(19) United States
(12) Patent Application Publication
(10) Pub. No.: US 2021/0216849 A1
(43) Pub. Date: Jul. 15, 2021

(54) NEURAL-NETWORK-BASED METHODS AND SYSTEMS THAT GENERATE FORECASTS FROM TIME-SERIES DATA

(71) Applicant: VMware, Inc., Palo Alto, CA (US)

(72) Inventors: Arnak Poghosyan, Yerevan (AM); Narek Hovhannisyan, Yerevan (AM); Sirak Ghazaryan, Yerevan (AM); George Oganesyan, Yerevan (AM); Clement Pang, Palo Alto, CA (US); Ashot Nshan Harutyunyan, Yerevan (AM); Naira Movses Grigoryan, Yerevan (AM)

(73) Assignee: VMware, Inc., Palo Alto, CA (US)

(21) Appl. No.: 17/151,610

(22) Filed: Jan. 18, 2021

Related U.S. Application Data
(63) Continuation-in-part of application No. 16/742,594, filed on Jan. 14, 2020.

(51) Int. Cl. G06N 3/04; G06N 3/08

(52) U.S. Cl. CPC G06N 3/049; G06N 3/08

(57) ABSTRACT

The current document is directed to methods and systems that generate forecasts based on input time-series data using a forecasting neural network or other machine-learning-based forecasting subsystem. In various implementations, an input time series is first classified and then transformed, based on the classification, to a corresponding stationary time series. The corresponding stationary time series is then submitted to a neural network or other machine-learning-based forecasting subsystem to generate an initial forecast for future time points. The initial forecast is then inverse transformed, based on the input-time-series classification, to generate a final, output forecast.

### CROSS-REFERENCE TO RELATED APPLICATION

This application is a continuation in part of application Ser. No. 16/742,594, filed on Jan. 14, 2020.

### TECHNICAL FIELD

The current document is directed to time-series data analysis and processing, and, in particular, to methods and subsystems that generate forecasts from time-series data using a forecasting neural network or other type of machine-learning-based forecaster.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

In modern computing systems, individual computers, subsystems, and components generally output large volumes of status, informational, and error data. In large, distributed computing systems, terabytes of status, informational, and error data may be generated each day. The status, informational, and error data generally contain information that can be used to detect the potential for serious failures and operational deficiencies in the computer systems prior to the accumulation of a sufficient number of failures and system-degrading events to lead to subsequent data loss, component and subsystem failures, and down time. The information contained in the data may also be used to detect and ameliorate various types of security breaches and security issues, to intelligently manage and maintain distributed computing systems, and to diagnose many different classes of operational problems, hardware-design deficiencies, and software-design deficiencies. In many cases, the collected information can be viewed as time-series data. For many applications, it is desirable to generate forecasts for future datapoints in the time-series data. However, generating forecasts from time-series data as a service may be associated with unacceptably low response times and unacceptably high costs for clients of forecasting services.

### SUMMARY

The current document is directed to methods and systems that generate forecasts based on input time-series data using a forecasting neural network or other machine-learning-based forecasting subsystem. In various implementations, an input time series is first classified and then transformed, based on the classification, to a corresponding stationary time series. The corresponding stationary time series is then submitted to a neural network or other machine-learning-based forecasting subsystem to generate an initial forecast for future time points. The initial forecast is then inverse transformed, based on the input-time-series classification, to generate a final, output forecast.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction. In FIG. 9, three different physical data centers 902-904 are shown below planes representing the cloud-director layer of abstraction 906-908.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates a simple example of event-message logging and analysis.

FIG. 12 shows a small, 11-entry portion of a log file from a distributed computer system.

FIG. 13 illustrates one initial event-message-processing approach.

FIG. 14 illustrates the fundamental components of a feed-forward neural network.

FIG. 15 illustrates a small, example feed-forward neural network.

FIG. 16 provides a concise pseudocode illustration of the implementation of a simple feed-forward neural network.

FIG. 17, using the same illustration conventions as used in FIG. 7, illustrates back propagation of errors through the neural network during training.

FIGS. 18A-13 show the details of the weight-adjustment calculations carried out during back propagation.

FIGS. 19A-I illustrate one iteration of the neural-network-training process.

FIGS. 20A-C illustrate various aspects of recurrent neural networks.

FIGS. 21A-C illustrate a convolutional neural network.

FIGS. 22A-B illustrate neural-network training as an example of machine-learning-based-subsystem training.

FIGS. 23A-B illustrate time-series data.

FIGS. 24A-G show data and plots for a stationary time series (“STS”).

FIGS. 25A-D show a linear-trend stationary time series (“LTSTS”), using the same illustration conventions as used in FIGS. 24A-G.

FIGS. 26A-D show a unit-root time series (“URTS”), using the same illustration conventions as used in FIGS. 24A-G and FIGS. 25A-D.

FIGS. 27A-D show a unit-root with drift time series (“URDTS”), using the same illustration conventions as used in FIGS. 24A-G, FIGS. 25A-D, and FIGS. 26A-D.

FIG. 28 illustrates a desired implementation for using neural networks in cloud-computing environments to provide forecasts based on time-series data.

FIG. 29 illustrates a general approach embodied in the currently disclosed neural-network-based methods and systems that generate forecasts from time-series data.

FIG. 30 shows forward and reverse transforms for several of the different types of time series discussed above with reference to FIGS. 23B and 24A-27D.

FIGS. 31A-B illustrates a method for generating 1° recasts by a forecasting neural network based on a greater number of data values than the number of inputs m for the neural network.

FIG. 32 provides a control-flow diagram that represents one implementation of the TS-type-determination subsystem or module discussed above with reference to FIG. 29.

FIG. 33 illustrates an approach to statistically testing a TS-type hypothesis.

FIGS. 34A-B show examples of null hypothesis tests for TS types or classes.

FIG. 35 illustrates computation of confidence bounds for the forecast produced by the neural network or other machine-learning-based forecasting system in the forecasting module 2908 in FIG. 29.

FIGS. 36A-B provide control-flow diagrams that illustrate one implementation of the currently disclosed neural-network-based forecast-generation methods and systems.

FIGS. 37A-L illustrate the additional classes of time series for which forecasting method and system enhancements are disclosed.

FIGS. 38A-C illustrate a technique for detecting periodic time-series components within a time series.

FIGS. 39A-I provide an example of detecting periodicity within a time series using the method of FIGS. 39A-C.

FIGS. 40A-C provide control-flow diagrams for a routine that illustrates implementation of the method for identifying periodicities in timeseries discussed above with reference to FIGS. 38A-39I.

FIGS. 41A-C illustrate one of many methods for removing known periodic time-series components from a time series.

FIGS. 42A-C provide control-flow diagrams that illustrate how the forecasting method disclosed in the preceding subsection and shown in FIG. 36A is modified to enable forecasting of periodic time-series in the above-described periodic-time-series classes SPTS, TPTS, and SCPTS.

### DETAILED DESCRIPTION

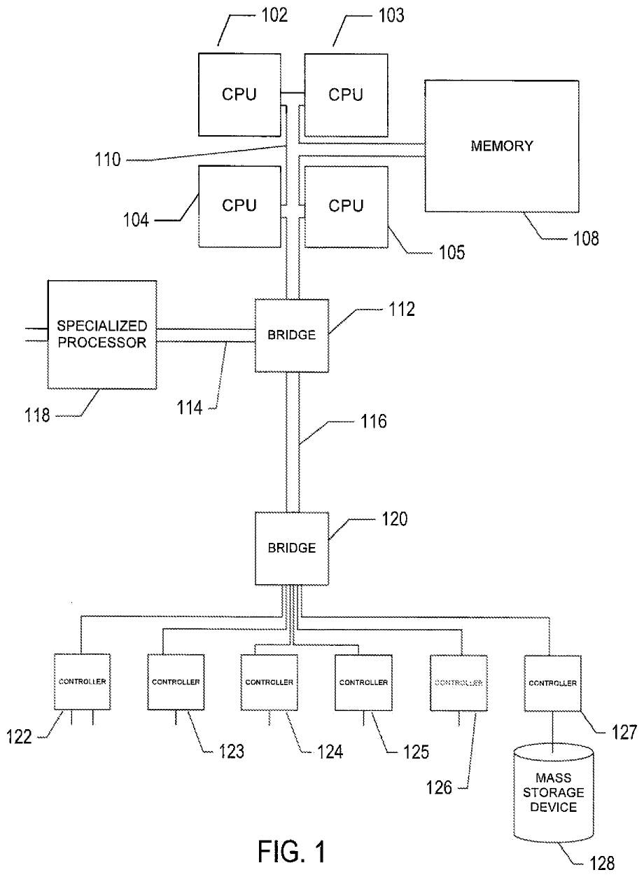

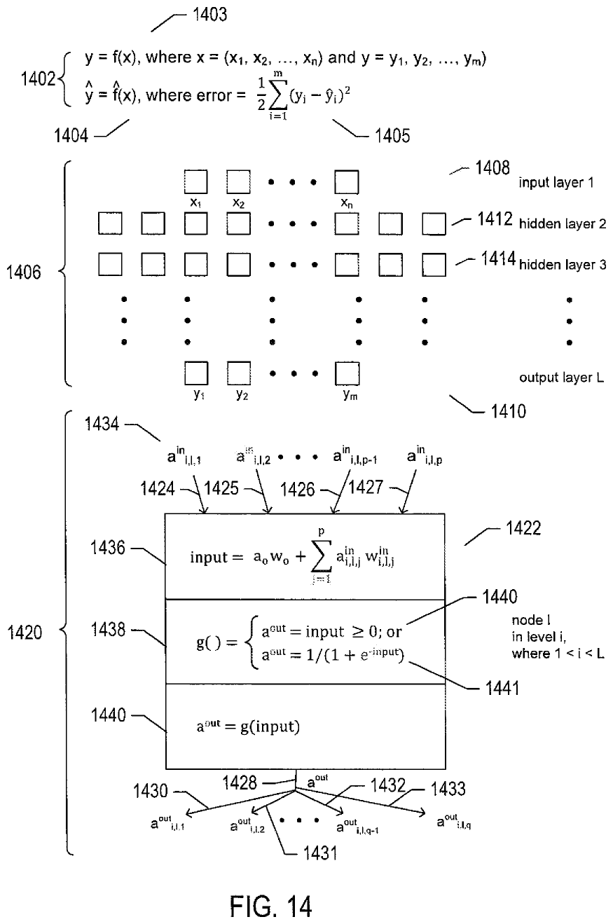

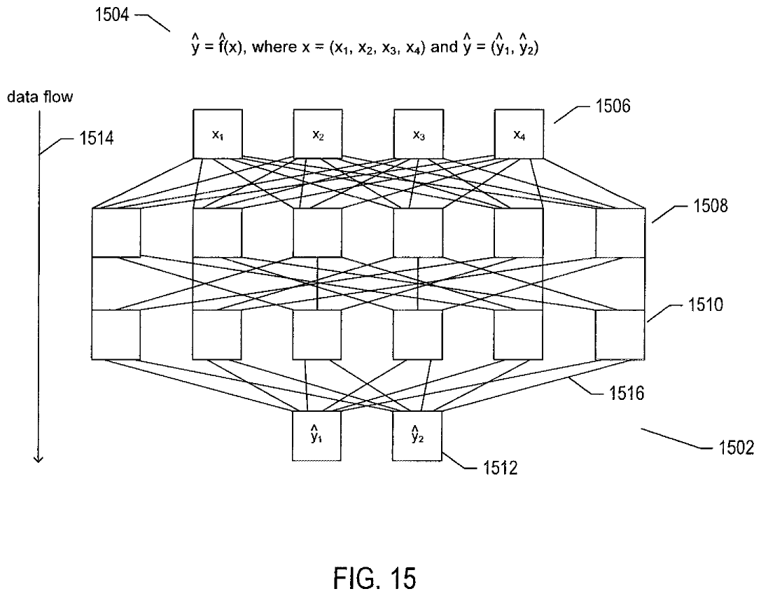

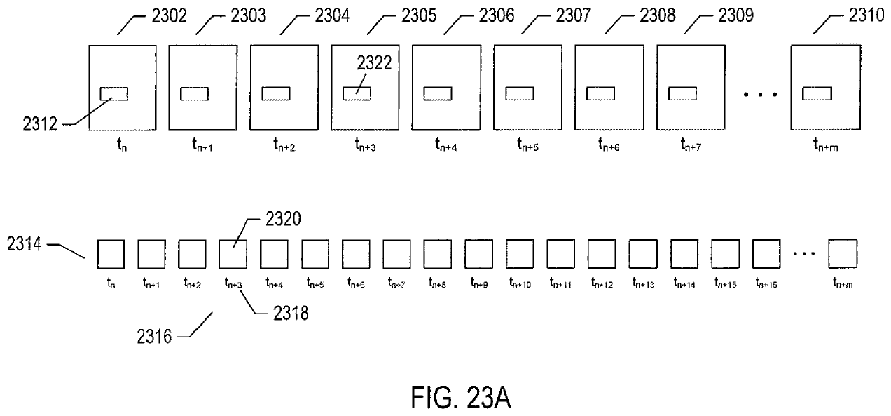

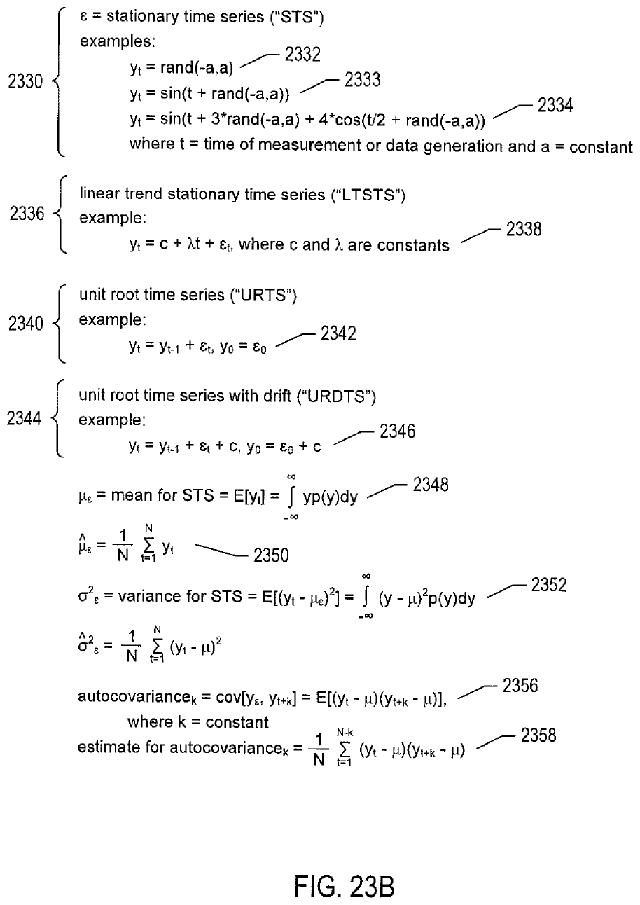

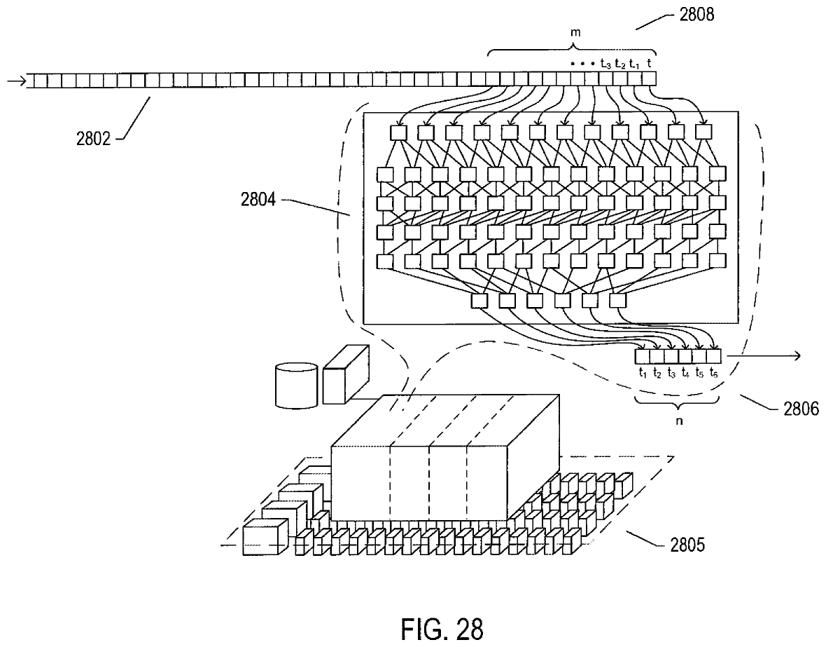

The current document is directed neural-network-based generation of forecasts from time-series data. In a first subsection, below, a detailed description of computer hardware, complex computational systems, virtualization, and generation of status, informational, and error data is provided with reference to FIGS. 1-13. In a second subsection, an overview of neural networks is provided with reference to FIGS. 14-22C. A third subsection discusses various types of time series with reference to FIGS. 23A-27D. Implementations of the currently disclosed methods and systems are introduced and described in detail, in a fourth subsection, with reference to FIGS. 28-36B. In a fifth and final subsection, enhancements to the implementations discussed in the fourth subsection, and to which the current claims are directed, are described in detail.

### Computer Hardware, Complex Computational Systems, Virtualization, and Generation of Status, Informational, and Error Data

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

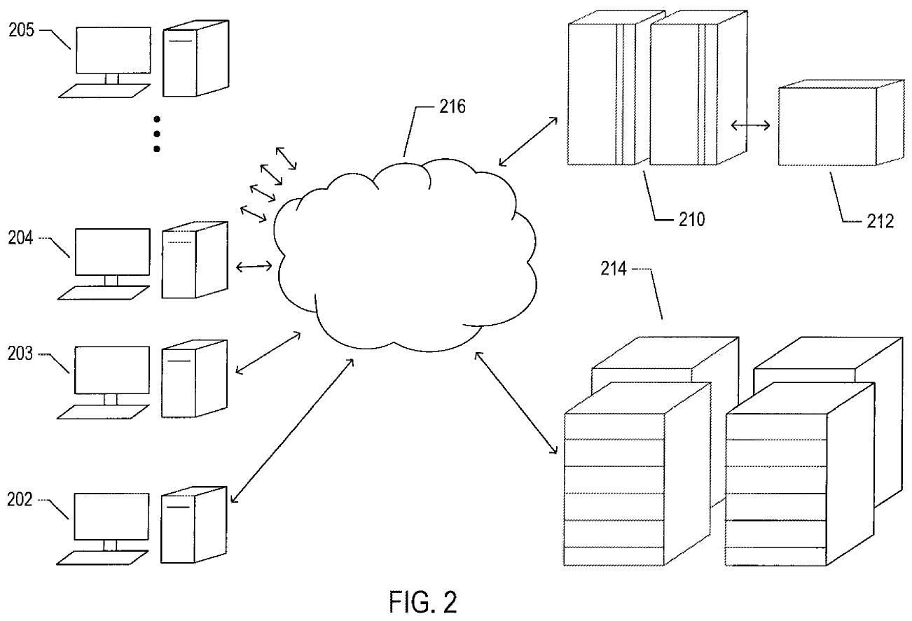

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

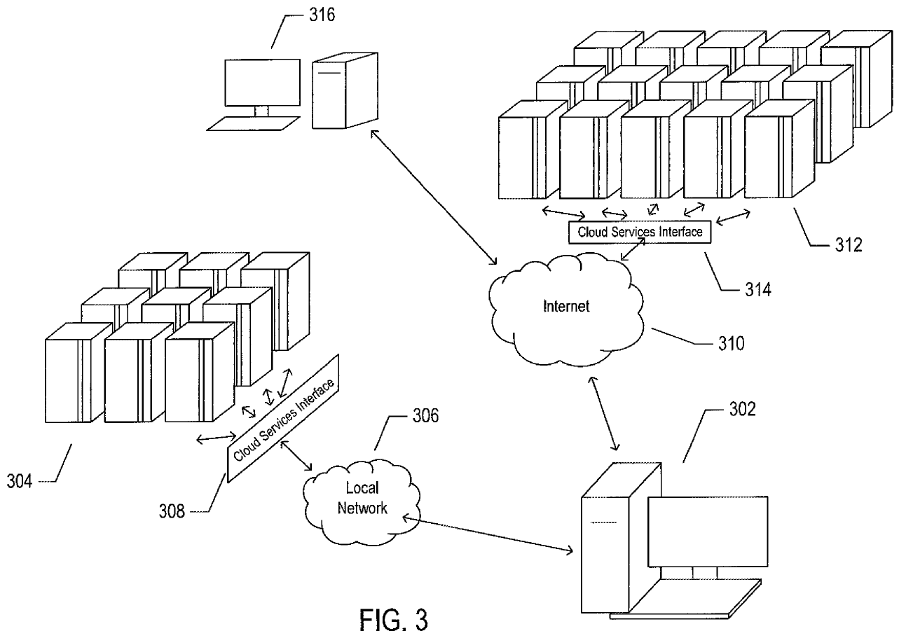

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

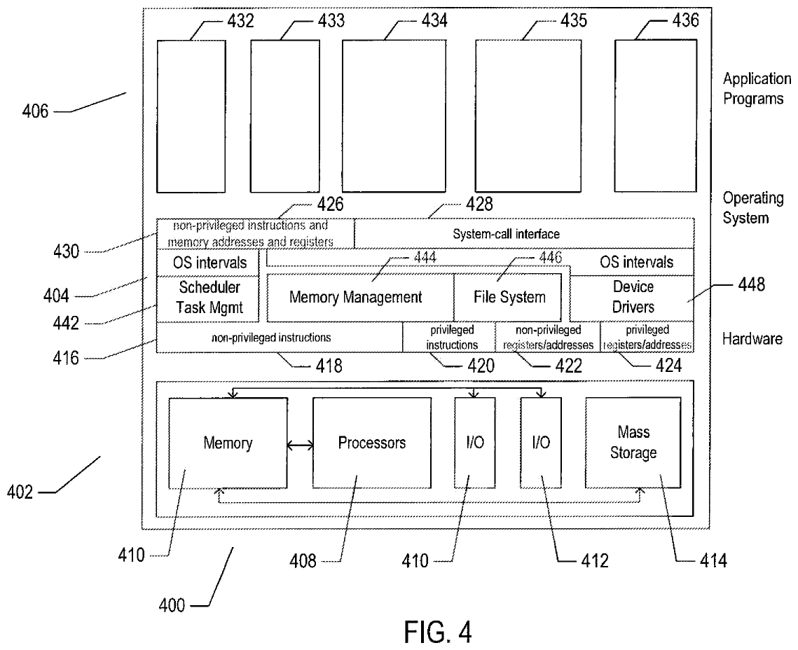

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating s stems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

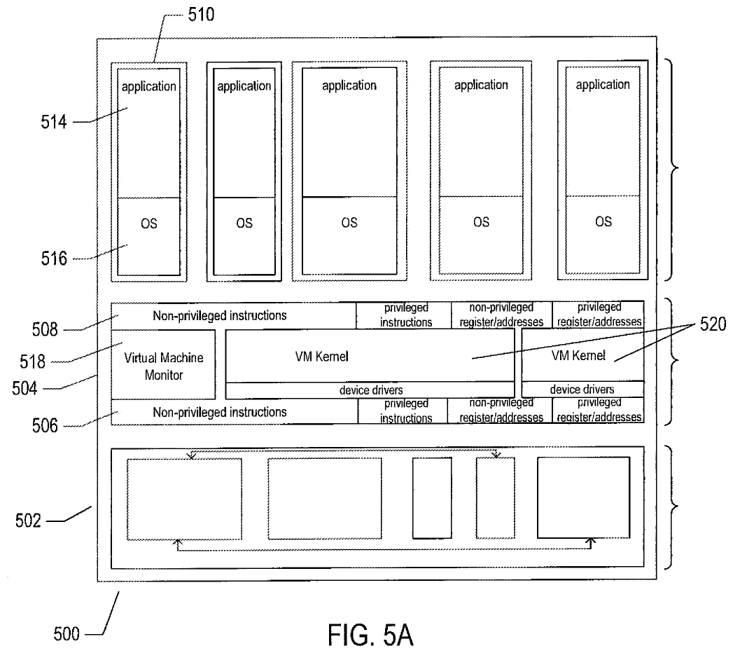

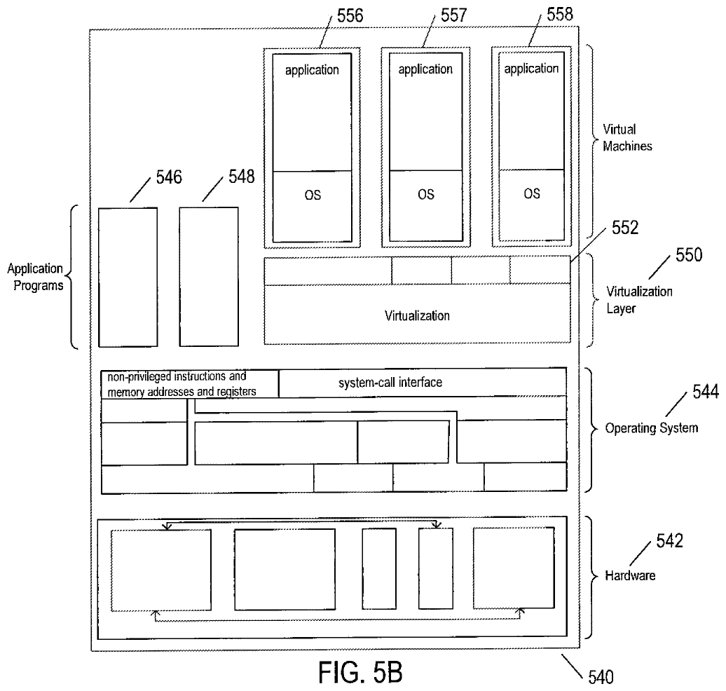

For alt of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

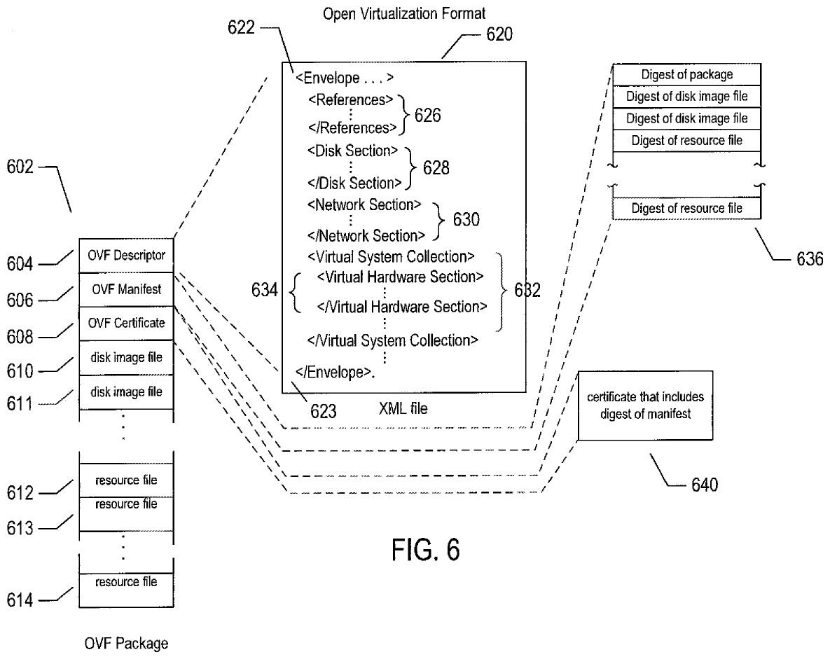

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

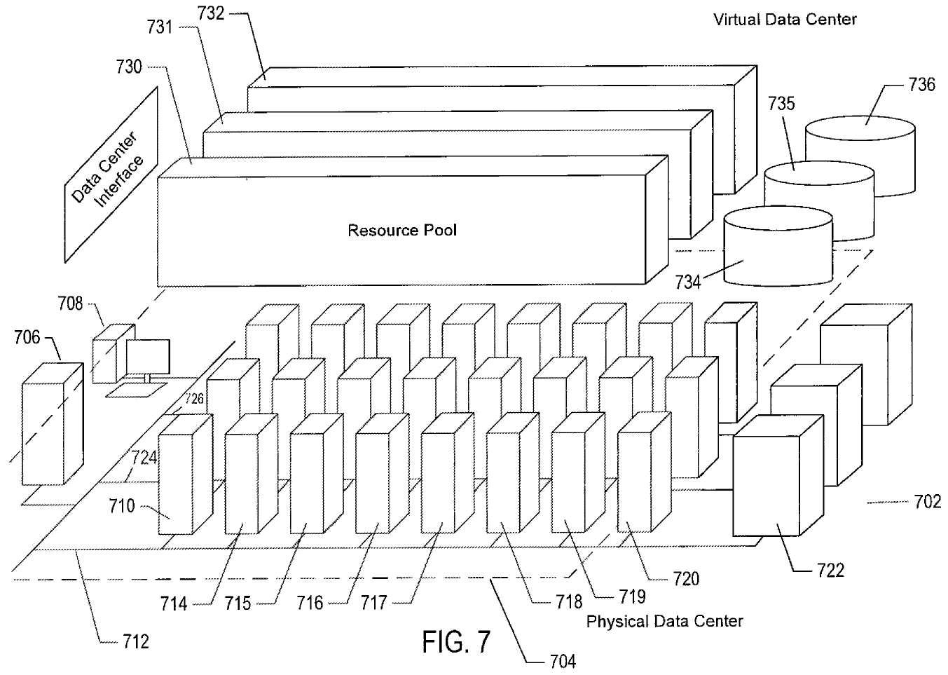

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

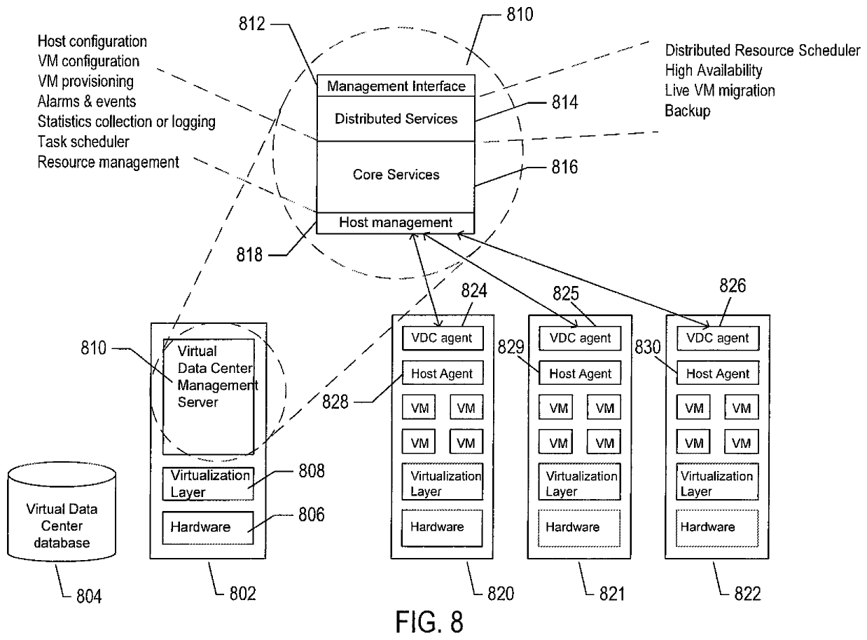

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the virtual-data-center management server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability. FIG. 8 illustrates virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server virtual machine 810 above the virtualization layer. Although shown as a single server in FIG. 8, the virtual-data-center management server (“VDC management server”) may include two or more physical server computers that support multiple VDC-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VDC management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VDC management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VDC management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

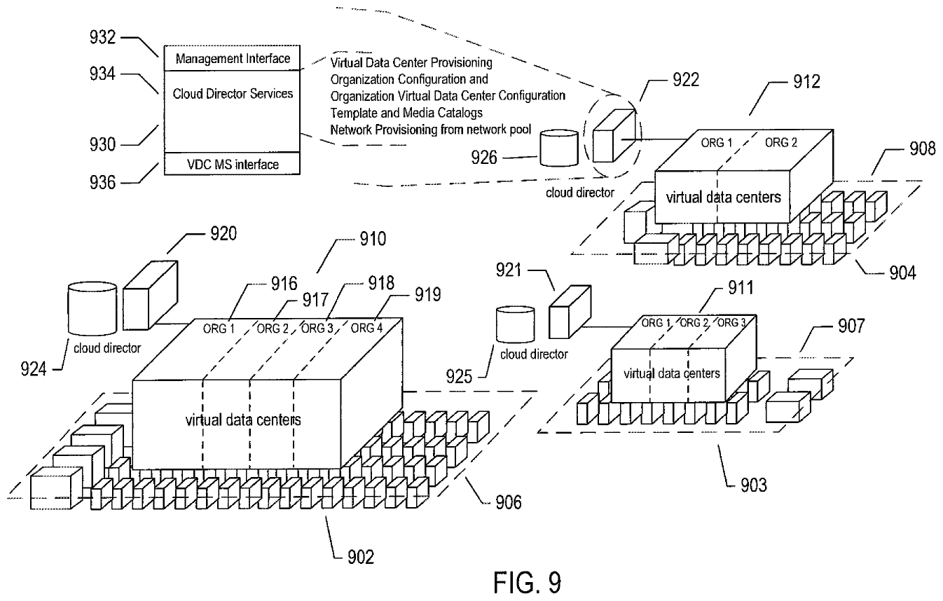

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

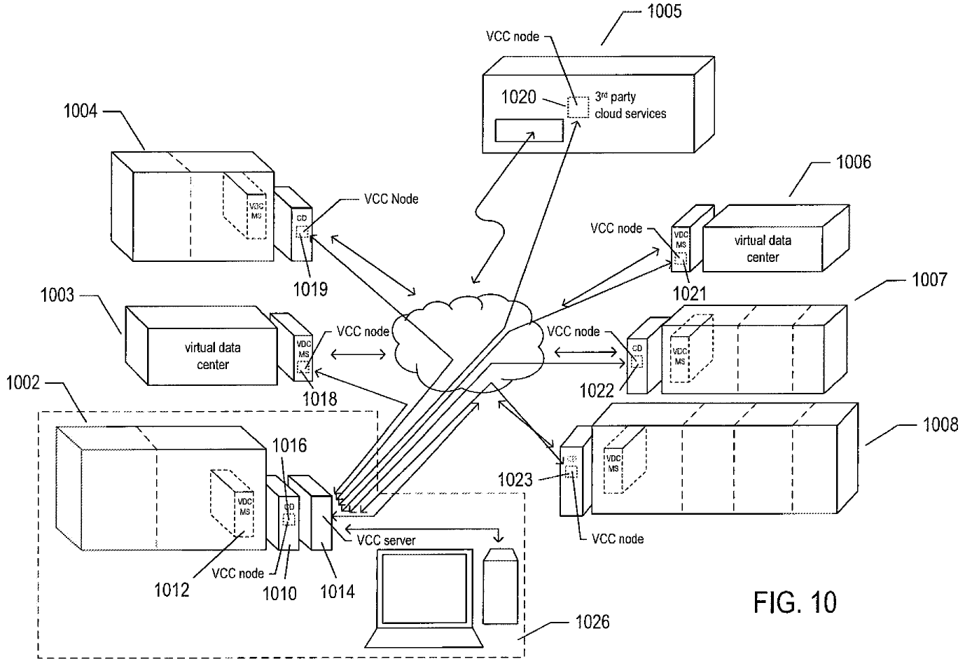

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

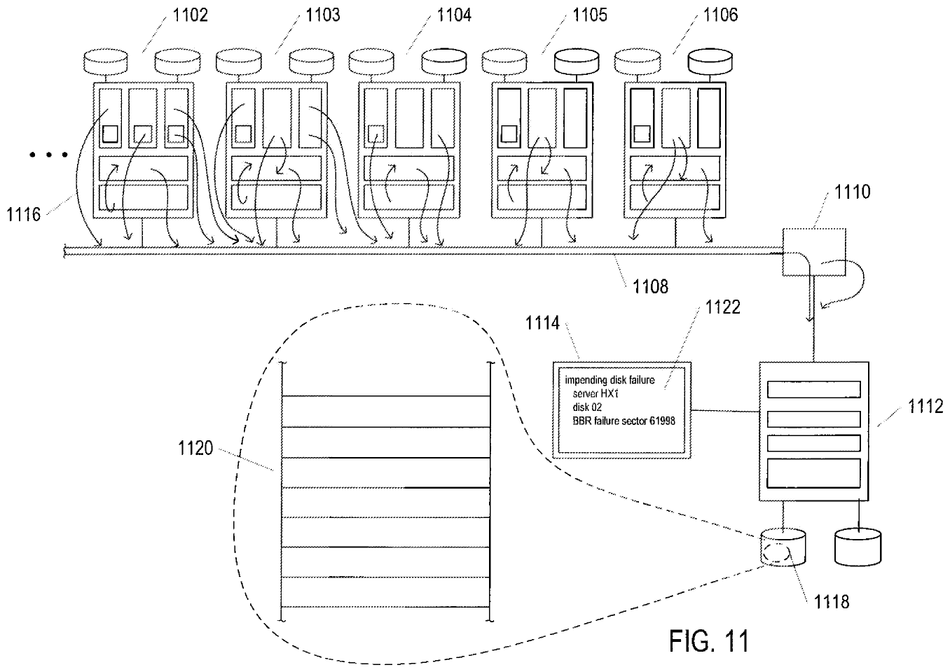

FIG. 11 illustrates a simple example of the generation and collection of status, informational, and error data the distributed computing system. In FIG. 11, a number of computer systems 1102-1106 within a distributed computing system are linked together by an electronic communications medium 1108 and additionally linked through a communications bridge/router 1110 to an administration computer system 1112 that includes an administrative console 1114. As indicated by curved arrows, such as curved arrow 1116, multiple components within each of the discrete computer systems 1102 and 1106 as well as the communications bridge/router 1110 generate various types of status, informational, and error data that is encoded within event messages which are ultimately transmitted to the administration computer 1112. Event messages are but one type of vehicle for conveying status, informational, and error data, generated by data sources within the distributed computer system, to a data sink, such as the administration computer system 1112. Data may be alternatively communicated through various types of hardware signal paths, packaged within formatted files transferred through local-area communications to the data sink, obtained by intermittent polling of data sources, or by many other means. The current example, the status, informational, and error data, however generated and collected within system subcomponents, is packaged in event messages that are transferred to the administration computer system 1112. Event messages may be relatively directly transmitted from a component within a discrete computer system to the administration computer or may be collected at various hierarchical levels within a discrete computer and then forwarded from an event-message-collecting entity within the discrete computer to the administration computer. The administration computer 1112 may filter and analyze the received event messages, as they are received, in order to detect various operational anomalies and impending failure conditions. In addition, the administration computer collects and stores the received event messages in a data-storage device or appliance 1118 as large event-message log files 1120. Either through real-time analysis or through analysis of log files, the administration computer may detect operational anomalies and conditions for which the administration computer displays warnings and informational displays, such as the warning 1122 shown in FIG. 11 displayed on the administration-computer display device 1114.

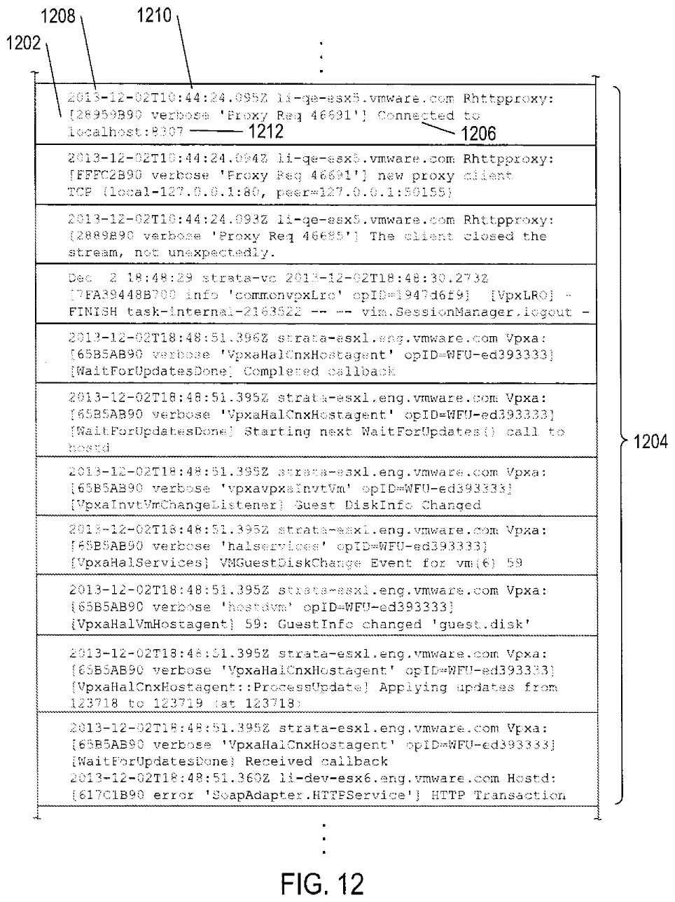

FIG. 12 shows a small, 11-entry portion of a log file from a distributed computer system. In FIG. 12, each rectangular cell, such as rectangular cell 1202, of the portion of the log file 1204 represents a single stored event message. In general, event messages are relatively cryptic, including generally only one or two natural-language sentences or phrases as well as various types of file names, path names, and, perhaps most importantly, various alphanumeric parameters. For example, log entry 1202 includes a short natural-language phrase 1206, date 1208 and time 1210 parameters, as well as a numeric parameter 1212 which appears to identify a particular host computer.

There are a number of reasons why event messages, particularly when accumulated and stored by the millions in event-log files or when continuously received at very high rates during daily operations of a computer system, are difficult to automatically interpret and use. The volume of data present within log files generated within large, distributed computing systems. As mentioned above, a large, distributed computing system may generate and store terabytes of logged event messages during each day of operation. This represents an enormous amount of data to process. Event messages are generated from many different components and subsystems at many different hierarchical levels within a distributed computer system, from operating system and application-program code to control programs within disk drives, communications controllers, and other such distributed-computer-system components. Even within a given subsystem, such as an operating system, many different types and styles of event messages may be generated, due to the many thousands of different programmers who contribute code to the operating system over very long time frames. In many cases, event messages relevant to a particular operational condition, subsystem failure, or other problem represent only a tiny fraction of the total number of event messages that are received and logged. Searching for these relevant event messages within an enormous volume of event messages continuously streaming into an event-message-processing-and-logging subsystem of a distributed computer system may be a significant computational challenge. Storing and archiving event logs may itself represent a significant computational challenge. Given that many terabytes of event messages may be collected during the course of a single day of operation of a large, distributed computer system, collecting and storing the large volume of information represented by event messages may represent a significant processing-bandwidth, communications-subsystems bandwidth, and data-storage-capacity challenge, particularly when it may be necessary to reliably store event logs in ways that allow the event logs to be subsequently accessed for searching and analysis.

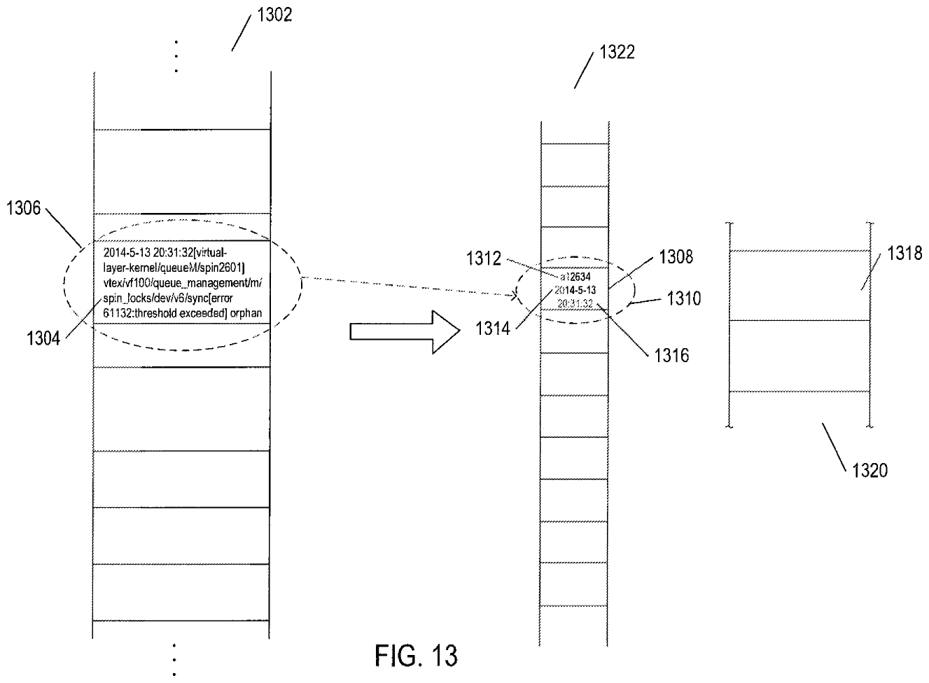

FIG. 13 illustrates one initial event-message-processing approach. In FIG. 13, a traditional event log 1302 is shown as a column of event messages, including the event message 1304 shown within inset 1306. Automated subsystems may process event messages, as they are received, in order to transform the received event messages into event records, such as event record 1308 shown within inset 1310. The event record 1308 includes a numeric event-type identifier 1312 as well as the values of parameters included in the original event message. In the example shown in FIG. 13, a date parameter 1314 and a time parameter 1315 are included in the event record 1308. The remaining portions of the event message, referred to as the “non-parameter portion of the event message,” is separately stored in an entry in a table of non-parameter portions that includes an entry for each type of event message. For example, entry 1318 in table 1320 may contain an encoding of the non-parameter portion common to all event messages of type a12634 (1312 in FIG. 13). Thus, automated subsystems may transform traditional event logs, such as event log 1302, into stored event records, such as event-record log 1322, and a generally very small table 1320 with encoded non-parameter portions, or templates, for each different type of event message.

### An Overview of Neural Networks

FIG. 14 illustrates the fundamental components of a feed-forward neural network. Equations 1402 mathematically represents ideal operation of a neural network as a function ƒ(x). The function receives an input vector x and outputs a corresponding output vector y 1403. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, one or more numeric values. The initial expression 1403 represents the ideal operation of the neural network. In other words, the output vectors y represent the ideal, or desired, output for corresponding input vector x. However, in actual operation, a physically implemented neural network \hat{ƒ}(x), as represented by expressions 1404, returns a physically generated output vector ŷ that may differ from the ideal or desired output vector y. As shown in the second expression 1405 within expressions 1404, an output vector produced by the physically implemented neural network is associated with an error or loss value. A common error or loss value is the square of the distance between the two points represented by the ideal output vector and the output vector produced by the neural network. To simplify back-propagation computations, discussed below, the square of the distance is often divided by 2. As further discussed below, the distance between the two points represented by the ideal output vector and the output vector produced by the neural network, with optional scaling, may also be used as the error or loss. A neural network is trained using a training dataset comprising input-vector ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 1406 of FIG. 14, a feed-forward neural network generally consists of layers of nodes, including an input layer 1408, and output layer 1410, and one or more hidden layers 1412 and 1414. These layers can be numerically labeled 1, 2, 3, . . . , L, as shown in FIG. 14. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 14 (1420 in FIG. 14) illustrates a feed-forward neural-network node. The neural-network node 1422 receives inputs 1424-1427 from one or more next-higher-level nodes and generates an output 1428 that is distributed to one or more next-lower-level nodes 1430-1433. The inputs and outputs are referred to as “activations,” represented by superscripted-and-subscripted symbols “a” in FIG. 14, such as the activation symbol 1434. An input component 1436 within a node collects the input activations and generates a weighted sum of these input activations to which a weighted internal activation a₀ is added. An activation component 1438 within the node is represented by a function g( ), referred to as an “activation function,” that is used in an output component 1440 of the node to generate the output activation of the node based on the input collected by the input component 1436. The neural-network node 1422 represents a generic hidden-layer node. Input-layer nodes lack the input component 1436 and each receive a single input value representing an element of an input vector. Output-component nodes output a single value representing an element of the output vector. The values of the weights used to generate the cumulative input by the input component 1436 are determined by training, as previously mentioned. In general, the input, outputs, and activation function are predetermined and constant, although, in certain types of neural networks, these may also be at least partly adjustable parameters. In FIG. 14, two different possible activation functions are indicated by expressions 1440 and 1441. The latter expression represents a sigmoidal relationship between input and output that is commonly used in neural networks and other types of machine-learning systems.

FIG. 15 illustrates a small, example feed-forward neural network. The example neural network 1502 is mathematically represented by expression 1504. It includes an input layer of four nodes 1506, a first hidden layer 1508 of six nodes, a second hidden layer 1510 of six nodes, and an output layer 1512 of two nodes. As indicated by directed arrow 1514, data input to the input-layer nodes 1506 flows downward through the neural network to produce the final values output by the output nodes in the output layer 1512. The line segments, such as line segment 1516, interconnecting the nodes in the neural network 1502 indicate communications paths along which activations are transmitted from higher-level nodes to lower-level nodes. In the example feed-forward neural network, the nodes of the input layer 1506 are fully connected to the nodes of the first hidden layer 1508, but the nodes of the first hidden layer 1508 are only sparsely connected with the nodes of the second hidden layer 1510. Various different types of neural networks may use different numbers of layers, different numbers of nodes in each of the layers, and different patterns of connections between the nodes of each layer to the nodes in preceding and succeeding layers.

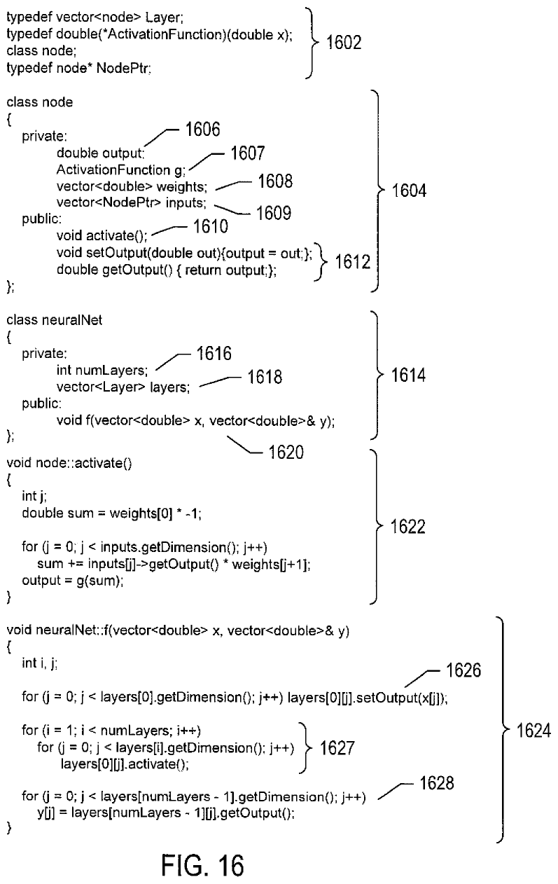

FIG. 16 provides a concise pseudocode illustration of the implementation of a simple feed-forward neural network. Three initial type definitions 1602 provide types for layers of nodes, pointers to activation functions, and pointers to nodes. The class node 1604 represents a neural-network node. Each node includes the following data members: (1) output 1606, the output activation value for the node; (2) g 1607, a pointer to the activation function for the node; (3) weights 1608, the weights associated with the inputs; and (4) inputs 1609, pointers to the higher-level nodes from which the node receives activations. Each node provides an activate member function 1610 that generates the activation for the node, which is stored in the data member output, and a pair of member functions 1612 for setting and getting the value stored in the data member output. The class neuralNet 1614 represents an entire neural network. The neural network includes data members that store the number of layers 1616 and a vector of node-vector layers 1618, each node-vector layer representing a layer of nodes within the neural network. The single member function ƒ 1620 of the class neuralNet generates an output vector y for an input vector x. An implementation of the member function activate for the node class is next provided 1622. This corresponds to the expression shown for the input component 1436 in FIG. 14. Finally, an implementation for the member function ƒ 1624 of the neuralNet class is provided. In a first for-loop 1626, an element of the input vector is input to each of the input-layer nodes. In a pair of nested for-loops 1627, the activate function for each hidden-layer and output-layer node in the neural network is called, starting from the highest hidden layer and proceeding layer-by-layer to the output layer. In a final for-loop 1628, the activation values of the output-layer nodes are collected into the output vector y.

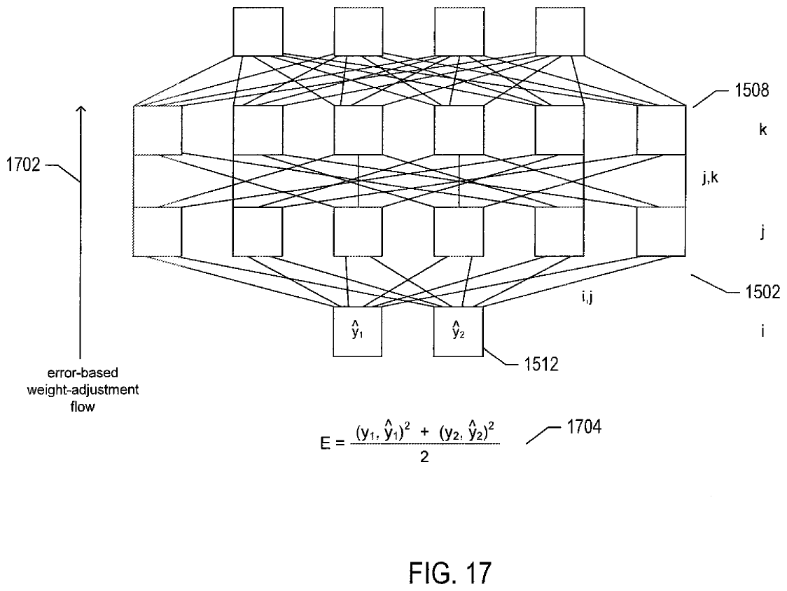

FIG. 17, using the same illustration conventions as used in FIG. 15, illustrates back propagation of errors through the neural network during training. As indicated by directed arrow 1702, the error-based weight adjustment flows upward from the output-layer nodes 1512 to the highest-level hidden-layer nodes 1508. For the example neural network 1502, the error, or loss, is computed according to expression 1704. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

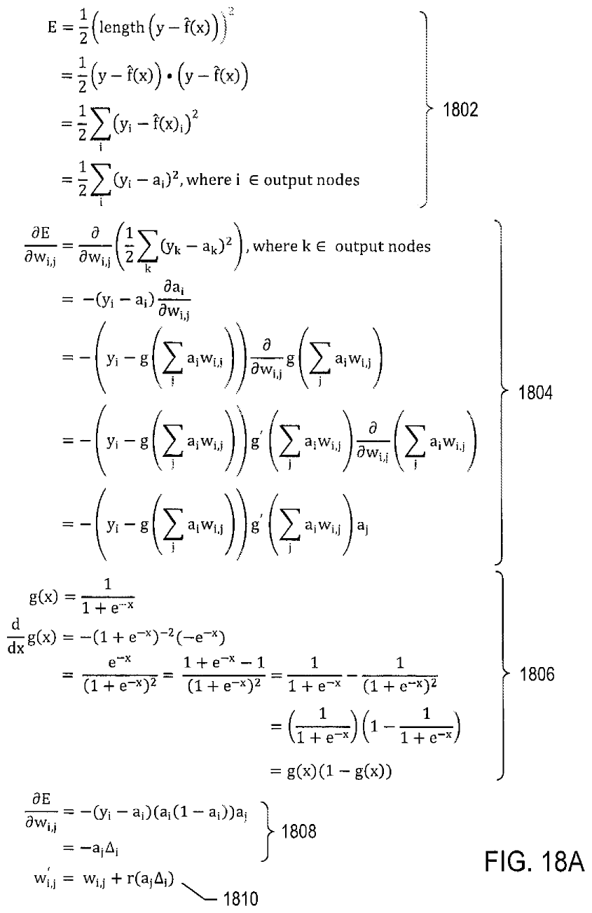

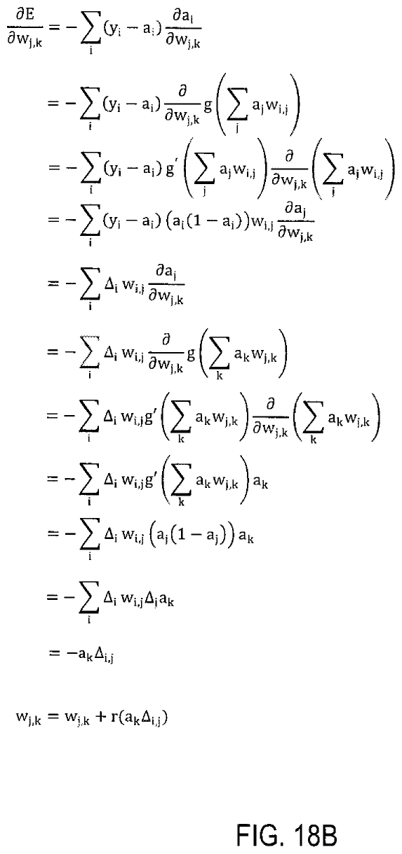

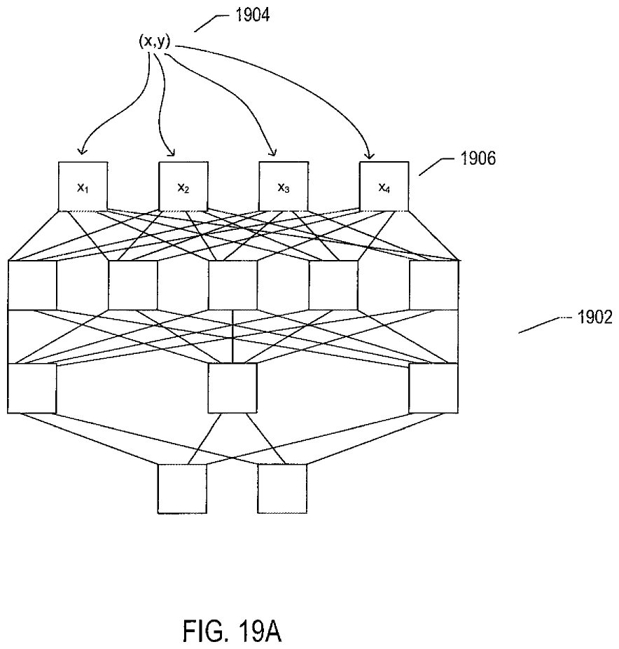

FIGS. 18A-B show the details of the weight-adjustment calculations carried out during back propagation. An expression for the total error, or loss, E with respect to an input-vector/label pair within a training dataset is obtained in a first set of expressions 1802, which is one half the squared distance between the points in a multidimensional space represented by the ideal output and the output vector generated by the neural network. The partial differential of the total error E with respect to a particular weight w_{i,j} for the j^{th} input of an output node i is obtained by the set of expressions 1804. In these expressions, the partial differential operator is propagated rightward through the expression for the total error E. An expression for the derivative of the activation function with respect to the input x produced by the input component of a node is obtained by the set of expressions 1806. This allows for generation of a simplified expression for the partial derivative of the total energy E with respect to the weight associated with the j^{th} input of the i^{th} output node 1808. The weight adjustment based on the total error E is provided by expression 1810, in which r has a real value in the range [0-1] that represents a learning rate, aⱼ is the activation received through input j by node i, and Δᵢ is the product of parenthesized terms, which include aᵢ and yᵢ, in the first expression in expressions 1808 that multiplies aⱼ FIG. 18B provides a derivation of the weight adjustment for the hidden-layer nodes above the output layer. It should be noted that the computational overhead for calculating the weights for each next highest layer of nodes increases geometrically, as indicated by the increasing number of subscripts for the A multipliers in the weight-adjustment expressions.

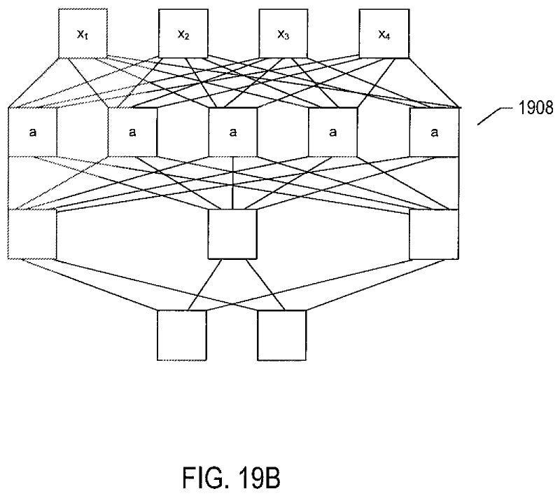

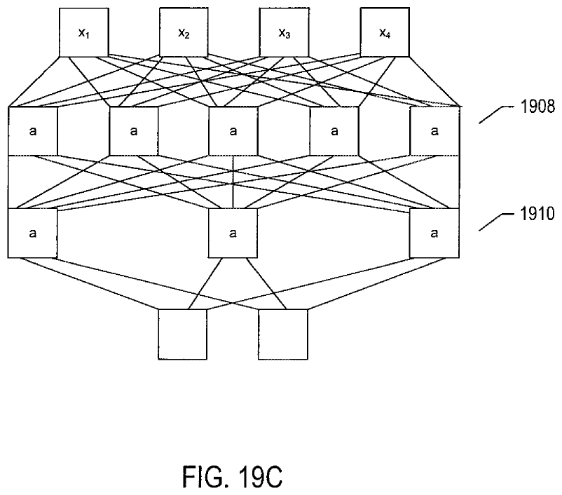

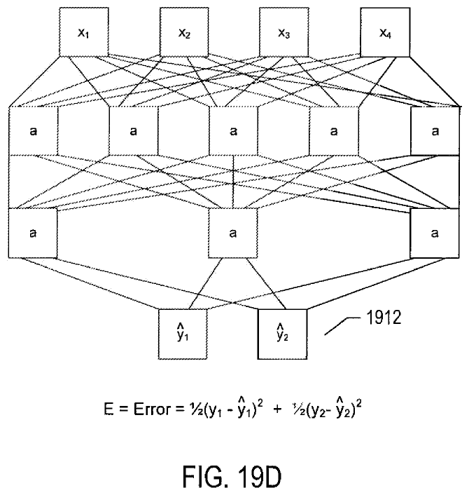

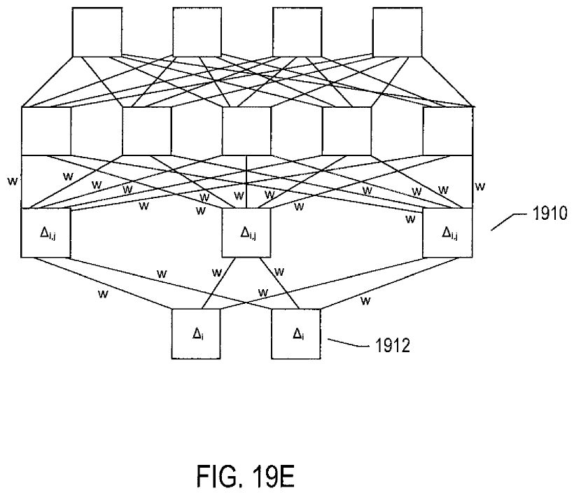

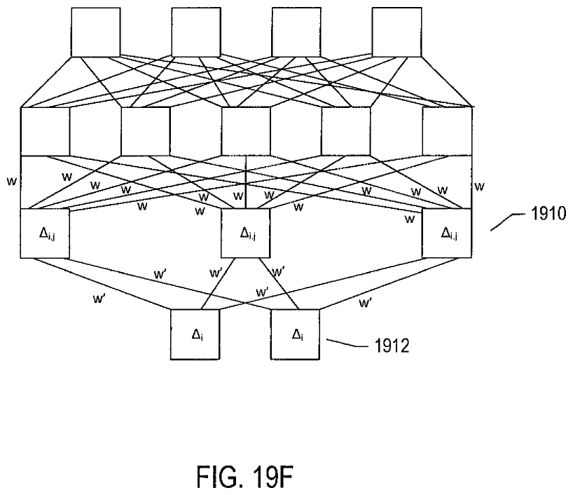

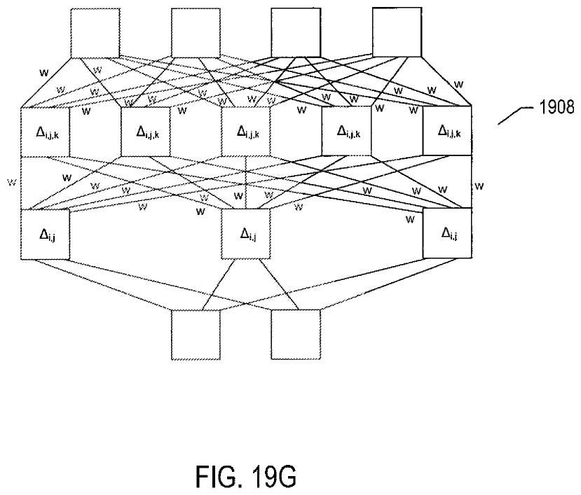

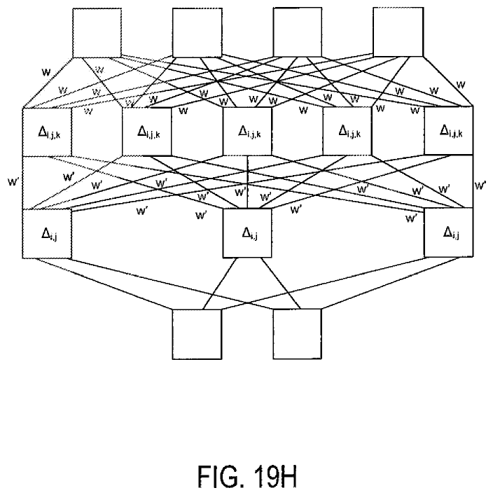

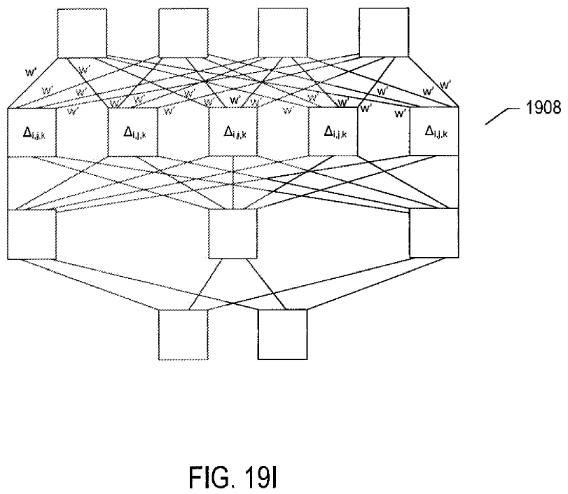

FIGS. 19A-I illustrate one iteration of the neural-network-training process. A simple, example neural-network 1902, illustrated using the same illustration conventions shown in FIGS. 1 and 17, is used in each of FIGS. 19A-I. In FIG. 19A, the input vector of an input-vector/label pair 1904 is input to the input-layer nodes 1906. In FIG. 19B, each node in the highest-level hidden layer 1908 generates an activation via a weighted sum of input activations transmitted to the node from the input nodes. In FIG. 19C, each node in the second hidden layer 1910 generate an activation via a weighted sum of the activations input to them from nodes of the higher-level hidden layer 1908. In FIG. 19D, the output-layer nodes 1912 generate activations from the activations received from the second hidden layer nodes. The activations generated by the output-layer nodes correspond to the values of the elements of the output vector ŷ. In FIG. 19E, multipliers Δᵢ of the activations for weight adjustments are computed by the output-layer nodes 1912 and multipliers Δ_{i,j} of the activations for weight adjustments are computed by the second layer of hidden nodes 1910. In FIG. 19F, the weights w associated with inputs to the output-layer nodes are adjusted to new weights w′. This is done after the multipliers of the activations to the weight adjustments of the second hidden-node layer are generated, since generation of those multipliers depends on the original weights associated with inputs to the output-layer nodes. In FIG. 19G, the multipliers of the activations for the weight adjustments of the highest-level hidden-layer nodes 1908 are generated. In FIG. 19H, the weights for the activations passed between the two hidden layers are adjusted. Finally, in FIG. 19I, the weights for the connections between the input nodes and the highest-level hidden-layer nodes 1908 are adjusted.

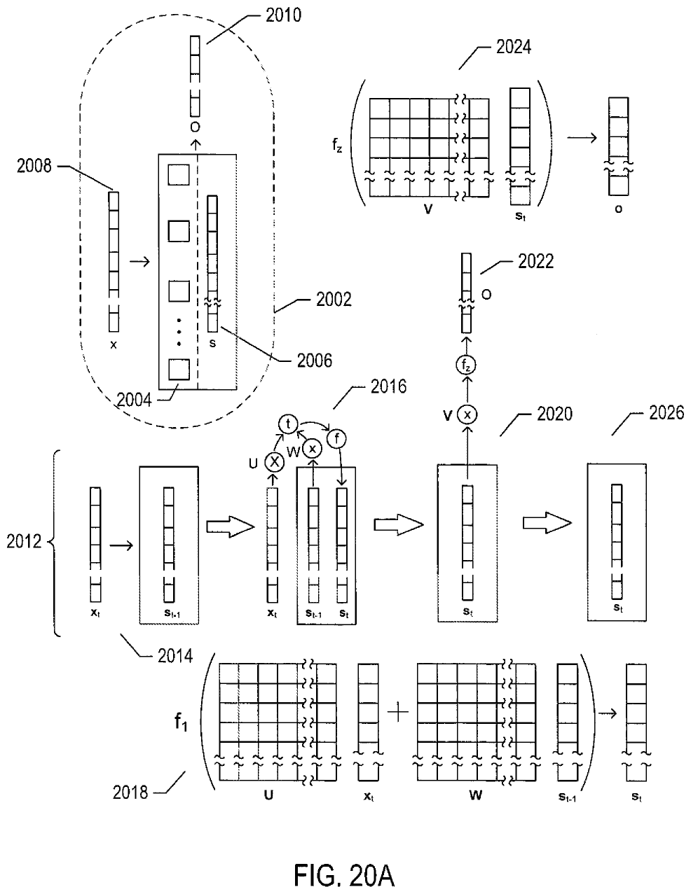

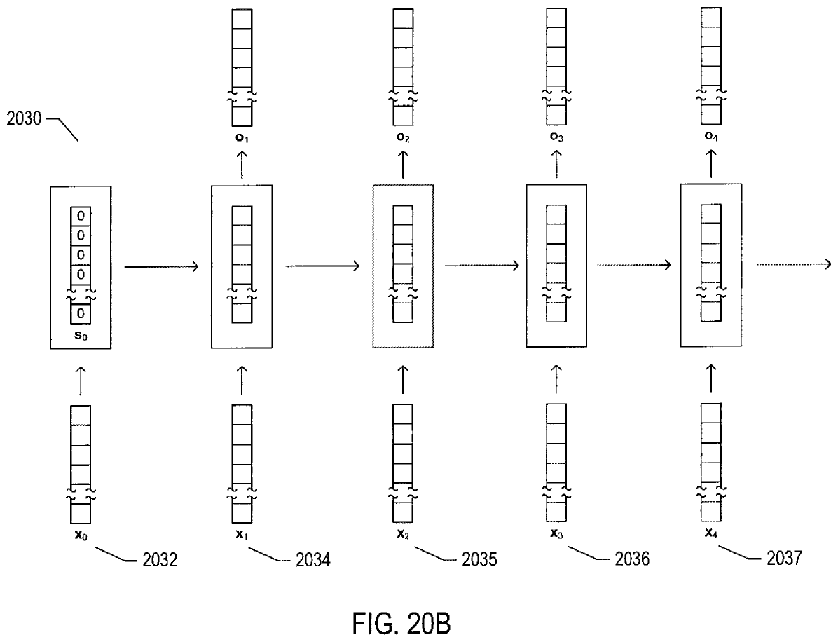

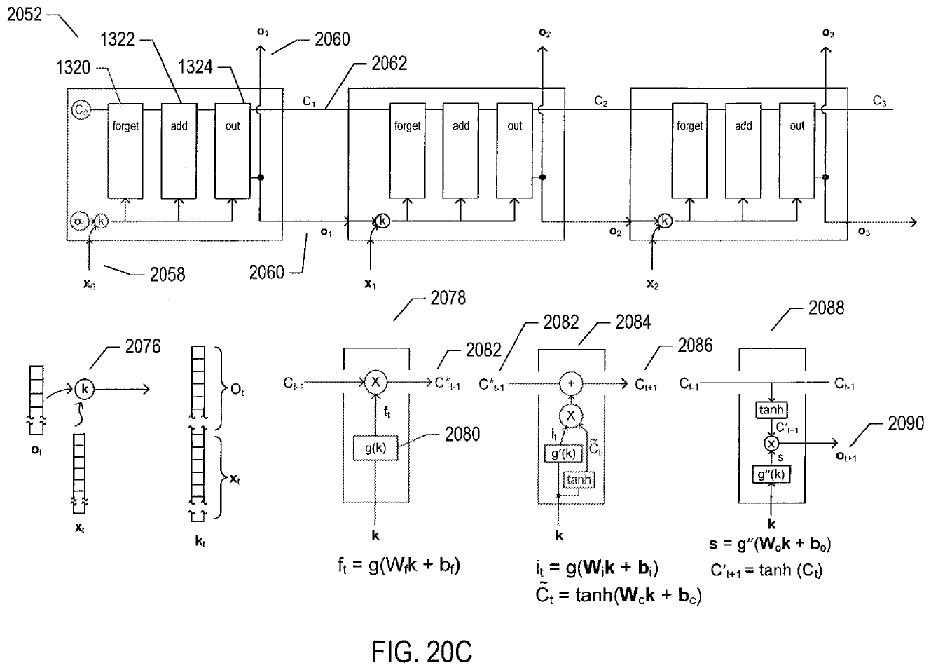

A second type of neural network, referred to as a “recurrent neural network,” is employed to generate sequences of output vectors from sequences of input vectors. These types of neural networks are often used for natural-language applications in which a sequence of words forming a sentence are sequentially processed to produce a translation of the sentence, as one example. FIGS. 20A-B illustrate various aspects of recurrent neural networks. Inset 2002 in FIG. 20A shows a representation of a set of nodes within a recurrent neural network. The set of nodes includes nodes that are implemented similarly to those discussed above with respect to the feed-forward neural network 2004, but additionally include an internal state 2006. In other words, the nodes of a recurrent neural network include a memory component. The set of recurrent-neural-network nodes, at a particular time point in a sequence of time points, receives an input vector x 2008 and produces an output vector 2010. The process of receiving an input vector and producing an output vector is shown in the horizontal set of recurrent-neural-network-nodes diagrams interleaved with large arrows 2012 in FIG. 20A. In a first step 2014, the input vector x at time t is input to the set of recurrent-neural-network nodes which include an internal state generated at time t−1. In a second step 2016, the input vector is multiplied by a set of weights U and the current state vector is multiplied by a set of weights W to produce two vector products which are added together to generate the state vector for time t. This operation is illustrated as a vector function ƒ₁ 2018 in the lower portion of FIG. 20A. In a next step 2020, the current state vector is multiplied by a set of weights V to produce the output vector for time t 2022, a process illustrated as a vector function ƒ₂ 2024 in FIG. 20A. Finally, the recurrent-neural-network nodes are ready for input of a next input vector at time t+1, in step 2026.

FIG. 20B illustrates processing by the set of recurrent-neural-network nodes of a series of input vectors to produce a series of output vectors. At a first time t₀ 2030, a first input vector x₀ 2032 is input to the set of recurrent-neural-network nodes. At each successive time point 2034-2037, a next input vector is input to the set of recurrent-neural-network nodes and an output vector is generated by the set of recurrent-neural-network nodes. In many cases, only a subset of the output vectors are used. Back propagation of the error or loss during training of a recurrent neural network is similar to back propagation for a feed-forward neural network, except that the total error or loss needs to be back-propagated through time in addition to through the nodes of the recurrent neural network. This can be accomplished by unrolling the recurrent neural network to generate a sequence of component neural networks and by then back-propagating the error or loss through this sequence of component neural networks from the most recent time to the most distant time period.

Finally, for completeness, FIG. 20C illustrates a type of recurrent-neural-network node referred to as a long-short-term-memory (“LSTM”) node. In FIG. 20C, a LSTM node 2052 is shown at three successive points in time 2054-2056. State vectors and output vectors appear to be passed between different nodes, but these horizontal connections instead illustrate the fact that the output vector and state vector are stored within the LSTM node at one point in time for use at the next point in time. At each time point, the LSTM node receives an input vector 2058 and outputs an output vector 2060. In addition, the LSTM node outputs a current state 2062 forward in time. The LSTM node includes a forget module 2070, an add module 2072, and an out module 2074. Operations of these modules are shown in the lower portion of FIG. 20C. First, the output vector produced at the previous time point and the input vector received at a current time point are concatenated to produce a vector k 2076. The forget module 2078 computes a set of multipliers 2080 that are used to element-by-element multiply the state from time t−1 in order to produce an altered state 2082. This allows the forget module to delete or diminish certain elements of the state vector. The add module 2134 employs an activation function to generate a new state 2086 from the altered state 2082. Finally, the out module 2088 applies an activation function to generate an output vector 2140 based on the new state and the vector k. An LSTM node, unlike the recurrent-neural-network node illustrated in FIG. 20A, can selectively alter the internal state to reinforce certain components of the state and deemphasize or forget other components of the state in a manner reminiscent of human short-term memory. As one example, when processing a paragraph of text, the LSTM node may reinforce certain components of the state vector in response to receiving new input related to previous input but may diminish components of the state vector when the new input is unrelated to the previous input, which allows the LSTM to adjust its context to emphasize inputs close in time and to slowly diminish the effects of inputs that are not reinforced by subsequent inputs. Here again, back propagation of a total error or loss is employed to adjust the various weights used by the LSTM, but the back propagation is significantly more complicated than that for the simpler recurrent neural-network nodes discussed with reference to FIG. 20A.

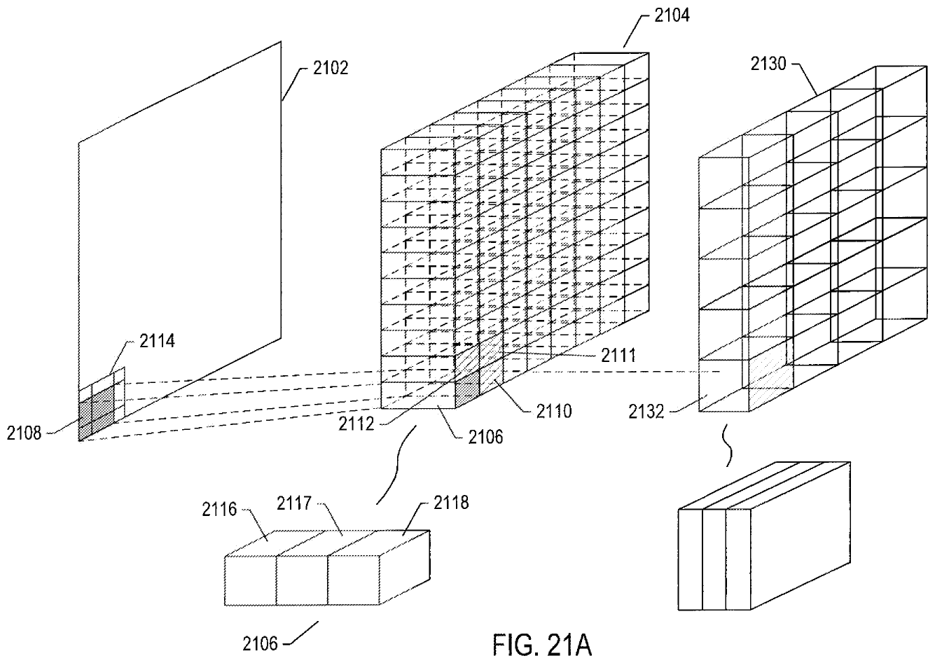

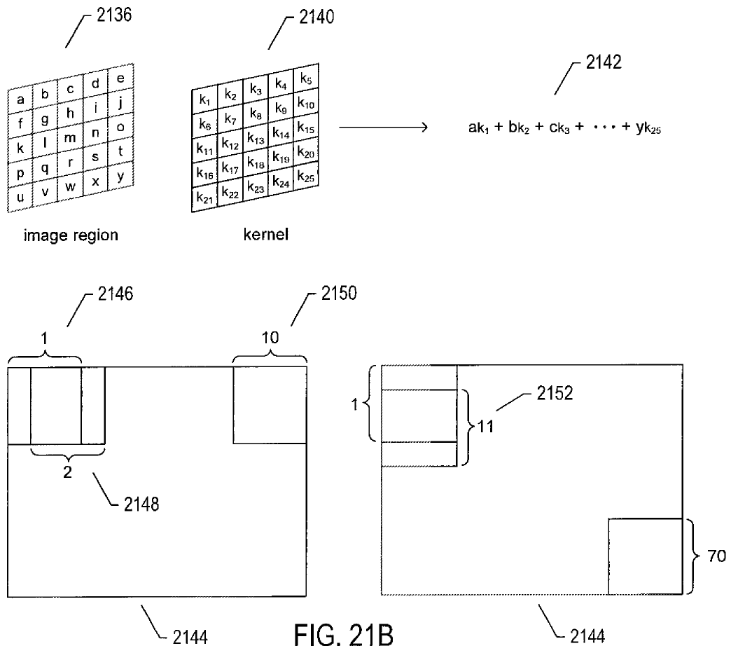

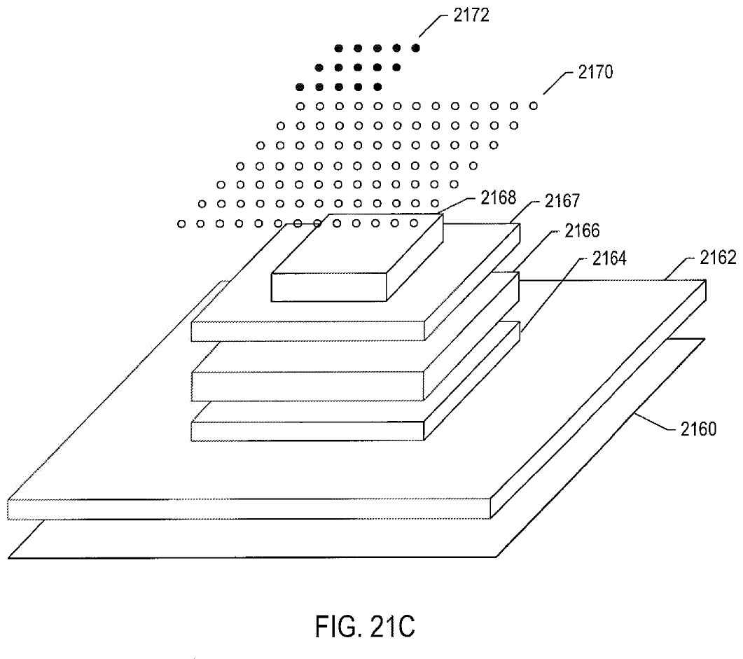

FIGS. 21A-C illustrate a convolutional neural network. Convolutional neural networks are currently used for image processing, voice recognition, and many other types of machine-learning tasks for which traditional neural networks are impractical. In FIG. 21A, a digitally encoded screen-capture image 2102 represents the input data for a convolutional neural network. A first level of convolutional-neural-network nodes 2104 each process a small subregion of the image. The subregions processed by adjacent nodes overlap. For example, the corner node 2106 processes the shaded subregion 2108 of the input image. The set of four nodes 2106 and 2110-2112 together process a larger subregion 2114 of the input image. Each node may include multiple subnodes. For example, as shown in FIG. 21A, node 2106 includes 3 subnodes 2116-2118. The subnodes within a node all process the same region of the input image, but each subnode may differently process that region to produce different output values. Each type of subnode in each node in the initial layer of nodes 2104 uses a common kernel or filter for subregion processing, as discussed further below. The values in the kernel or filter are the parameters, or weights, that are adjusted during training. However, since all the nodes in the initial layer use the same three subnode kernels or filters, the initial node layer is associated with only a comparatively small number of adjustable parameters. Furthermore, the processing associated with each kernel or filter is more or less translationally invariant, so that a particular feature recognized by a particular type of subnode kernel is recognized anywhere within the input image that the feature occurs. This type of organization mimics the organization of biological image-processing systems. A second layer of nodes 2130 may operate as aggregators, each producing an output value that represents the output of some function of the corresponding output values of multiple nodes in the first node layer 2104. For example, second-a layer node 2132 receives, as input, the output from four first-layer nodes 2106 and 2110-2112 and produces an aggregate output. As with the first-level nodes, the second-level nodes also contain subnodes, with each second-level subnode producing an aggregate output value from outputs of multiple corresponding first-level subnodes.

FIG. 21B illustrates the kernel-based or filter-based processing carried out by a convolutional neural network node. A small subregion of the input image 2136 is shown aligned with a kernel or filter 2140 of a subnode of a first-layer node that processes the image subregion. Each pixel or cell in the image subregion 2136 is associated with a pixel value. Each corresponding cell in the kernel is associated with a kernel value, or weight. The processing operation essentially amounts to computation of a dot product 2142 of the image subregion and the kernel, when both are viewed as vectors. As discussed with reference to FIG. 21A, the nodes of the first level process different, overlapping subregions of the input image, with these overlapping subregions essentially tiling the input image. For example, given an input image represented by rectangles 2144, a first node processes a first subregion 2146, a second node may process the overlapping, right-shifted subregion 2148, and successive nodes may process successively right-shifted subregions in the image up through a tenth subregion 2150. Then, a next down-shifted set of subregions, beginning with an eleventh subregion 2152, may be processed by a next row of nodes.

FIG. 21C illustrates the many possible layers within the convolutional neural network. The convolutional neural network may include an initial set of input nodes 2160, a first convolutional node layer 2162, such as the first layer of nodes 2104 shown in FIG. 21A, and aggregation layer 2164, in which each node processes the outputs for multiple nodes in the convolutional node layer 2162, and additional types of layers 2166-2168 that include additional convolutional, aggregation, and other types of layers. Eventually, the subnodes in a final intermediate layer 2168 are expanded into a node layer 2170 that forms the basis of a traditional, fully connected neural-network portion with multiple node levels of decreasing size that terminate with an output-node level 2172.

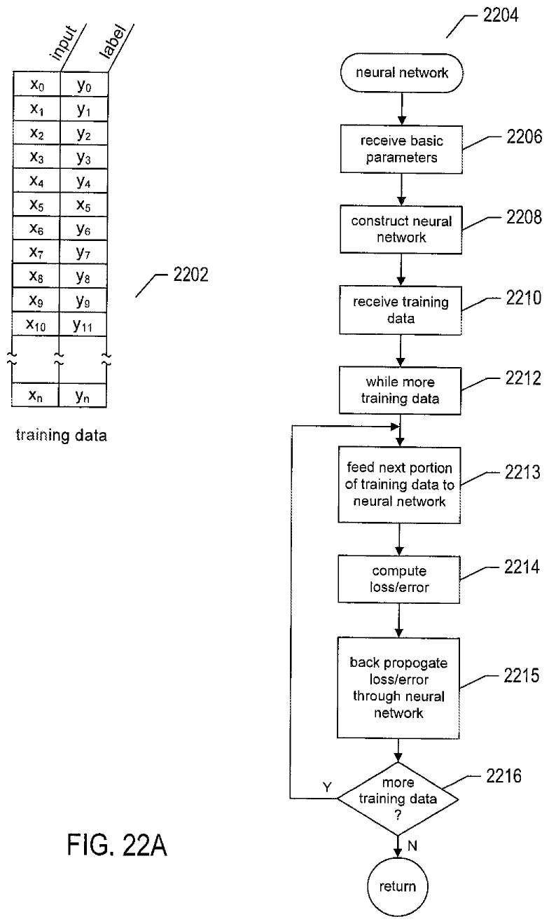

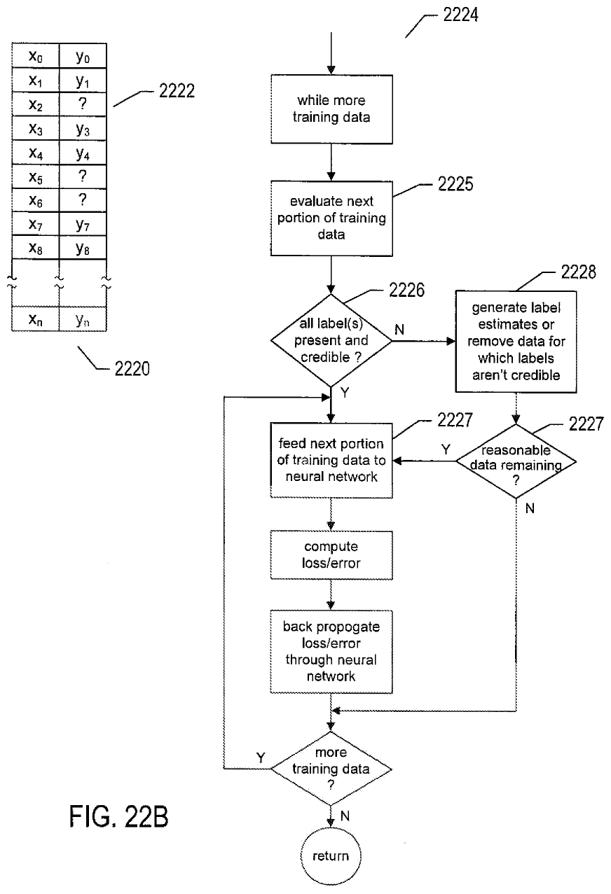

FIGS. 22A-B illustrate neural-network training as an example of machine-learning-based-subsystem training. FIG. 22A illustrates the construction and training of a neural network using a complete and accurate training dataset. The training dataset is shown as a table of input-vector/label pairs 2202, in which each row represents an input-vector/label pair. The control-flow diagram 2204 illustrates construction and training of a neural network using the training dataset. In step 2206, basic parameters for the neural network are received, such as the number of layers, number of nodes in each layer, node interconnections, and activation functions. In step 2208, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 2210, training data represented by table 2202 is received. Then, in the while-loop of steps 2212-2216, portions of the training data are iteratively input to the neural network, in step 2213, the loss or error is computed, in step 2214, and the computed loss or error is back-propagated through the neural network step 2215 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 22B illustrates one method of training a neural network using an incomplete training dataset. Table 2220 represents the incomplete training dataset. For certain of the input-vector/label pairs, the label is represented by a “?” symbol, such as in the input-vector/label pair 2222. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-flow diagram 2224 illustrates alterations in the while-loop of steps 2212-2216 in FIG. 22A that might be employed to train the neural network using the incomplete training dataset. In step 2225, a next portion of the training dataset is evaluated to determine the status of the labels in the next portion of the training data. When all of the labels are present and credible, as determined in step 2226, the next portion of the training dataset is input to the neural network, in step 2227, as in FIG. 22A. However, when certain labels are missing or lack credibility, as determined in step 2226, the input-vector/label pairs that include those labels are removed or altered to include better estimates of the label values, in step 2228. When there is reasonable training data remaining in the training-data portion following step 2228, as determined in step 2229, the remaining reasonable data is input to the neural network in step 2227. The remaining steps in the while-loop are equivalent to those in the control-flow diagram shown in FIG. 22A. Thus, in this approach, either suspect data is removed, or better labels are estimated, based on various criteria, for substitution for the suspect labels.

### Time-Series Data

FIGS. 23A-B illustrate time-series data. As discussed above with reference to FIGS. 11-13, distributed computing systems generally include a large number of event-message sources that generate large volumes of event messages which are collected, processed, analyzed, and stored by administrative computer systems for use in system monitoring, diagnostics, and administration. The data contained in time-stamped event messages are one example of a source of time-series data. As shown in FIG. 23A, a series of time-stamped event messages 2302-2310 containing one or more metric-data fields, such as metric-data field 2312, can be more abstractly viewed as time-series data 2314 consisting of an ordered series of time/data-value pairs. For example, the time data-value pair 2316 is associated with a time value tₙ₊₃ 2318 corresponding to the timestamp for event message 2305 and a data value 2320 extracted from the metric-data field 2322 in event message 2305. In certain cases, the data value may be a scaler value, such as an integer value or floating-point value, but may also be, in other cases, a vector of integer or floating-point values. For many different types of time-series-data analyses, it is assumed that the time/data-value pairs are spaced apart, in time, by a constant time increment or time interval, but various methods for interpolating data values can be used to convert time-series data with variable time increments into time-series data with a fixed, constant time increment. Time-series data may be viewed as a discrete scaler-valued or vector-valued function of time, for certain purposes. Time-series data may be inherently discrete but may, in other cases, represent sampling from a signal or function that is continuous in time.

A variety of different types of notation may be used to represent time-series data. Time-series data is often represented as a sequence of time-indexed values, “ . . . yₜ₋₂, yₜ₋₁, yₜ, yₜ₊₁, yₜ₊₂, . . . ,” where t is an arbitrary reference point in time. This representation allows for compact definitions of particular types of time series.

FIG. 23B provides examples of a number of different classes of time series. The first example is a stationary time series (“STS”) 2330. As discussed further, below, a stationary time series may be characterized by an average value and a variance that are both independent of time, in the sense that the average value and variance computed for two different non-overlapping subsequences of time/value pairs in the time series approaches an identical value with increasing lengths of the two different non-overlapping subsequences. In addition, a stationary time series is characterized by autocovariances, for different time lags k, that are also independent of time, as further discussed below. FIG. 23B shows three different examples of STSs 2332, 2333, and 2334. The first example 2332 is a stochastic stationary time series where the values are randomly selected from a range of possible values [−a, a]. The second example is a non-repeating, oscillating time series in which the value yₜ at time t is the sine of t plus a value randomly selected from the range of possible values [−a, a]. The third example is a more complex, non-repeating oscillating time series. A second exemplary type of time series illustrated in FIG. 23B is a linear-trend stationary time series (“LTSTS”) 2336. In a prototype expression for an LTSTS 2338, the value at time t is computed as the sum of a constant c, a linear term in t, λt, and the value, at time t, of an STS, εₜ. A third type of times series illustrated in FIG. 23B is a unit-root time series (“URTS”) 2340. In a prototype expression for a URTS 2342, the value at time t is computed as the sum of the value at time t−1, yₜ₋₁, and the value, at time t, of an STS, εₜ, with the value at time t=0, y₀, equal to ε₀. A fourth type of times series illustrated in FIG. 23B is a unit-root time series with drift (“URDTS”) 2344. In a prototype expression for a URDTS 2346, the value at time t is computed as the sum of the value at time t−1, yₜ₋₁, a constant c, and the value, at time t, of an STS, εₜ, with the value at time t=0, y₀, equal to ε₀+c.

In the lower portion of FIG. 23B, definitions are provided for the average value, variance, and autocovariance of an STS. The average value of the STS, μ_{c}, or the mean of the time series, is the expected value of an arbitrary term of the time series 2348, which can be estimated as the average of a finite subsequence of values selected from the time series 2350. Similarly, the variance for the time series is the expected value of the square of an arbitrary term minus the mean for the time series 2352, which can be estimated by the variance of a finite subsequence of the time series 2354. The autocovariance, cov[yₜ, yₜ₊ₖ], of an STS for a lag k, the time interval k between two elements of the time series, is the expected value of the product of the difference between the two elements and the mean for the series 2356, which can again be estimated from a finite subsequence of the time series 2358.

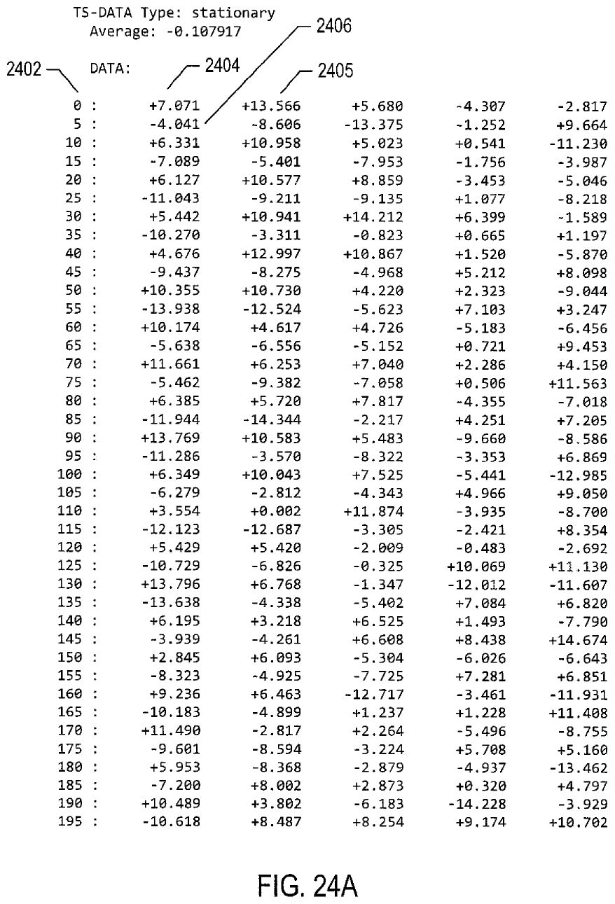

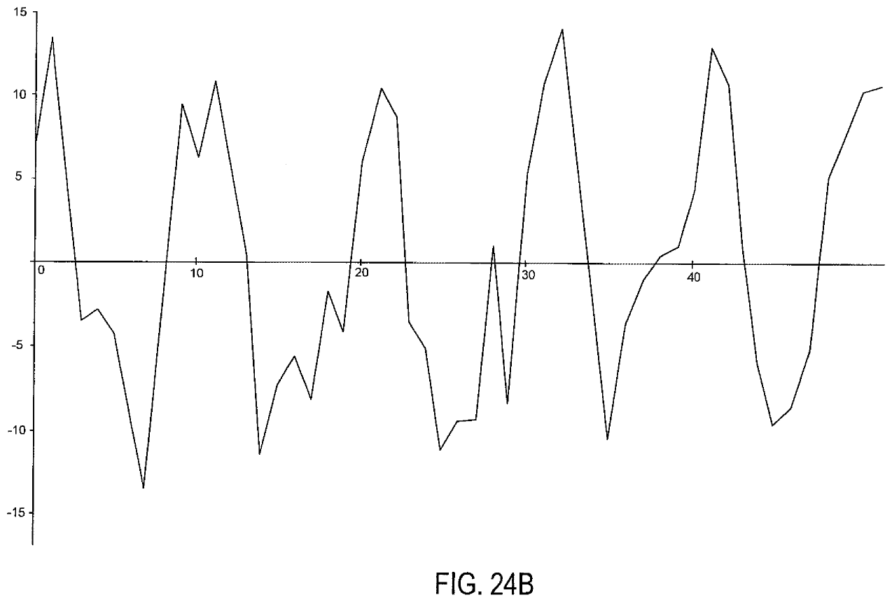

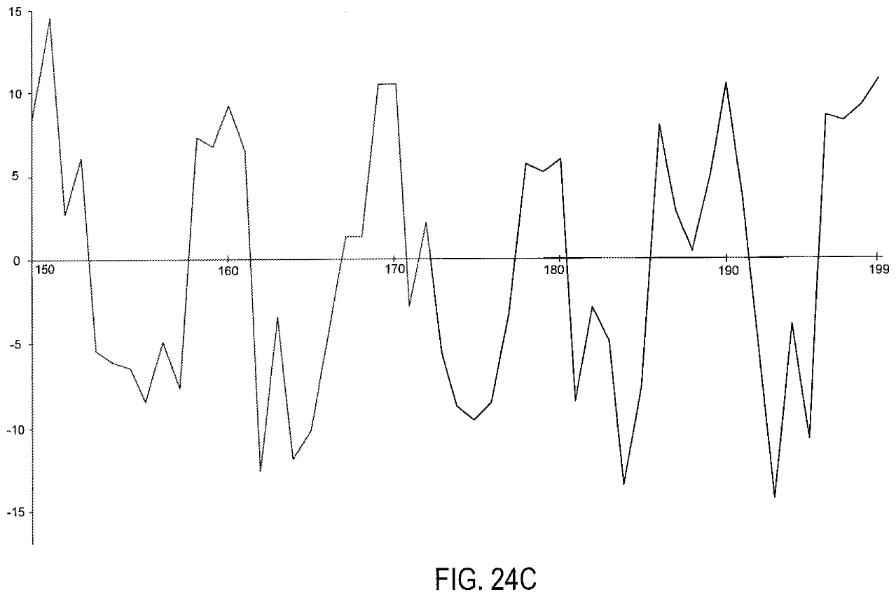

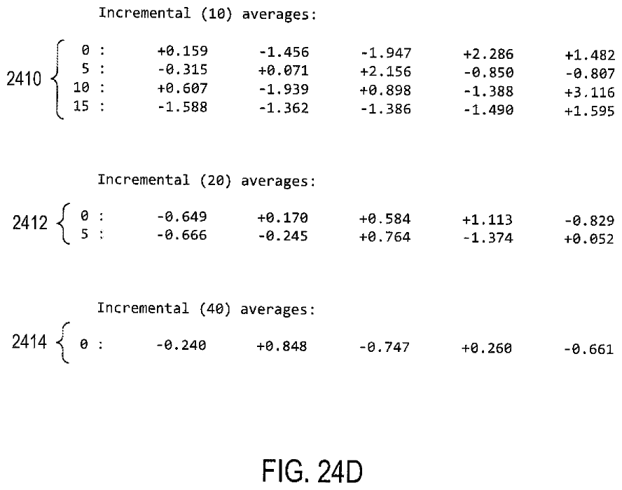

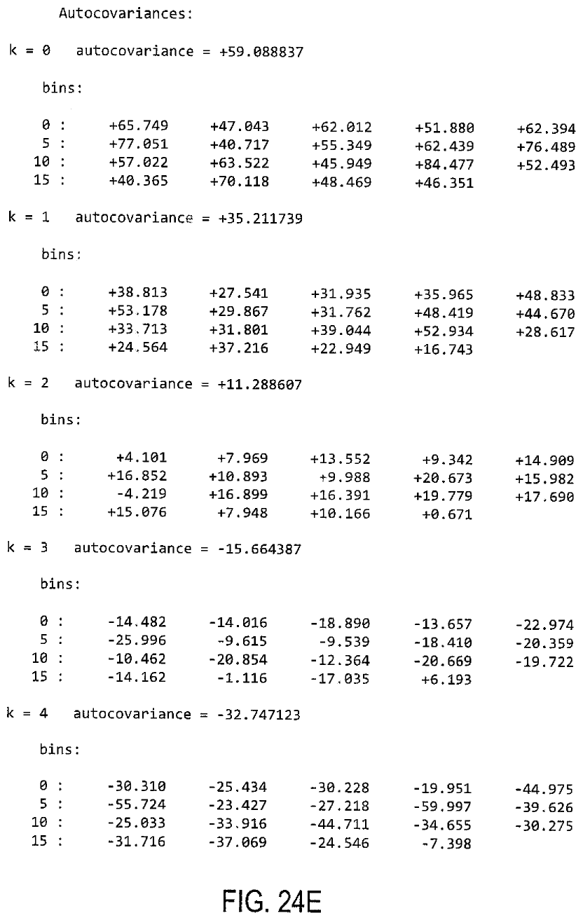

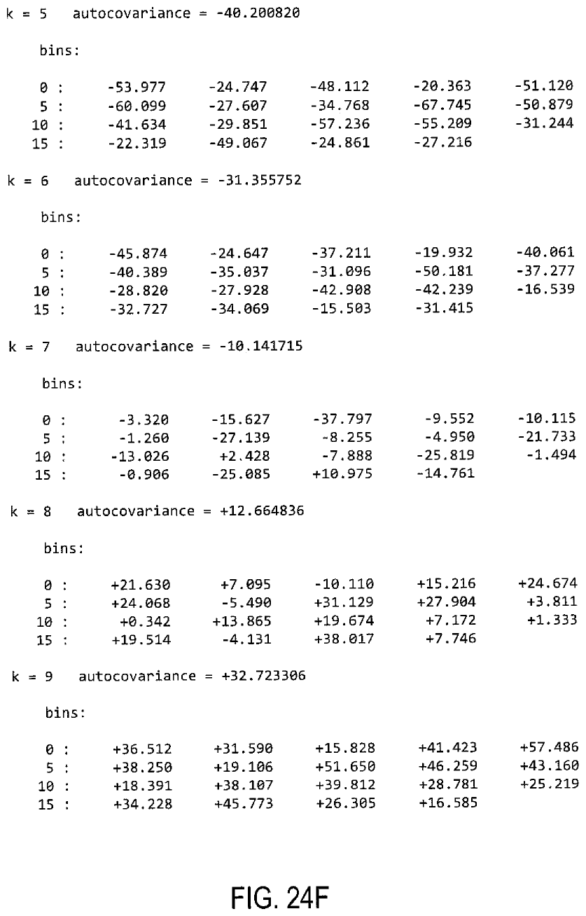

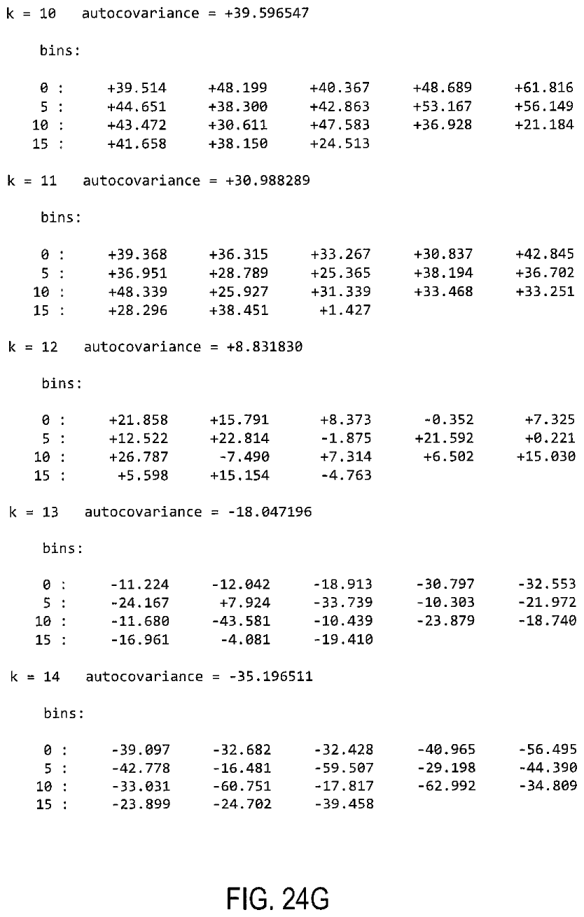

FIGS. 24A-G show data and plots for a stationary time series (“STS”). FIG. 24A lists 200 time-ordered values for the STS. Each row of values contains five successive time-series of values beginning with the value associated with the time indicated in the first column 2402. Thus, y₀=7.071 (2404), y₂=13.566 (2405), and y₅=−4.041 (2406). From the sequence of numerical values in FIG. 24A, the oscillatory nature of the STS is apparent. FIG. 24B shows a plot of the first 52 values of the STS shown in FIG. 24A. For clarity, the points corresponding to the 52 discrete values are connected by straight lines but, to be accurate, the actual data comprises the points at the vertices of the curve shown in FIG. 24B. As can be seen in the plot shown in FIG. 24B, the STS does oscillate somewhat regularly, but is also apparently non-repeating. FIG. 24C shows a plot of the final 52 discrete values of the STS shown in FIG. 24A. The oscillatory nature of the time series is again apparent in this plot, as is the non-repeating nature of the time series. FIG. 24D shows three sets of subsequence averages for the STS shown in FIG. 24A. The first set of averages 2410 represent the average value for successive non-overlapping subsequences of 10 time/value pairs. Even though the time series includes positive values greater than 14.0 and negative values less than −14.0, the 10-value averages range only from −1.947 to 3.116. A second set of averages 2412 represents the average value for successive subsequences of 20 time value pairs. Here, the values range from −1.374 to 1.113. A third set of averages 2414 represents the average value for successive subsequences of 40 time/value pairs. In this case, the average values range from −0.747 to 0.848. As the length of the STS increases, and the lengths of the subsequences for which averages are computed increases, the computed average values for the subsequences approaches a mean value, 0.0 in the case of the STS of FIG. 24A. FIGS. 24E-G show autocovariances for lags k=0 to 14 for the STS shown in FIG. 24A. For each value of k, the autocovariance computed over the entire 200 time/value pairs is first shown, followed by the autocovariances computed for successive 10-time/value-pair subsequences. The autocovariances for lag k=0, 59.088837, is the variance for the STS shown in FIG. 24A. As can be seen in FIGS. 24 E-G, the 10-time/value-pair autocovariances computed for each k vary, about a mean, due to the small sample size, but are generally distributed closely around the value for the autocovariance for the time lag computed for the entire 200 values shown in FIG. 24A. As the length of the STS increases and the lengths of the subsequences for which the autocovariances are computed increase, the autocovariances computed for subsequences for a given k would approach a single, limit value. However, the value of the autocovariance computed for a first k would generally differ from the autocovariance computed for a second k.

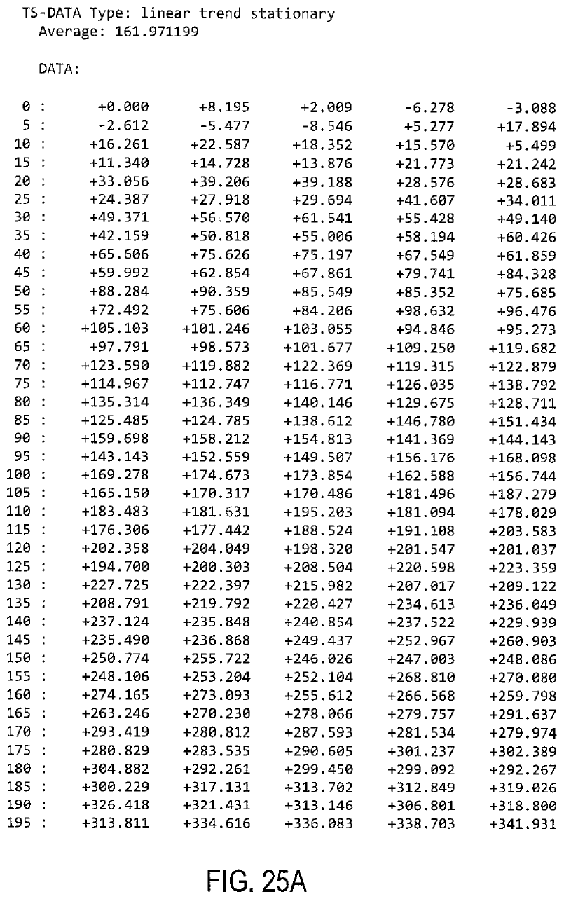

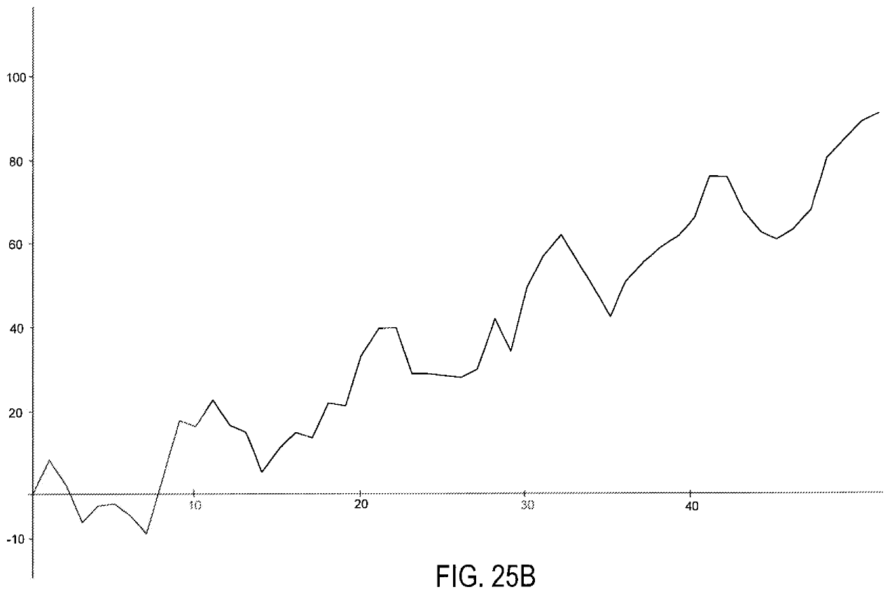

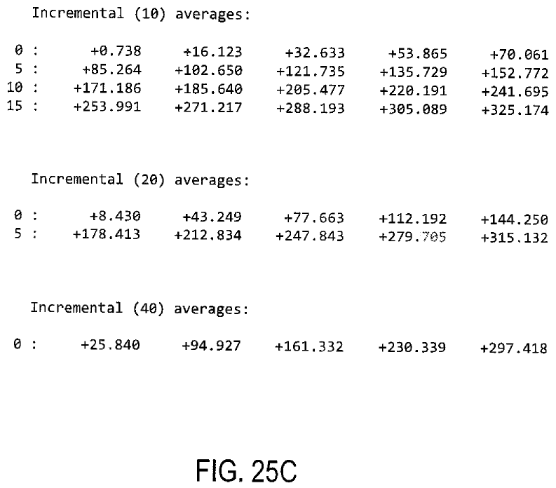

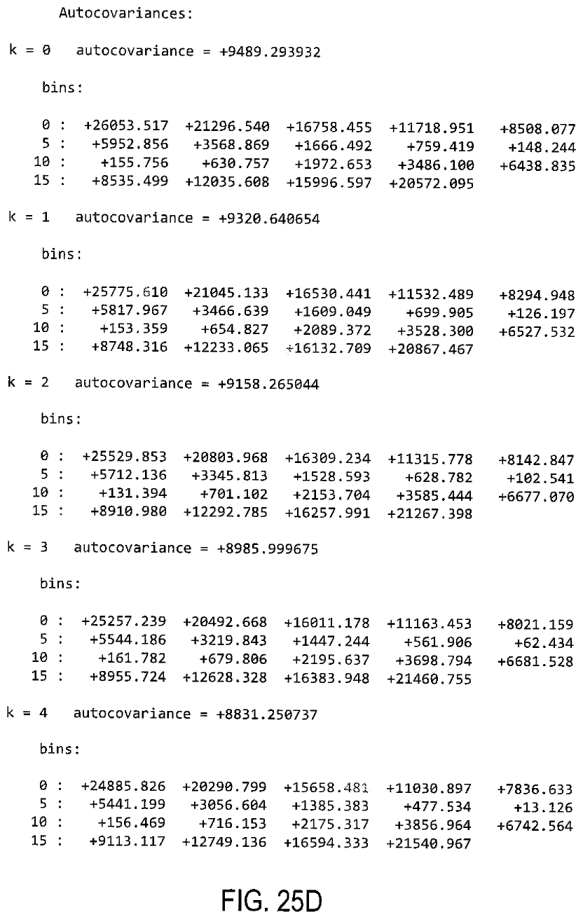

FIGS. 25A-D show a linear-trend stationary time series t″LTSTS″), using the same illustration conventions as used in FIGS. 24A-G. In the plot of the first 52 values of the LISTS, shown in FIG. 25 B, it is readily apparent that, although the time series is both oscillatory and non-repeating, there is a definite linear trend, or positive slope, to the plotted curve. As can be seen in the computed averages, shown in FIG. 25C, the average values computed for successive subsequences uniformly increase. From the autocovariances, shown in FIG. 25D, it is evident that the autocovariances for a given lag k are not time independent.

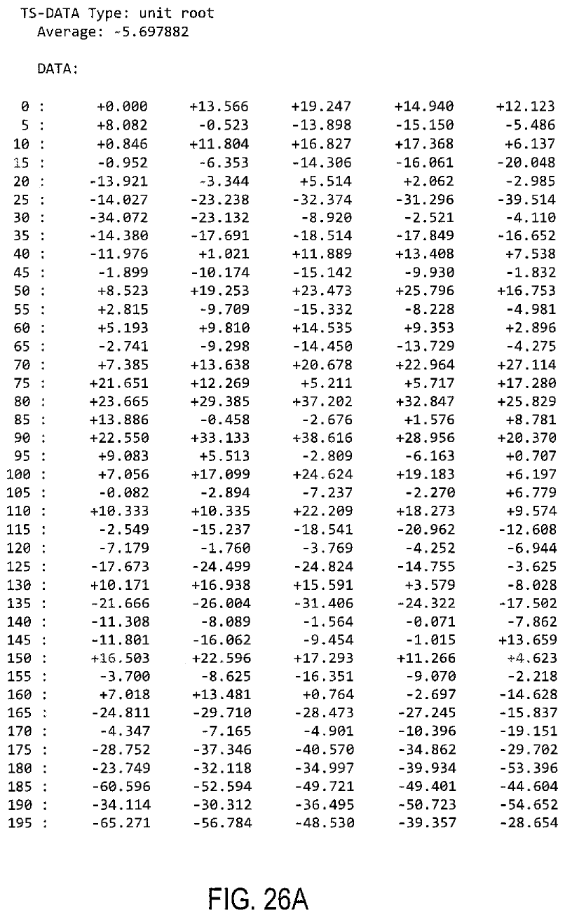

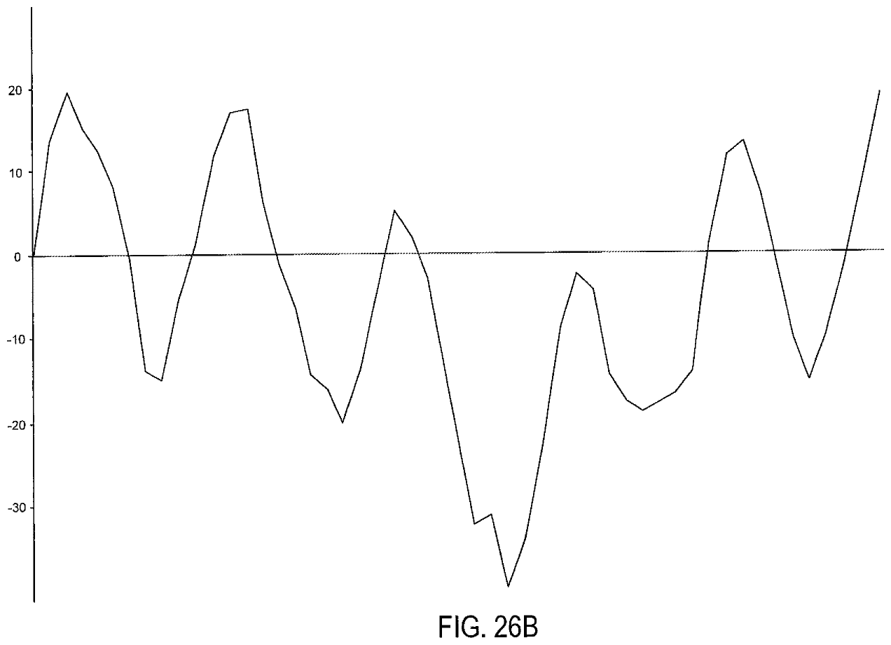

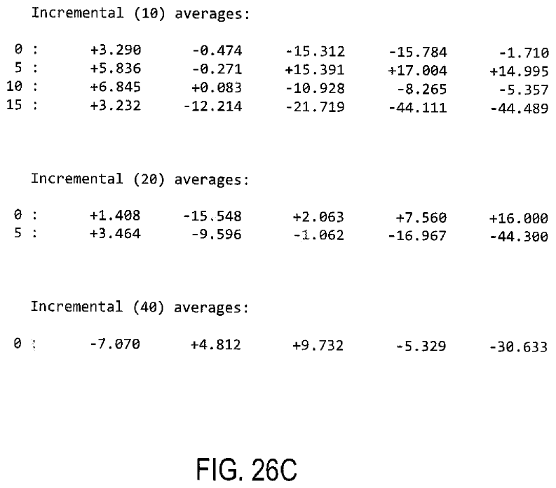

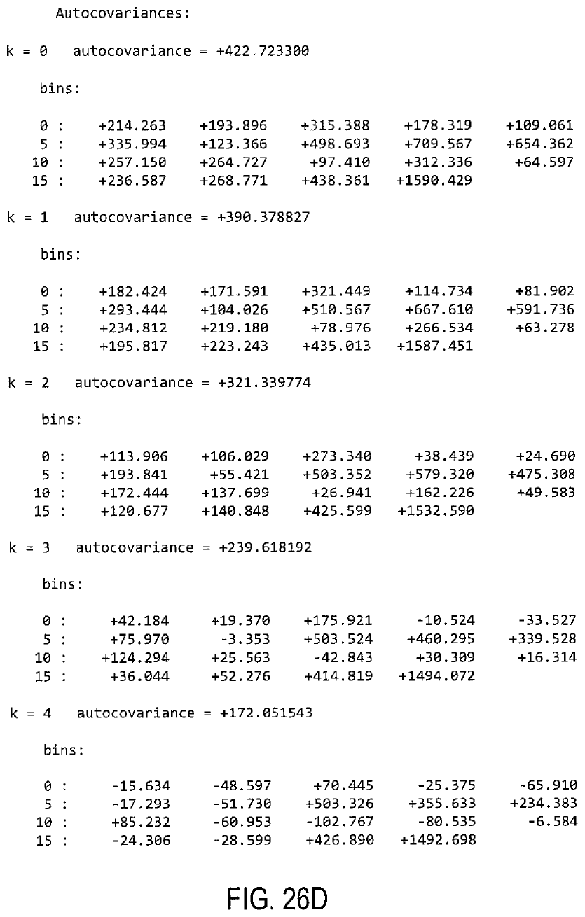

FIGS. 26A-D show a unit-root time series (“URTS”), using the same illustration conventions as used in FIGS. 24A-G and FIGS. 25A-D. In the plot of the first 52 values of the URTS, shown in FIG. 26B, it is clear that the time series is both oscillatory and non-repeating. However, this time series is not stationary, since a large random excursion in the value at a particular time point can affect the subsequent behavior of the time series, so that the time series does not have time-independent averages, variances, and autocovariances for given lags. As can be seen in the computed averages, shown in FIG. 26C, the average values computed for successive subsequences vary significantly and nonuniformly with respect to time, as do the autocovariances for a given lag k, as shown in FIG. 26D.

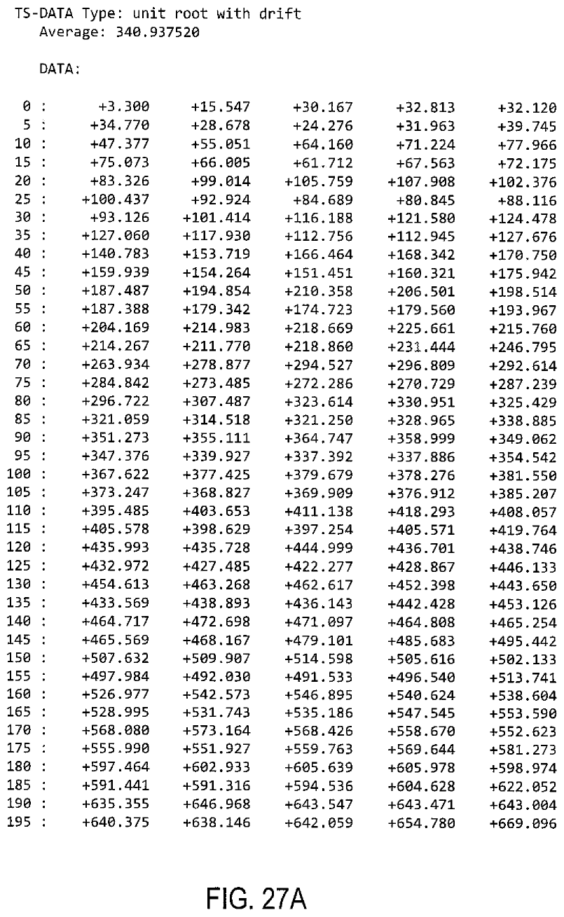

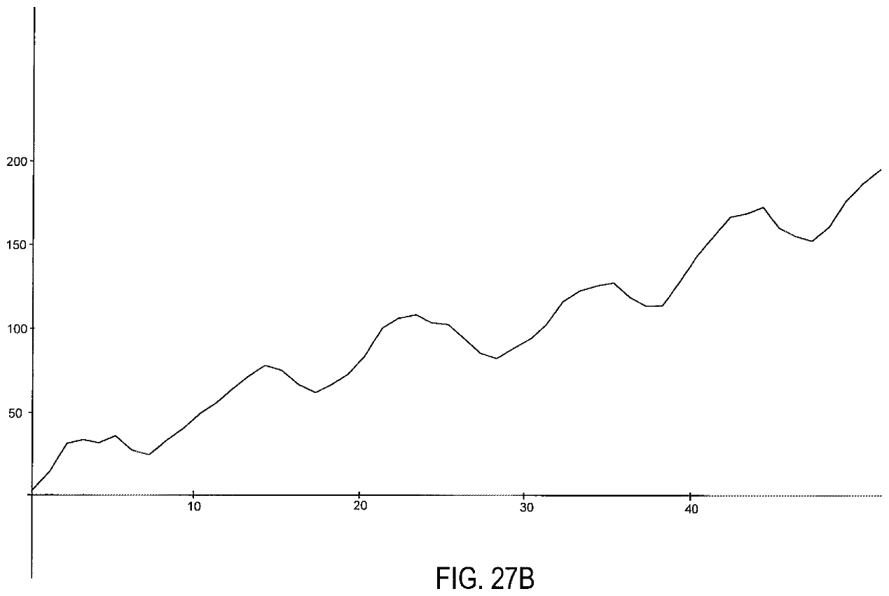

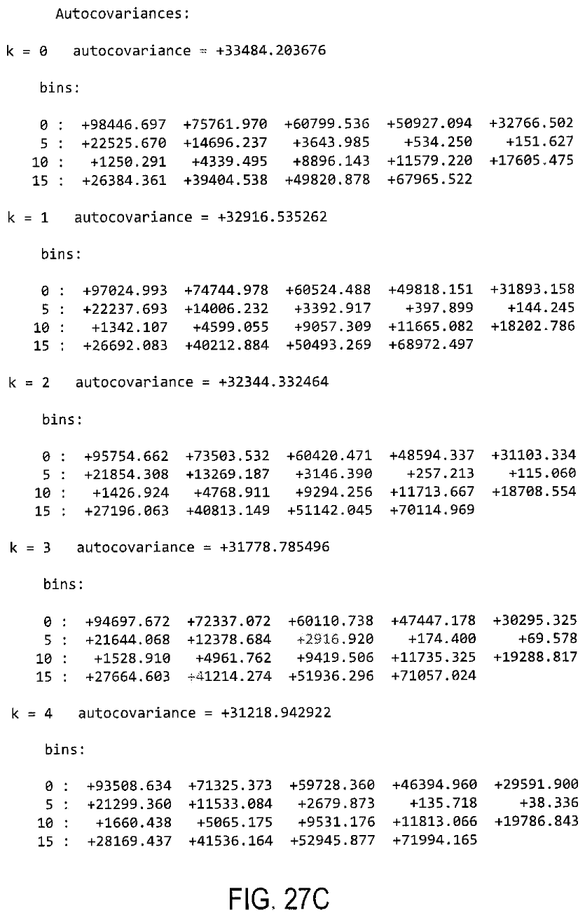

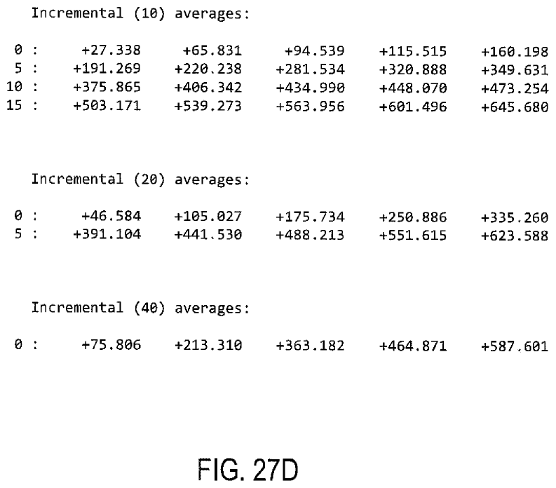

FIGS. 27A-D show a unit-root with drift time series (“URDTS”), using the same illustration conventions as used in FIGS. 24A-G, FIGS. 25A-D, and FIGS. 26A-D. In the plot of the first 52 values of the URTS, shown in FIG. 27B, it is clear that the time series is both oscillatory and non-repeating. However, this time series is not stationary, since a large random excursion in the value at a particular time point can affect the subsequent behavior of the time series and because there is a pronounced linear trend, or slope, to the plotted curve, as a result of which the time series does not have time-independent averages, variances, and autocovariances for given lags. As can be seen in the computed averages, shown in FIG. 27C, the average values computed for successive subsequences vary significantly and nonuniformly with respect to time, as do the autocovariances for a given lag k, as shown in FIG. 27D.

The LTSTS, URTS, and URDTS shown in FIGS. 25A-27D are all generated from an underlying STS, as discussed above with reference to FIG. 23B. In these examples, the underlying STS is identical to the STS shown in FIGS. 23A-G, in all cases. However, these types of time series may have very different forms depending on the nature of the underlying STS, which may not be oscillatory and may be repeating. Nonetheless, regardless of the nature of the underlying STS, LTSTSs, URTSs, and URDTSs are not stationary. It should also be pointed out that there are number of different sets of criteria for stationarity. The criteria discussed above correspond to criteria referred to as “weak stationarity.”

### Currently Disclosed Methods and Systems

There are various reasons for attempting to forecast future time-series values based on current and past time-series values. For example, when metric data are collected and analyzed by an administrative computer system, administrators may desire automated forecasts of future metric-data values indicative of likely future states of the distributed computer system. Data related to computing-resources and capacities, for example, may include trends indicating that additional processor bandwidth or mass-storage capacity may be needed, in the near future, due to increasing workloads, in order to prevent delays and failures and/or to maximize economic efficiency. Data related to failures and anomalies detected in particular subsystems or devices may be indicative of an approach to catastrophic failure of one or more subsystems or devices. Of course, metric data distributed computer systems are but one example of many different types of sources of time-series data for which automated processing and automated forecasts may be desired. Additional examples independent of distributed computing systems include time-series of data related to utilities consumption, stock prices and trading volumes, airline-ticket purchases, and traffic congestion and accidents.

Many different approaches that have been developed for generating forecasts from time-series data. Analysis of time-series data is a significant branch of mathematics and computing that includes a variety of different types of analytic procedures, computational tools, and forecasting methods. However, there are many different types of time series relevant to many different types of applications for which accurate forecasting methods have yet to be developed. In addition, certain applications require relatively quick forecasts based on the most recent data, and are thus associated with significant temporal constraints, forestalling lengthy and computationally intensive analyses. In other applications, including cloud-computing applications, the price of complex computational processes needed for accurate forecasting may outweigh the benefits of the forecasts produced by the computational processes.

Use of neural networks, including multi-level and convolutional neural networks, has produced significant advances in a variety of different types of computational tasks, including natural-language processing, pattern matching, face recognition, data analysis, system control, robotics, and computational vision. Neural networks can be trained to carry out these tasks with a level of accuracy that would be far harder to achieve by attempting to design and program logical, analytic solutions. Use of neural networks, and other machine-learning techniques, for time-series-based forecasting may represent a productive approach to time-series analysis and forecasting. FIG. 28 illustrates a desired implementation for using neural networks in cloud-computing environments to provide forecasts based on time-series data. The collected and preprocessed time-series data 2802 would be submitted to a neural network 2804, implemented, trained, and running within the cloud-computing facility 2805, which would produce a forecast of n future time-series data values 2806 based on m collected time-series data values 2808, where n it is generally smaller than m. For example, the time-series-data forecasting system could be provided to cloud-computing-facility clients, or clients of an organization leasing computational resources from the cloud-computing facility, as a service to provide forecasts based on time-series data collected by the clients.

A naïve implementation of a neural-network-based time-series-data forecasting system within a cloud-computing facility would likely fail to provide adequate response times and would likely be far too expensive for most clients. Training and storing neural networks is both time-consuming and expensive with respect to the necessary mass-storage and memory resources that would be needed to be leased from the cloud-computing facility. In particular, it would not be feasible to train and store special-purpose neural networks for all of the different possible types of time series. A naïve attempt to train a single neural network to analyze all of the various different types of time-series data that might be generated by clients would also likely fail, since there are so many different types of time-series data, since the different types of time-series data exhibit different types of behaviors and temporal patterns, and because a single neural network would need a vast number of nodes and even vaster sets of training data to produce reasonable forecasts for general time-series data.

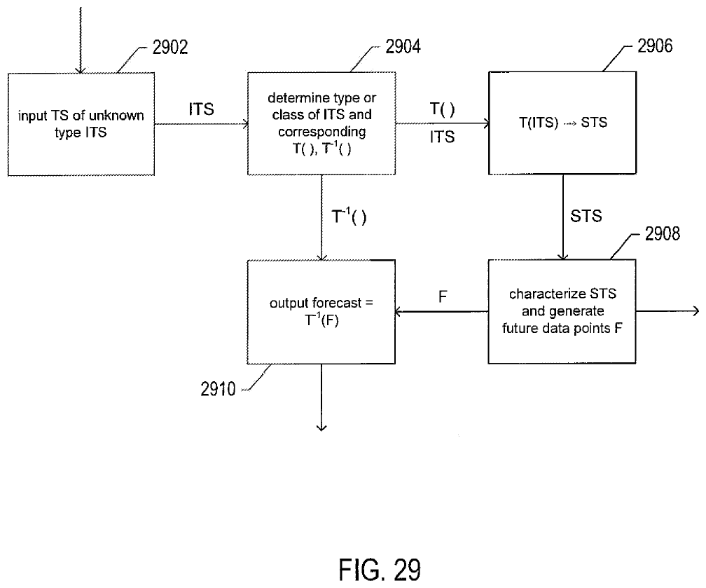

FIG. 29 illustrates a general approach embodied in the currently disclosed neural-network-based methods and systems that generate forecasts from time-series data. In the currently disclosed approach, time-series data, referred to as a “time series” (“TS”), of unknown type is input to the forecasting system or subsystem 2902. The input TS is referred to as the “ITS” in FIG. 29. Following various types of preparation and preprocessing, the ITS is input to a TS-type-determination subsystem or module 2904, which determines the type or class of the ITS. In addition, the TS-type-determination subsystem or module retrieves a transform inverse-transform pair T( )/T⁻¹( ) for the determined type or class of the ITS. The forward transform T( ) and the ITS are input to a transform module 2906 that uses the forward transform to transform the ITS to a corresponding stationary time series STS. The corresponding STS is then input to a forecast module 2908, which submits the corresponding STS to a forecasting neural network or other type of machine-learning-based forecasting subsystem, which generates a set of time-ordered future datapoints F from the STS. The forecasting module transmits the set of future datapoints F to a reverse-transform module 2910, which receives the reverse transform determined for the ITS from the TS-type-determination subsystem or module 2904 and applies the reverse transform to the set of future datapoints F to generate an output forecast. Of course, the forward transform, or transform, and the reverse transform, or inverse transform, for an input stationary TS are essential no-op transforms that do not alter a time series to which they are applied. This approach addresses the problems discussed in the preceding paragraph and various additional problems that would be associated with naïve implementations. Because the neural network or other type of machine-learning subsystem needs only to generate forecasts from stationary time series, it is feasible to train a single neural network to produce accurate forecasts from a wide variety of different types of STSs. Thus, the expense and time that would be associated with attempting to train and store special-purpose neural networks or other machine-learning subsystems to handle each of various different types of input time-series data is avoided. Furthermore, the development and training of the forecasting neural network or other type of machine-learning subsystem can be carried out in a private computing facility, rather than a cloud-computing facility, in order to economically develop and train the forecasting subsystem. The trained forecasting subsystem can be exported from the private computing facility to a cloud-computing facility for application to client time-series data as one or more formatted data files that include specifications of the number of inputs, outputs, node levels, node weights, and node types for a neural network or similar specifications for other types of machine-learning subsystems. In alternative implementations, a small number of neural networks or other machine-learning-based subsystems may be developed and trained to handle a small number of broad, different classes of STSs, in the case that the STS class of an unclassified STS can be readily identified, so that more specific training can be carried out for each of the broad classes. In other words, the currently disclosed approach need not rely on a single neural network or other machine-learning-based subsystem, but may use a small number of such neural networks or other machine-learning-based subsystems, provided that the computational and cost overheads do not outweigh the value of the time-series-data analysis-service provided.

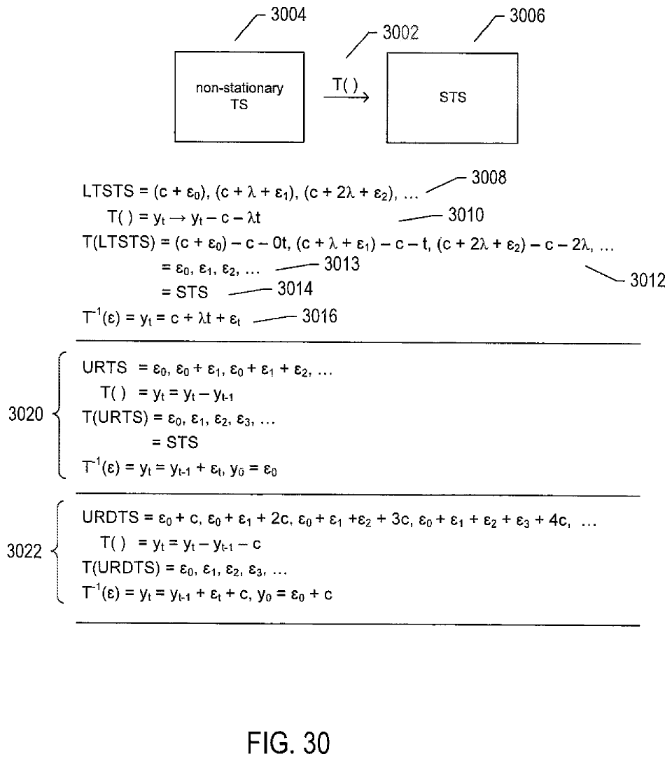

FIG. 30 shows forward and reverse transforms, discussed in the preceding paragraph, for several of the different types of time series discussed above with reference to FIGS. 23B and 24A-27D. As discussed above, the forward transform 3002 transforms a non-stationary TS 3004 to a corresponding STS 3006. The LTSTS can be represented as shown in expression 3008. The forward transform is shown in expression 3010. Application of the forward transform to the LTSTS is shown by expressions 3012-3014. As can be seen, the forward transform indeed transforms the LTSTS into the same STS that is a component of the original LTSTS. The inverse transform 3016 is simply the original expression for the LISTS (2338 in FIG. 23B). Using similar illustration conventions, FIG. 30 shows the forward and inverse transforms for the URTS 3020 and the URDTS 3022. Forward and inverse transforms for a variety of other types of time series have been, or can easily be, determined.

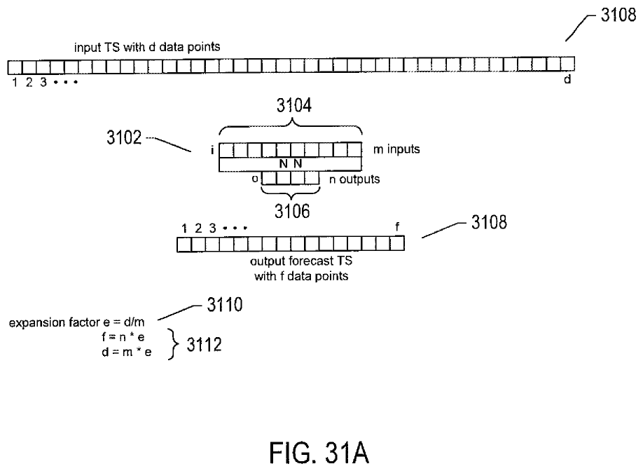

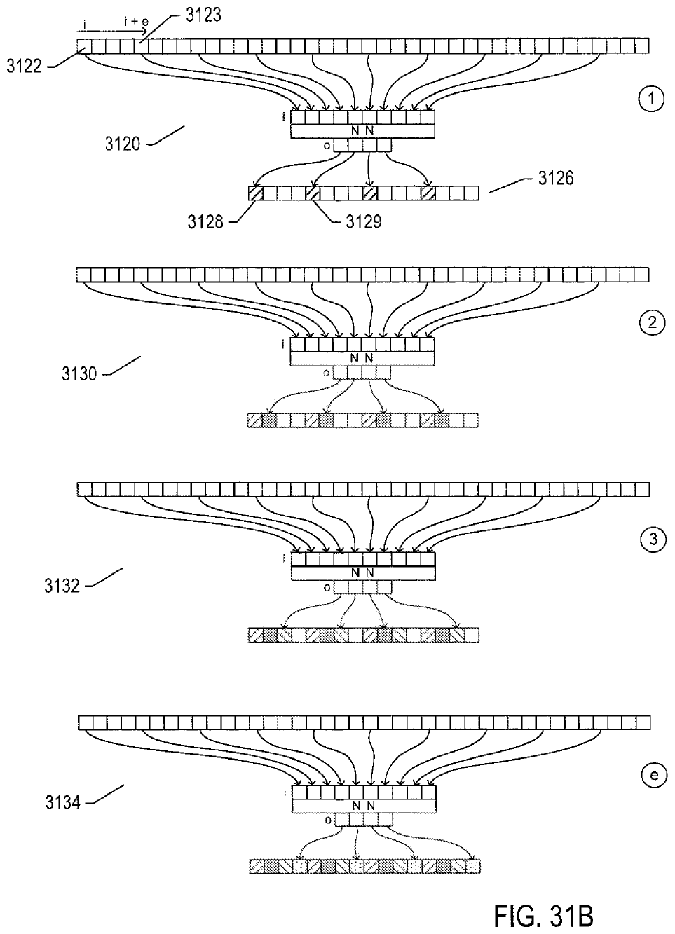

Because the currently disclosed approach uses a single neural network, or other type of machine-learning subsystem, or a small number of such subsystems, and because time-series data may include vector data as well as scaler data, a flexible approach to employing between one and a small number of neural networks or other type of machine-learning systems is needed. FIGS. 31A-B illustrates a method for generating forecasts by a forecasting neural network based on a greater number of data values than the number of inputs m for the neural network. As shown in FIG. 31A, the neural network 3102 has m inputs and n outputs 3106. It is desired to use a total of d successive values from the input TS 3108, where d is an integer multiple of m. The neural network generates a forecast containing ƒ future values, where ƒ is an integer multiple of n. As shown by expression 3110, the input expansion factor e can be computed by dividing d by m. The input expansion factor e is thus the integer multiple of n and m that gives ƒ and d 3112. An analogous problem arises for vector-based time series, in which case the length of the vector may correspond to e and the approach used to consider a sufficient number of datapoints to forecast a corresponding sufficient number of future time-associated data values.

FIG. 31B illustrates the input-expansion method. This method involves a total of e steps, or passes. In a first step 3120, values separated by e−1 intervening values, such as values 3122 and 3123, are selected from the d values of the input TS to generate m input values to the neural network. The n forecast values output by the neural network are then entered into the ƒ output values 3126 spaced apart by e−1 intervening value slots, such as output values 3128 and 3129. In essence, in the first pass, a time series containing m values with a time interval equal to the product of e and the original time interval is generated from the input TS for input to the neural network, which produces a set of n forecast values with a time interval equal to the product of e and the original time interval, which are then distributed across the eventual set off forecast values with the original time interval. In the second step 3130, a process similar to that carried out in the first step is employed, but involving input and output data values shifted by one position with respect to the input and output data values of the preceding pass. The third step 3132 again uses the same process, but shifted by one position, and the final e^{th} step 3134 again employs the same process, shifted by e positions with respect to the first step.

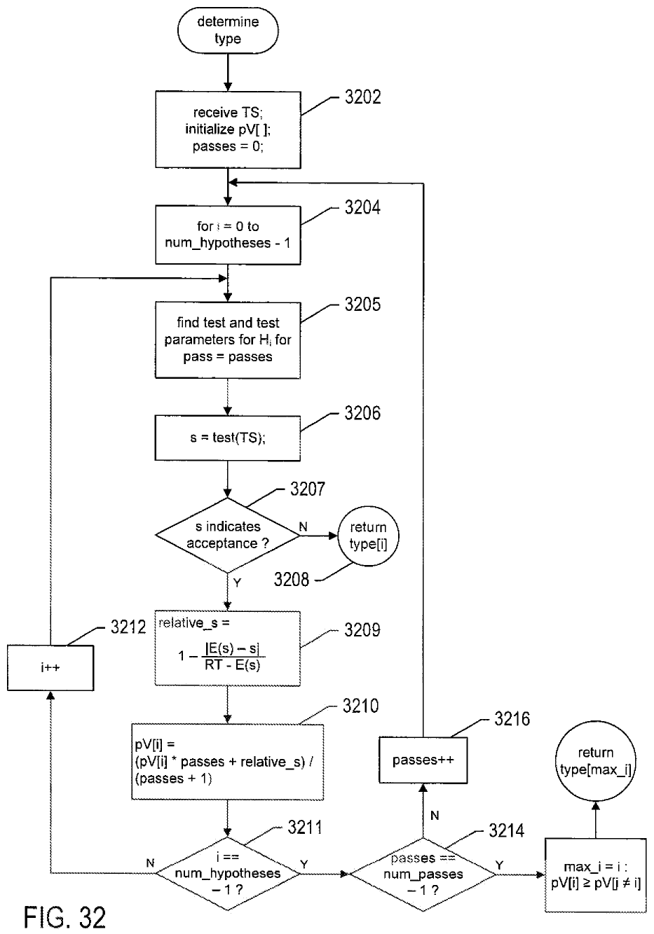

FIG. 32 provides a control-flow diagram that represents one implementation of the TS-type-determination subsystem or module discussed above with reference to FIG. 29. In step 3202, the subsystem receives an input TS, initializes an array of relative statistic values pV[ ], and sets a local variable passes to 0. In the for-loop of steps 3204-3212, each of a series of null hypotheses is statistically tested. Each null hypothesis assumes that the type or class of the input TS is a particular type or class. When the null hypothesis cannot be rejected based on a computed statistic and a known distribution for the statistic, the hypothesis is accepted and the type or class assumed by the hypothesis is returned as the type or class of the input TS. In step 3205, the test and test parameters for the currently considered hypothesis are retrieved from memory or mass storage. In step 3206, the input TS is submitted to the statistical test, which returns a test statistic s. When the test statistic indicates that the hypothesis should not be rejected, as determined in step 3207, the type or class assumed by the hypothesis is returned in step 3208. Otherwise, a relative statistic is computed from the test statistic s returned by the test, in step 3209, and added to a running average for the type or class corresponding to the currently considered hypothesis, in step 3210. When there are more types or classes to consider, as determined in step 3211, the loop variable i is incremented, in step 3212, and control returns to step 3205 for another iteration of the for-loop of steps 3204-3212. When all of the types or classes have been considered, then, in step 3214, the subsystem determines whether another pass can be made through the types or classes. This may be possible when different values can be selected from the input TS to carry out the test for the type or class or when other tests are available for the types and classes. In the case that another pass is possible, the variable passes is incremented, in step 3216, and the for-loop of steps 3204-3212 is again executed. When there are no more passes, as determined in step 3214, the type or class having the greatest average relative statistic is selected as the type or class for the input TS.

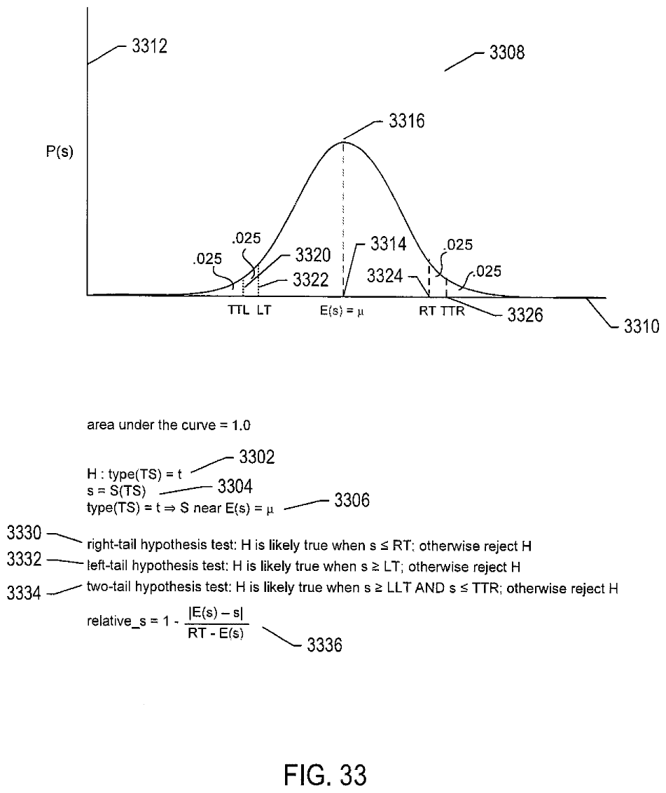

FIG. 33 illustrates an approach to statistically testing a TS-type hypothesis. The hypothesis is that the type of a particular TS is t, as indicated by expression 3302. In order to test this hypothesis, a statistical test S is carried out on TS to generate a test statistic s, as indicated by expression 3304. When the type of the TS is t, it would be likely for the test statistic to be near the expected value for the test statistic based on a known the probability distribution for the test statistic generated from TSs of type t, as indicated by expression 3306. In many cases, test statistics are normally distributed, but they need not be. In the upper portion of FIG. 33, plot 3308 illustrates the probability distribution P(s|type(TS)=t). The horizontal axis 3310 represents the possible values of the test statistic s and the vertical axis 3312 represents the probability that the statistical test carried out on a TS of type t produces a test statistic s. In this example, the test statistic is normally distributed and the expected value for the test statistic, E(s)=μ 3314, which corresponds to the peak 3316 of the probability distribution. There are three different types of hypothesis test, as shown in the lower portion of FIG. 33. These tests are based on four points along the horizontal axis: (1) TTL 3320; (2) LT 3322; (3) RT 3324; and (4) TTR 3326. Each of the four points can be thought of as dividing the area under the probability-distribution curve into two portions. The point TTL divides the area under the curve, which is equal to 1.0, into a left portion equal to 0.025 and a right portion equal to 0.975. The point LT divides the area under the curve into a left portion equal to 0.05 and a right portion equal to 0.95. The points RT and TTR are similarly positioned on the right-hand side of the probability distribution. The right-tail hypothesis test, as indicated by expression 3330, indicates that the hypothesis H it is likely to be true when the test statistic s has a value less than, or equal to, RT. The left hypothesis test, as indicated by expression 3332, indicates that the hypothesis H is likely to be true when the test statistic s has a value greater than, or equal to, LT. The two-tail hypothesis test, as indicated by expression 3334, indicates that the hypothesis H it is likely to be true when the test statistic s has a value greater than, or equal to, LTT and less than, or equal to, RTT. The positions of the four points are arbitrary, but are selected in order to provide a desired confidence in the test results. The relative statistic used in step 3209 of FIG. 32, indicated by expression 3336, has a value that increases as the value of the statistic s falls closer to the expected value E(s)=μ.

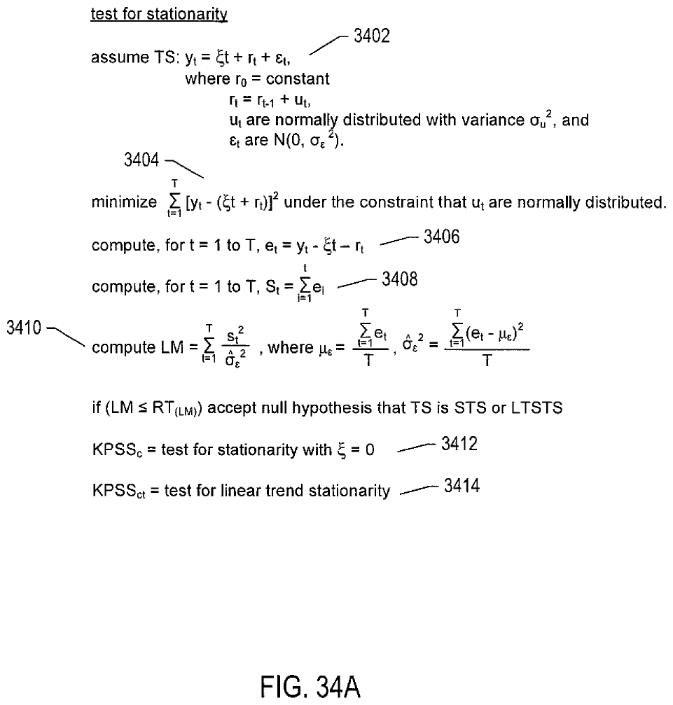

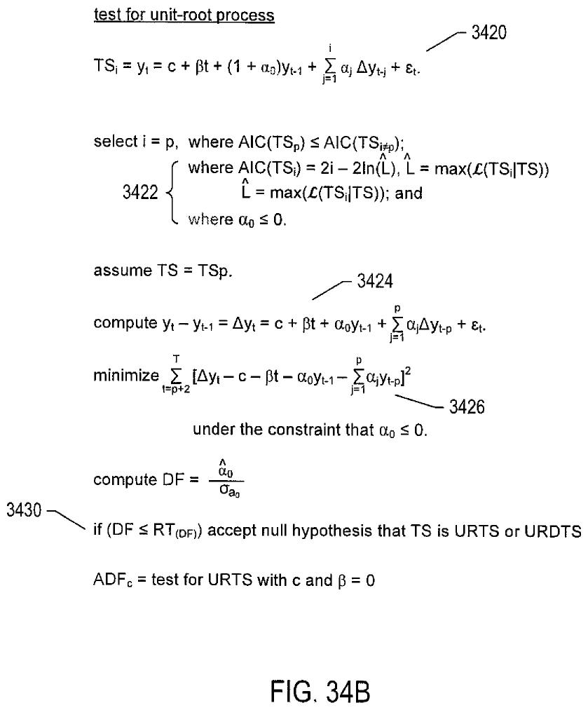

FIGS. 34A-B show examples of null hypothesis tests for TS types or classes. FIG. 34A shows several tests for stationarity. The TS is assumed to have the form 3402, which includes a term ξt linear in time, a random-walk term rₜ, and a stochastic-STS term εₜ, which is normally distributed. The system of linear equations can be obtained to adjust the parameters in the model 3402 to minimize the sum 3404 computed from the TS under the constraint that the random-walk steps uₜ are normally distributed. There are various mathematical methods to carry out this minimization, including various types of regression analysis, the simplex method, and other methods. Once the model parameters have been estimated, the model can be used to determine the errors for each value in the TS, as indicated by expression 3406. A value Sₜ is computed, as indicated by expression 3408, for each time point t in the TS, where Sₜ is the sum of the errors computed for the TS values up to the value associated with time point t. The test statistic LM is then computed according to expression 3410, which is the sum of the squares of the Sₜ values divided by the variance of the stochastic STS for all time points in the TS. When the model parameter ξ is 0, the test is referred to as the “KPSSc” test 3412, which tests for an STS, otherwise, the test is referred to as the “KPSSct” test 3414, which tests for an LTSTS.

FIG. 34B shows a test for a unit-root TSs. For this test, the TS is assumed to have the form 3420. Each value in the TS is computed from a constant term, a term linear in time, the preceding term in the TS, differences between the current term and previous terms, and a stochastic-STS term. The number of differences to use, i, is selected using the Akaike Information Criterion (“AIC”). Considering the test model to represent a set of test models TSi, where i ranges from 1 to some larger number, the test model to use for an input TS is selected as the test model for which the AIC has the smallest value. The AIC is computed by expression 3422, including a positive term proportional to the number of differences i and a negative term proportional to the likelihood that the model corresponds to the input TS. The parameter α₀ has a value less than or equal to 0. To carry out the test, a first-difference TS corresponding to the input TS is computed, as indicated by expression 2424. Then, a system of equations is generated to minimize the value 2426 by adjusting the model parameters under the constraint that α₀ is less than or equal to 0. Then, a Dickey-Fuller test statistic DF is computed 2428 as the ratio of the estimated value of the parameter an divided by the variance of an determined by the minimization procedure. A right-tail test on the test statistic is employed, as indicated by expression 2430. A specific example of this test is a test for a URTS, for which the parameters c and β are both 0.

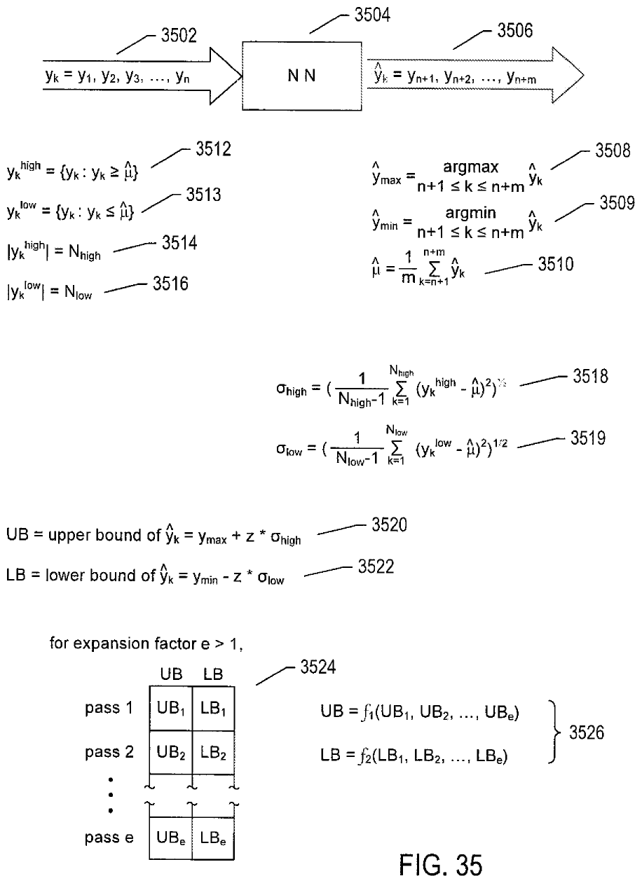

FIG. 35 illustrates computation of confidence bounds for the forecast produced by the neural network or other machine-learning-based forecasting system in the forecasting module 2908 shown in FIG. 29. In the example shown in FIG. 35, an input TS, yₖ, 3502 is submitted to a forecasting neural network 3504, which produces an output forecast, ŷ₁, 3506. The maximum value ŷₘₐₓ, the minimum value ŷₘᵢₙ, and the average \hat{μ} of the forecast values are computed, as indicated by expressions 3508-3510. Two subsets of TS values yᵢ^{high} and yᵢ^{low} are computed as the values from TS greater than, or equal to, \hat{μ} and less than, or equal to, \hat{μ}, respectively, as indicated by expressions 3512-3513. N_{low} 3514 and N_{high} 3516 are the cardinalities of yᵢ^{low} and yᵢ^{high}, respectively. The standard deviations σ_{low} and σ_{high} are computed for the two subsets yᵢ^{high} and yᵢ^{low} by expressions 3518-3519. These computed values allow for computation of an upper bound, UB, and a lower bound, LB, for the forecast ŷₖ via expressions 3520 and 3522. In these expressions, the value of z can be chosen to generate a number of UB/LB pairs corresponding to different levels of confidence. When the input-expansion method discussed with respect to FIGS. 31A-B is used, a table of upper and lower bounds for each pass 3524 is computed, and an aggregate upper bound and lower bound for the forecast generated from multiple passes is then computed as functions of the multiple upper and lower bounds generated for each pass 3526.

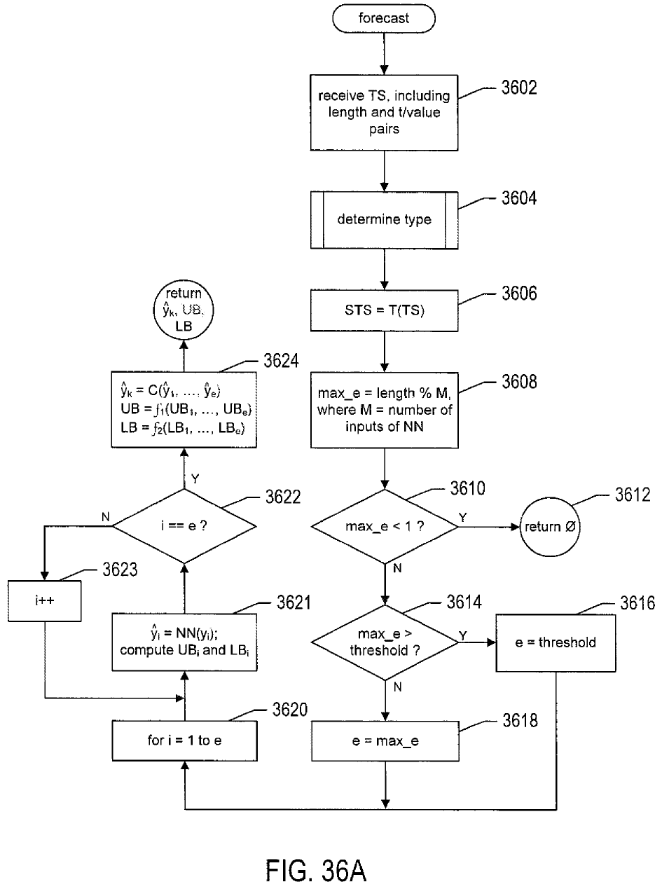

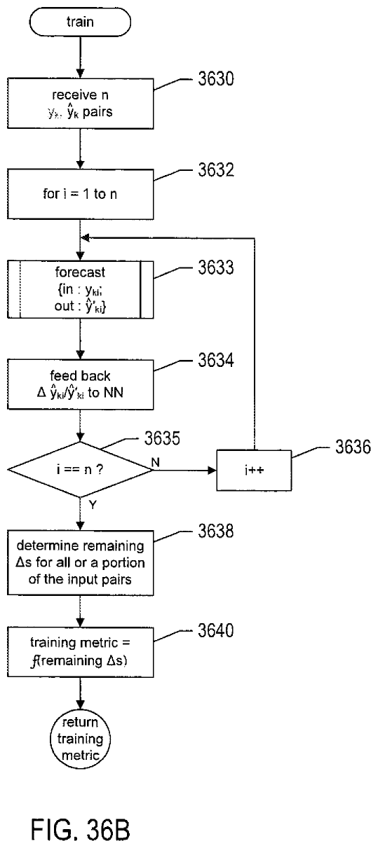

FIGS. 36A-B provide control-flow diagrams that illustrate one implementation of the currently disclosed neural-network-based forecast-generation methods and systems. FIG. 36A illustrates an implementation of the forecast method. In step 3602, and input TS is received. In step 3604, the type of the input TS is determined via the type-determination method discussed above with reference to FIG. 32. In step 3606, the input TS is transformed to an STS via the forward transform for the determined type. In step 3608, the value max_e it is obtained by dividing the length of the subsequence of the received TS to be used for generating a forecast by the number of neural-network inputs M. When max_e is less than 1, as determined in step 3610, the forecast method returns a null value in step 3612. Otherwise, when max_e is greater than a threshold value, as determined in step 3614, the expansion factor e is set to the threshold value in step 3616. The expansion factor e is otherwise set to max_e, in step 3618. In the for-loop of steps 3620-3623, value subsets are extracted from the input TS and submitted to the neural network to generate forecast subsets for each of the e passes, as discussed above with reference to FIGS. 31A-B. Finally, in step 3624, the forecast subsets are combined to generate a final forecast and the upper and lower bounds computed for each of the passes are combined to generate overall upper and lower bounds.

FIG. 36B provides a control-flow diagram for a training procedure for training the forecast neural network. In step 3630, n TS/forecast pairs are received. In the for-loop of steps 3632-3636, the TS of each TS/forecast pair is submitted to the neural network to produce a forecast, in step 3633, and, in step 3634, the difference between the forecast produced by the neural network and the forecast included in the TS/forecast pair is used as feedback to train the neural network. In step 3638, each TS of all or a portion of the input TS/forecast pairs is again submitted to the neural network and the differences between the neural-network-generated forecasts and the input forecasts are computed. The computed differences are then used to generate a training metric 3640 that indicates the accuracy of the trained neural network with respect to the training set. In addition, in certain implementations, a forecast metric can be generated from forecasts generated for as-yet-unprocessed TS/forecast pairs, to evaluate the accuracy of the trained neural network for TS data not included in the training set.

### Enhancements to the Currently Disclosed Methods and Systems

In the previous subsection, four different classes of time series were introduced, including stationary time series (“STS”), linear-trend stationary time series (“LTSTS”), unit-root time series (“URTS”), and unit-root-with-drift time series (“URDTS”). Then, methods and systems for generating forecasts of future datapoints for each of these different classes of time series were described. This subsection introduces additional classes of time series and then discloses enhancements to the above-described forecasting methods and systems that allow the forecasting methods to be applied to time series of the additional classes of time series. In these discussions, the URTS and URDTS are treated together and referred to as a “collective stochastic-timeseries” (“SOTS”) class.

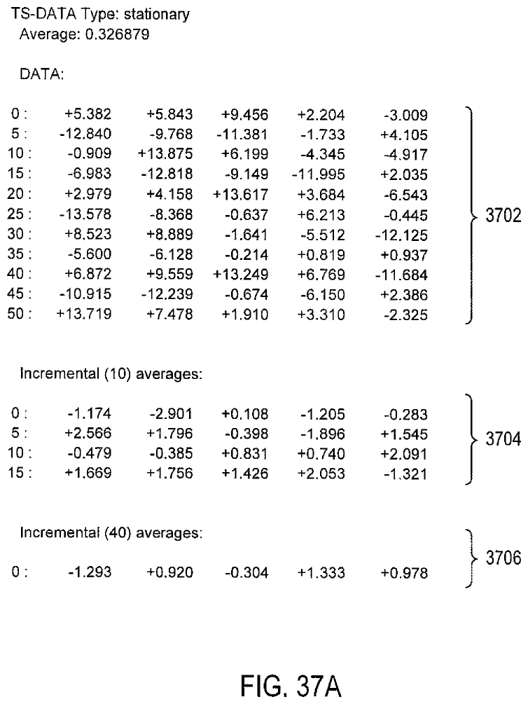

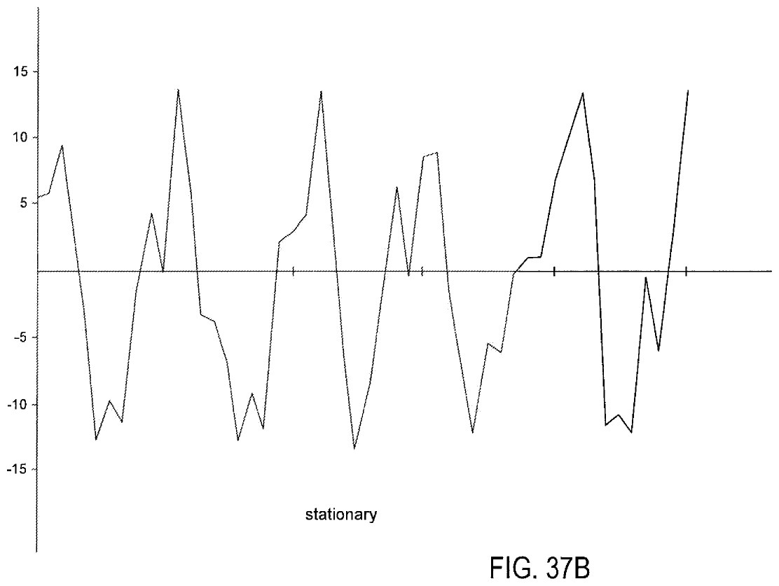

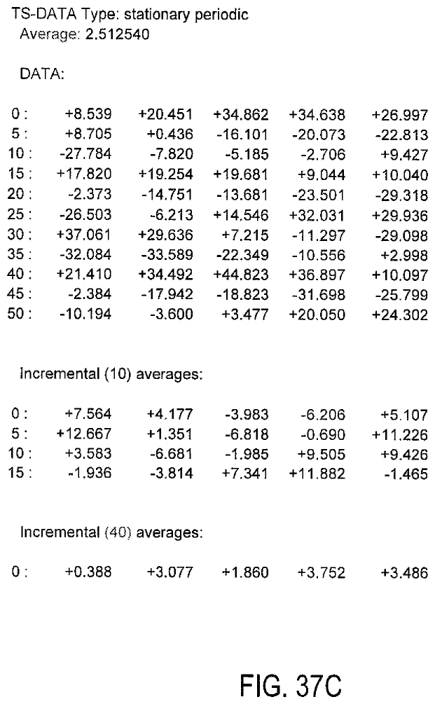

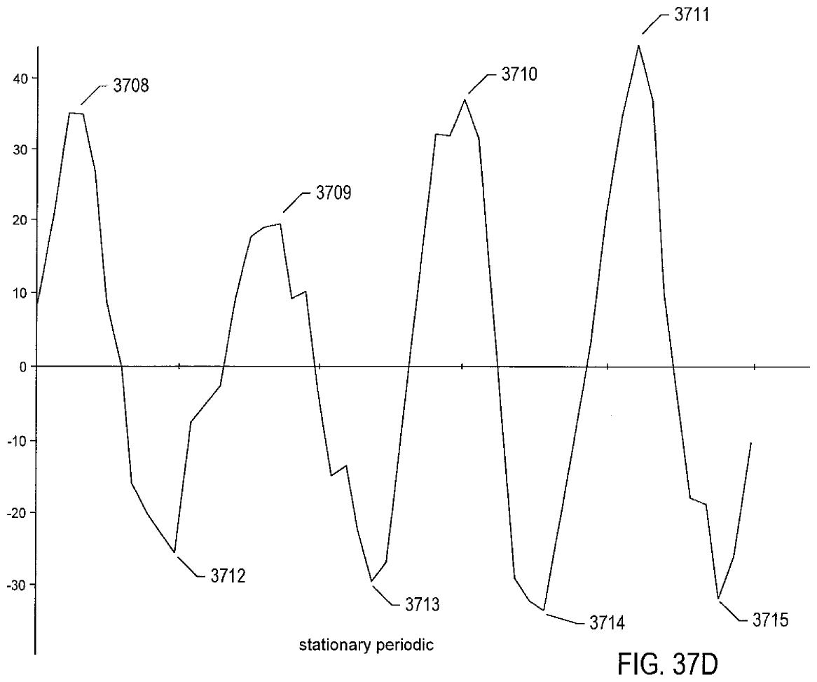

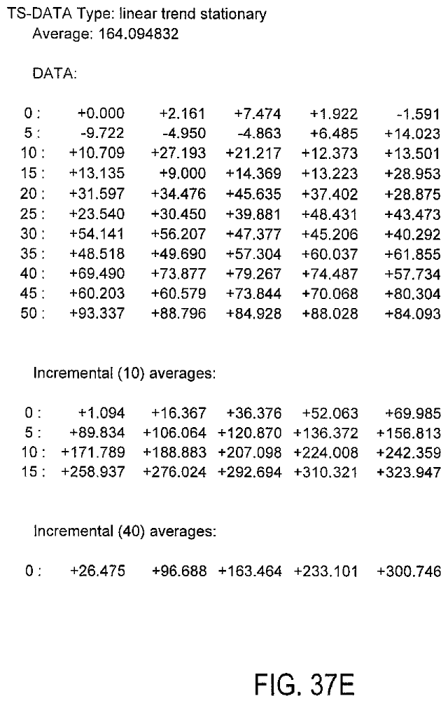

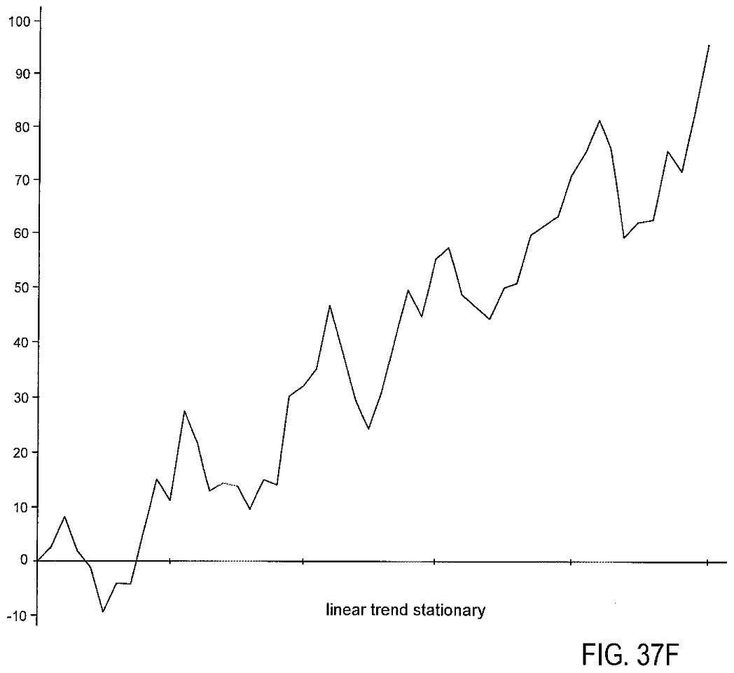

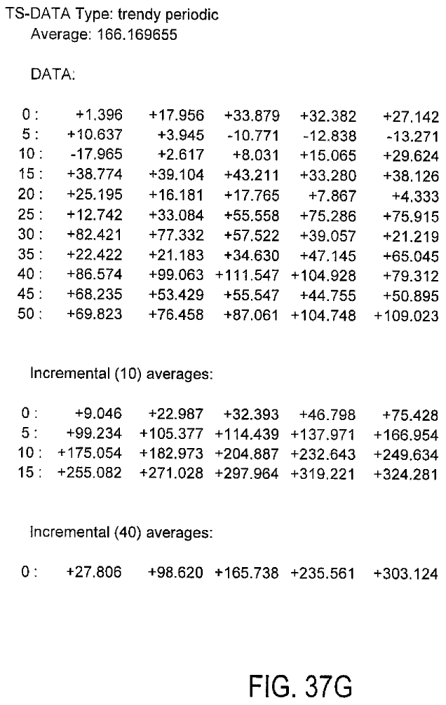

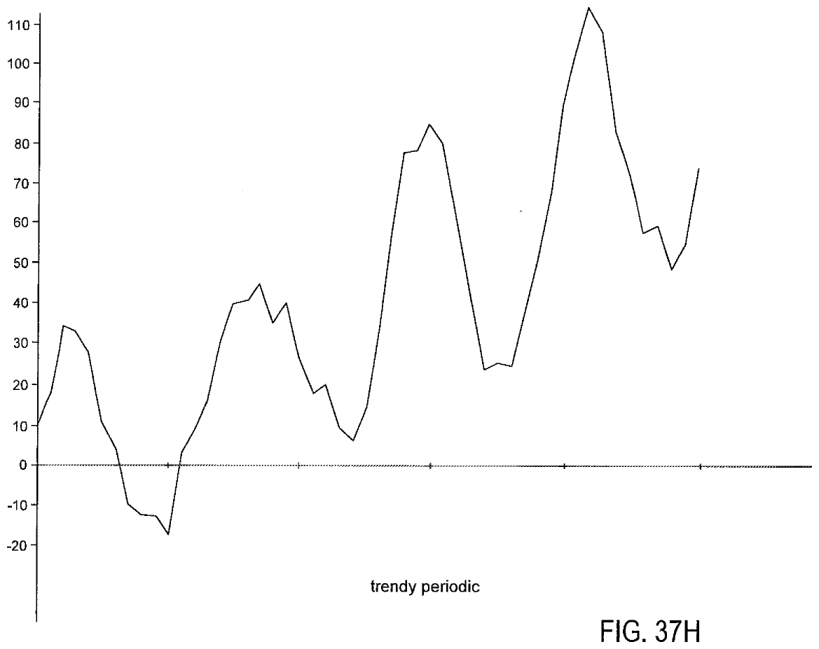

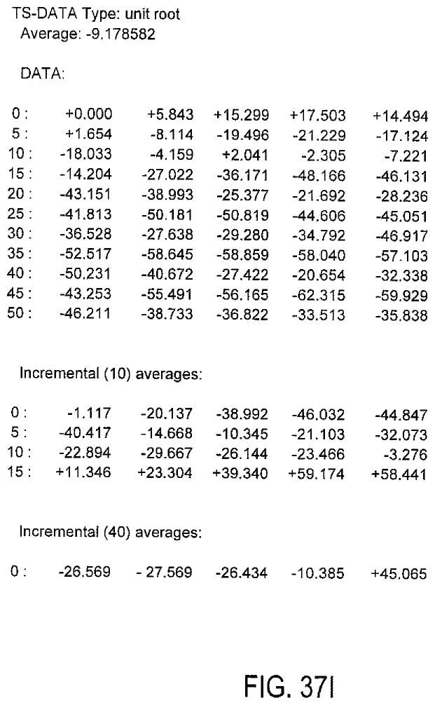

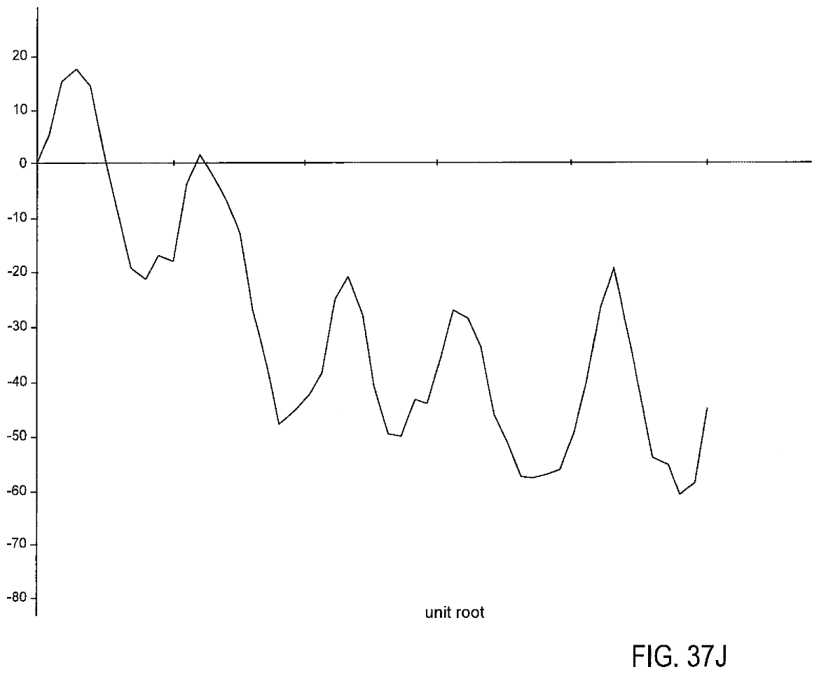

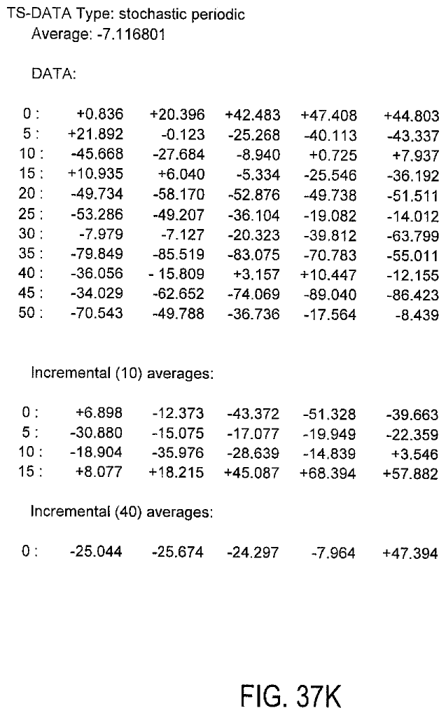

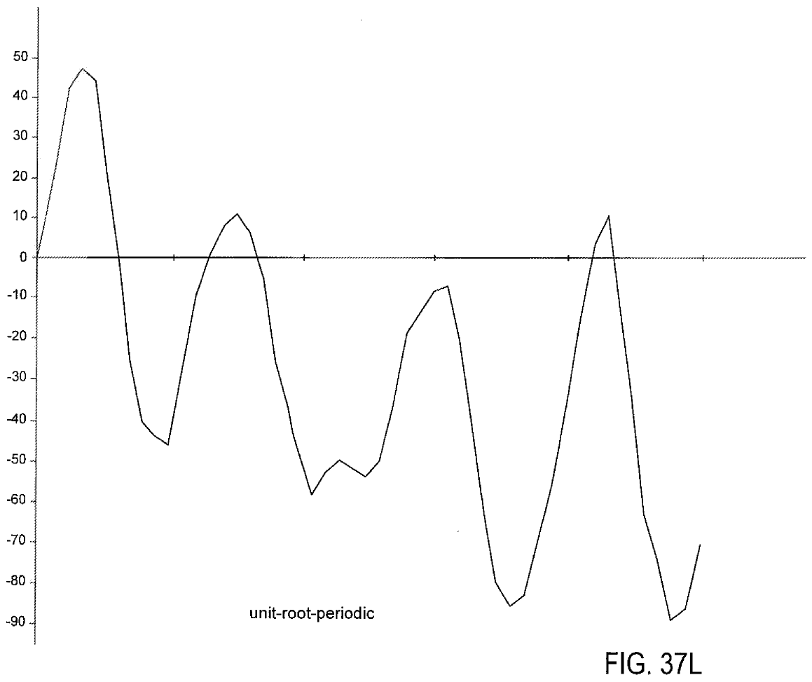

FIGS. 37A-L illustrate the additional classes of time series for which forecasting method and system enhancements are disclosed. These figures use similar illustration conventions used in FIGS. 24A-27D, but with much of the detail abbreviated. FIG. 37A shows 55 initial data-point values 3702 for an STS along with a first set of averages 3704 that each represents the average value for one of successive non-overlapping subsequences of 10 time/value pairs and a second set of averages 3706 that each represents the average value for one of successive subsequences of 20 time/value pairs. FIG. 37B shows a plot of the first 50 datapoints of the STS. This plot is different from the plot shown in FIG. 24B, since the STS plotted in FIG. 37B was differently generated, but shares many of the characteristics of the plot shown in FIG. 24B. The STS plotted in FIG. 37B oscillates somewhat regularly, but is non-repeating. FIG. 37C shows initial data-point values and two sets of averages for a different time series based on the STS plotted in FIG. 37B. This different time series was generated by adding a regularly repeating, or periodic, time series to the STS plotted in FIG. 37B. This is an example of a first additional class of time series referred to as “stationary periodic time series” (“SATS”). FIG. 37D shows a plot of the SPTS. Comparing the plot shown in FIG. 37D to the plot shown in FIG. 37B, it is readily apparent that the addition of the periodic time series to the STS has markedly altered the overall characteristics of the product SPTS plotted in FIG. 37D as compared to the STS on which it is based. In the SPTS, there are four relatively pronounced peaks 3708-3711 and four relatively pronounced valleys 3712-3715. While the peaks are not exactly regularly spaced apart, the plotted datapoints have a more regularly oscillating appearance than the irregular oscillations of the STS on which the SPTS is based. Assuming that the periodic component time series of the SPTS has little or no information content, and that the STS on which the SPTS is based represents the information-containing portion of the SPTS, it is readily apparent that the periodic component would tend to completely overshadow the information-containing portion of the SPTS were the above-described neural-network-based forecasting method applied to the SPTS. Furthermore, the SPTS does not have the STS characteristics that allow for reliable and accurate forecasting, via the above-discussed neural-network-based methods and systems, of time series of the STS class. The above-discussed methods and systems are unsuitable for producing forecasts for an SPTS, such as that shown in FIG. 37D.

FIGS. 37E-F show data-point values and averages and a plot of an LIST based on the STS plotted in FIG. 37B. FIGS. 37 G-H show data-point values and averages and a plot of an example of a second additional class of time series referred to as a “trendy periodic time series” (“TPTS”), produced by adding a periodic component time series to the LTST plotted in FIG. 37F. Here again, the periodic component time series has imparted much different characteristics to the TPTS than those exhibited by the LTST on which the TPTS is based. The LTST essentially angles the underlying STS upward, but preserves the profile of the underlying STS in a somewhat distorted form. By contrast, the profile of the underlying STS is nearly completely obscured in the TPTS plotted in FIG. 37 H, replaced instead by a strong, relatively regular pattern of prominent peaks and valleys. As with the SPTS, the information-containing component of the TPTS, which is essentially the STS on which the LTST used to generate the TPTS is based, has been masked and obscured by introduction of the periodic component. The TPTS is not periodic since the magnitudes of the peaks increase in value.

FIGS. 37I-J show data-point values and averages and a plot of a URTS based on the STS plotted in FIG. 37B. FIGS. 37K-L show data-point values and averages and a plot of an example of a third additional class of time series, referred to as a “stochastic periodic time series” (“SCPTS”) produced by adding a periodic component time series to the URTS plotted in FIG. 37J. Similar comments apply to the URTS/SCPTS pair as made with respect to the LTST/TPTS and STS/SPTS pairs, discussed above.

The periodic-time-series classes SPTS, TPTS, and SCPTS need to be handled differently than the corresponding STS, LTST, and URTS time-series classes with respect to forecasting. The null hypothesis tests for non-periodic-time-series classes discussed in the preceding subsection with reference to FIGS. 34A-B are not applicable to times series of the periodic-time-series classes for determining whether periodic time series is one of an SPTS, TPTS, or SCPTS.

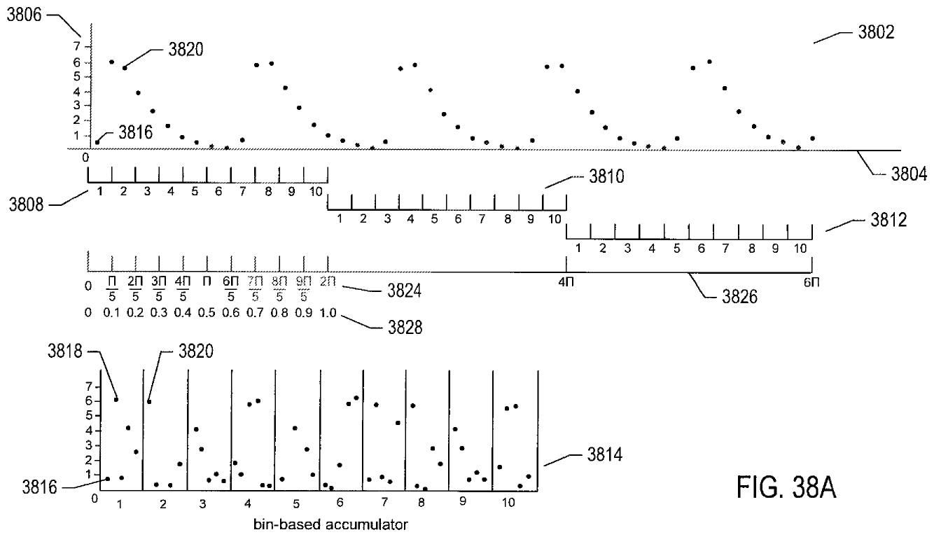

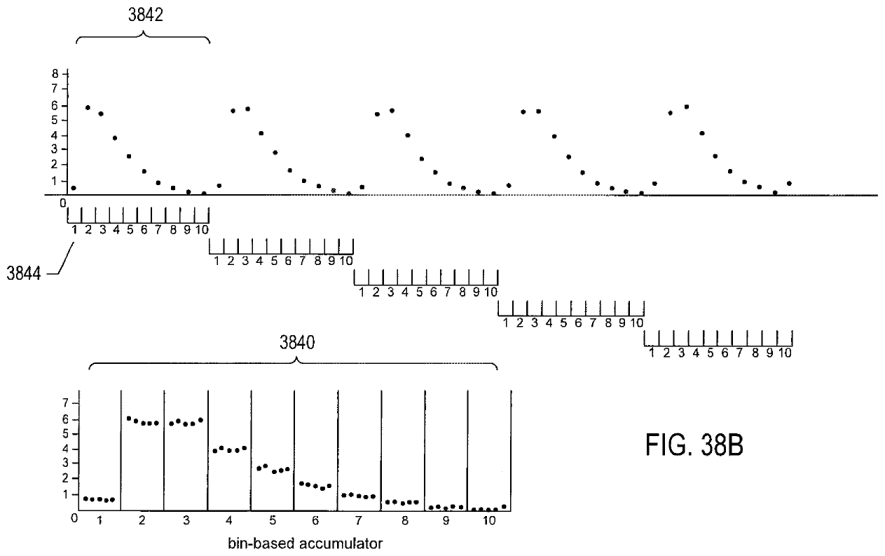

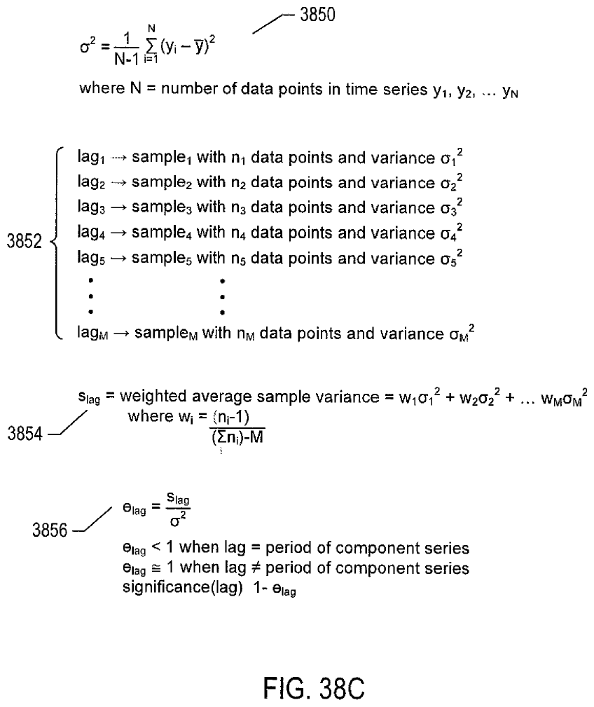

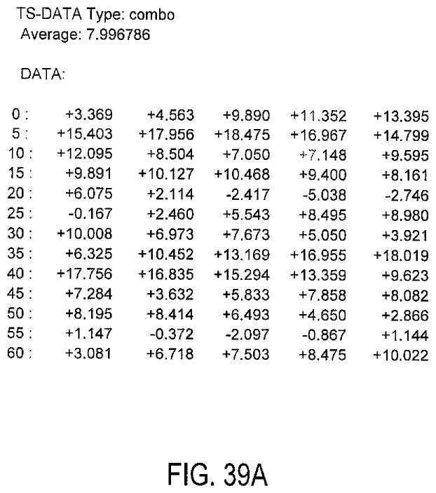

FIGS. 38A-C illustrate a technique for detecting periodic time-series components within a time series. FIGS. 38A-B use the same illustration conventions, next described with reference to FIG. 38A. FIG. 38A shows a plot 3802 of a time series. The discrete datapoints of the time series are plotted with respect to a horizontal time axis 3804 and a vertical data-value axis 3806. The time series is processed by successively applying a comb-like data-point selector to the datapoints of the time series. The first application of the comb-like data-point selector 3808 encompasses the first 17 Datapoints of the time series, the second application of the comb-like data-point selector 3810 encompasses the next 16 datapoints of the time series, and a third application of the comb-like data-point selector 3812 encompasses the final 17 datapoints of the time series. Only three comb-like data-point-selector iterations or applications are shown in FIG. 38A but, in general, the comb-like data-point-selector would be successively applied along the entire length of a larger portion of a time series. The comb-like data-point-selector includes 10 bin selectors numbered 1 through 10. Each bin selector selects datapoints to add to a corresponding bins of a bin-based accumulator 3814 as the comb-like data-point-selector is successively applied along the length of a portion of the time series. For example, during the first application of the comb-like data-point-selector 3808, bin selector 1 selects datapoints 3816 and 3818 from the time series for addition to bin 1 of the bin-based accumulator and bin selector 2 selects datapoint 3820 for addition to bin 2 of the bin-based accumulator. As the comb-like data-point-selector is successively applied to the time series, the bin-based-accumulator bins become increasingly filled with datapoints selected by the corresponding bin selectors of the comb-like data-point-selector. Note that the datapoints in the bins of the bin-based accumulator have the same heights within the bin as their counterparts in the time series.

Each bin-selector, during each particular application of the comb-like data-point-selector to the time series, is associated with a phase. The phase of a particular bin selector increases by 2π with each successive application of the comb-like data-point-selector. The phases of the bin selectors increase along the comb-like data-point-selector by 2π/NUM_BINS where NUM_BINS is equal to the number of bin selectors in the comb-like data-point-selector. The initial phases of the bin selectors 3824 are shown below a phase line 3826 in FIG. 38A. Alternatively, the phases may be expressed as real numbers in the range [0, 1], as shown 3828 below the corresponding phases 3824 expressed in increments of 2π/NUM_BINS. Thus, the phases of the bin selectors that select datapoints for a particular bin in the bin-based accumulator are all multiples of an initial bin-selector phase, where the multiplier is either 2π or 1.0 depending on the convention used for expressing phases, as discussed above. As can be seen in FIG. 38A, the datapoint values of the datapoints in the bin-based-accumulator bins vary considerably. In fact, unless the comb-like data-point-selector has a total length, in time, equal to the period of a periodic time-series component of the time series, which is not the case for the comb-like data-point-selector shown in FIG. 38A, the variance of the data values contained in a bin-based-accumulator bin would be expected to converge on a value equal to the overall variance of the data values in the time series with increasing number of applications of the comb-like data-point-selector and accumulation of increasing numbers of datapoints.

FIG. 38B shows successive application of a different comb-like data-point-selector to the same time series shown in FIG. 38A. In the case of FIG. 38B, the comb-like data-point-selector has a length equal to the period of the periodic time-series component of the time series. In this case, four successive applications of the comb-like data-point-selector produces a data-point distribution 3840 among the bins of the bin-based accumulator that is markedly different from the distribution of the datapoints in the bin-based accumulator shown in FIG. 38A. In the case of FIG. 38B, because the length of the comb-like data-point-selector is equal to the period of the periodic time-series component of the time series, the phases of the bin selectors correspond exactly to the phases of the periodic-time-series component of time series. As a result, each bin selector selects datapoints from a particular phase range of the periodic time-series component during each successive application of the comb-like data-point-selector. Therefore, there is very little variation in the data-point values in each of the bins of the bin-based accumulator. The small variation within each bin is due to the non-periodic, information-containing component of the time series. Thus, when the length of the comb-like data-point-selector is equal to the period of a periodic time-series component, the variance of the values of the datapoints in any particular bin-based-accumulator bin falls from a value near to the variance of data values for the time series, as a whole, to a value near to the variance of the non-periodic time-series component of the time series within the phases range associated with the bin. A plot of the average values for the successive bins of the bin-based accumulator would generate a close approximation to a plot of the first period of the periodic time-series component of the time series. The profile of the average values of the datapoints in each bin in the bin-based accumulator, if resealed to a length equal to the length of the comb-like data-point-selector, would look very much like the profile of the datapoints 3842 in the time series above the first application of the comb-like data-point-selector 3844.

FIG. 38C expresses the technique illustrated in FIGS. 38A-B in mathematical notation. Expression 3850 shows how the variance σ² of the data values in a timeseries is computed. The variance σₓ² for the data values of the datapoints in a bin-based-accumulator bin x is similarly computed. The length, in time, of the comb-like data-point-selector is referred to as a lag. Thus, applying a comb-like data-point-selector with a length equal to lag and with M bin selectors to a time series produces M different bin samples 1, 2, 3, . . . , M, each bin sample i corresponding to a bin-based-accumulator bin i and each bin sample having a total number of datapoints nᵢ and a data-point-value variance σᵢ² 3852. The average sample variance for the M samples, S_{lag}, 3854 is computed as the sum of the products of sample weights and sample variances, wσ₁²+wσ₂²+wσ₃²+ . . . +wσ₃ᵢ², where the weight for sample i is computed as

$${w}_{i} = \frac{( {n}_{i} - 1 )}{( {\sum }_{i} {n}_{i} ) - M} .$$

A theta statistic for a particular lag 3856 is then computed as

$${θ}_{lag} = \frac{{S}_{lag}}{{σ}^{2}} ,$$

where σ² is the variance of all of the datapoints in the time series. As discussed above, when θ_{lag} is approximately equal to 1.0, the time series does not have a periodicity with a period equal to lag, but, when θ_{lag} is less than 1.0, the time series likely includes a periodic time-series component with a period equal to lag. The significance of a lag is equal to 1−θ_{lag}. In order to determine whether a timeseries has a periodic time-series component, the method discussed above with reference to FIGS. 38A-B is used to apply comb-like data-point-selectors of increasing lengths, or lags, to a timeseries, computing θ_{lag} for each different lag. When θ_{lag} falls significantly below 1.0, the time series is inferred to include a periodic time-series component with a period equal to the lag or equal to lag/2, lag/4, or another harmonic. In many cases, the relative amplitude of the periodic time-series component is related to the computed significance for the detected period, or lag, of the periodic time-series component.

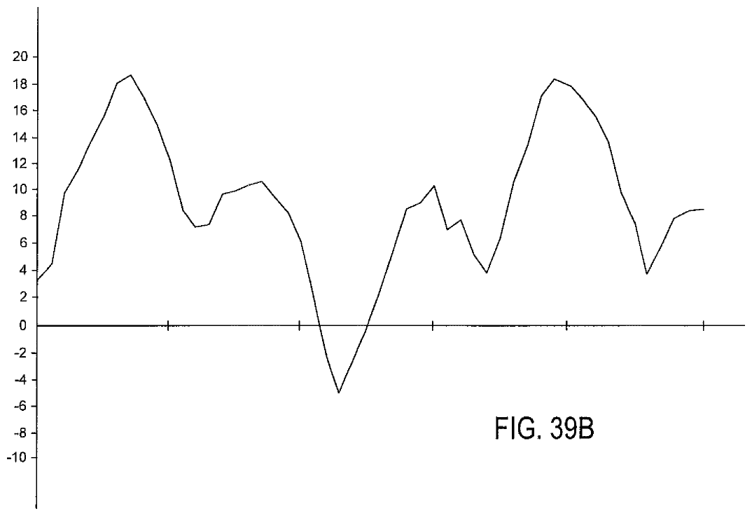

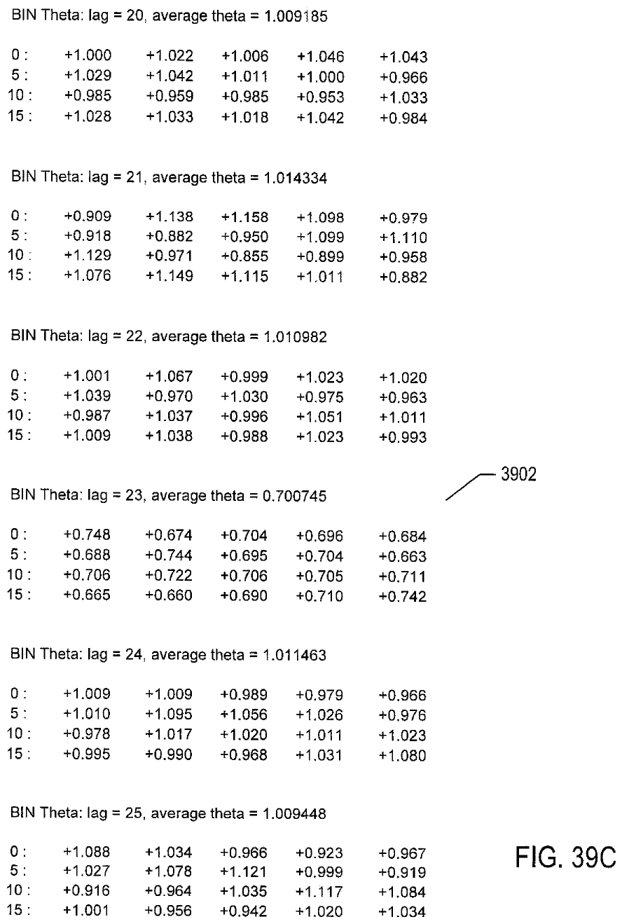

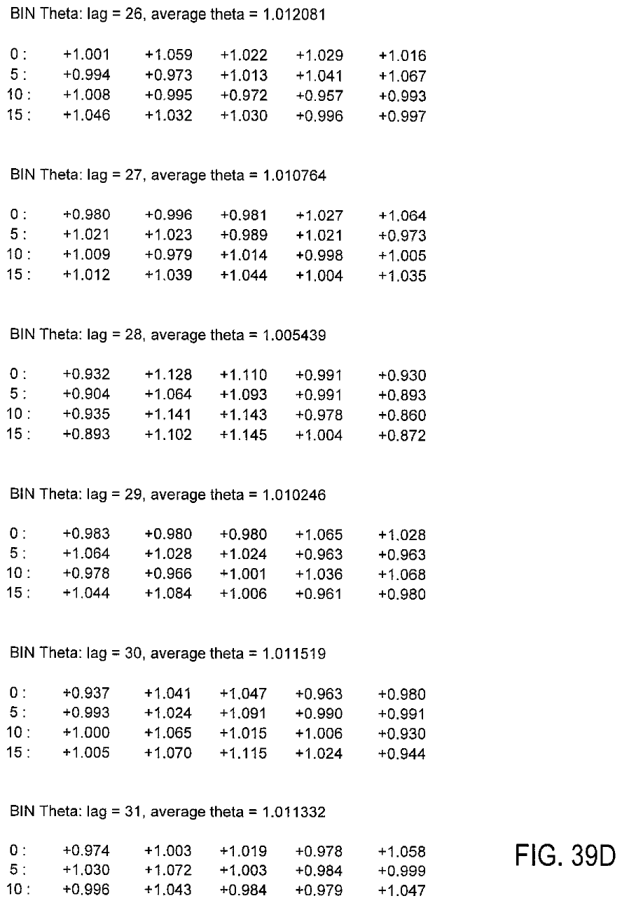

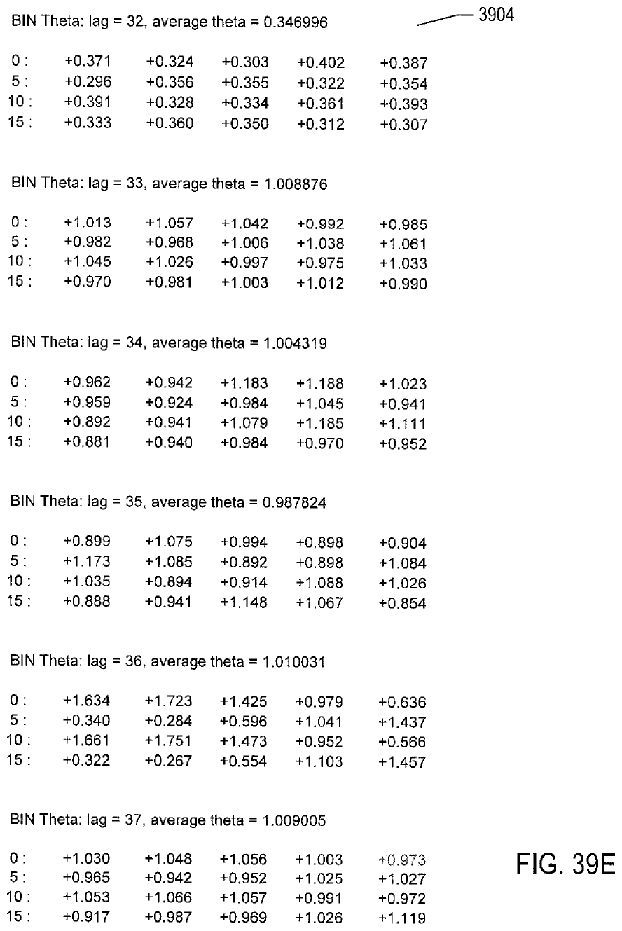

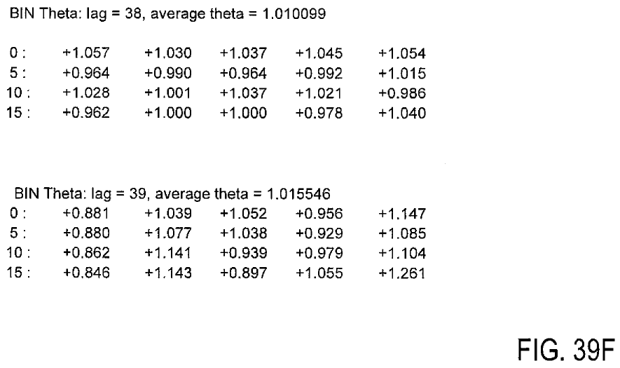

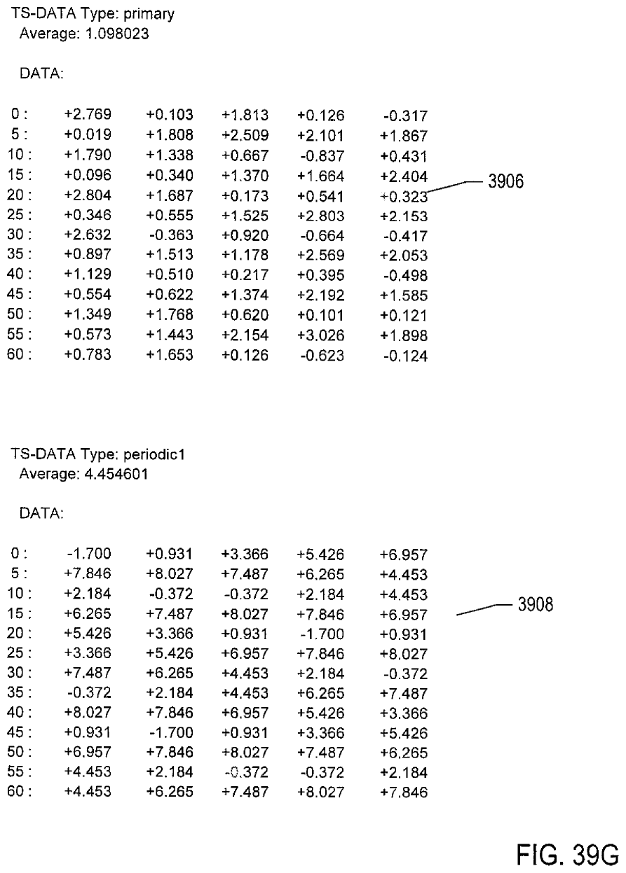

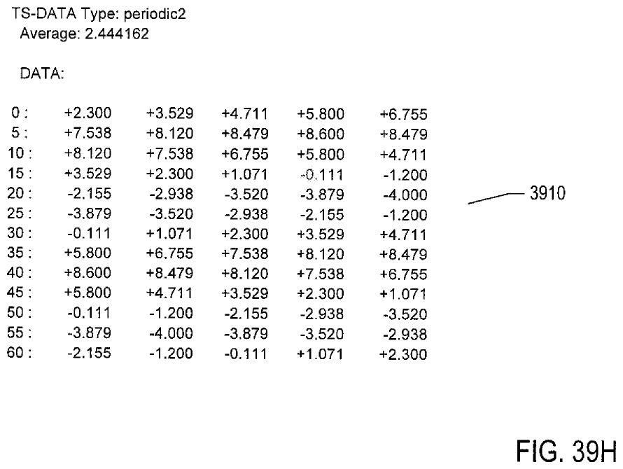

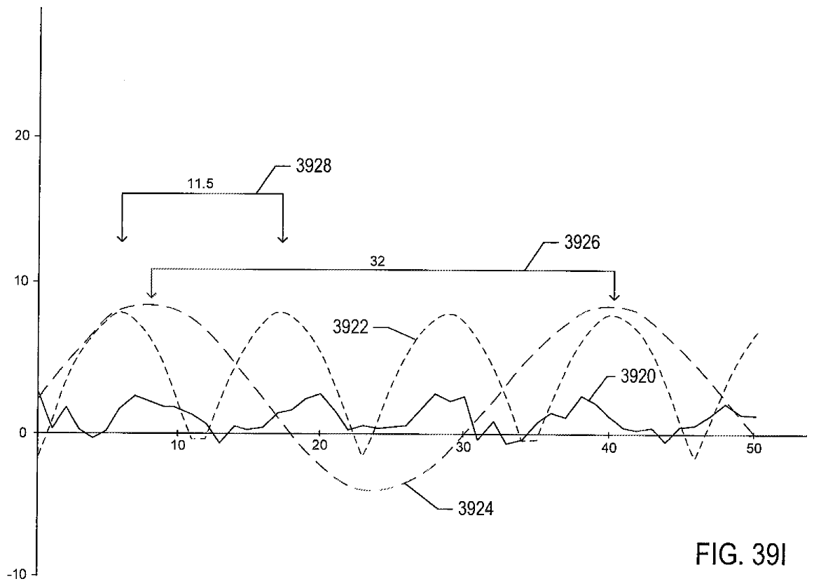

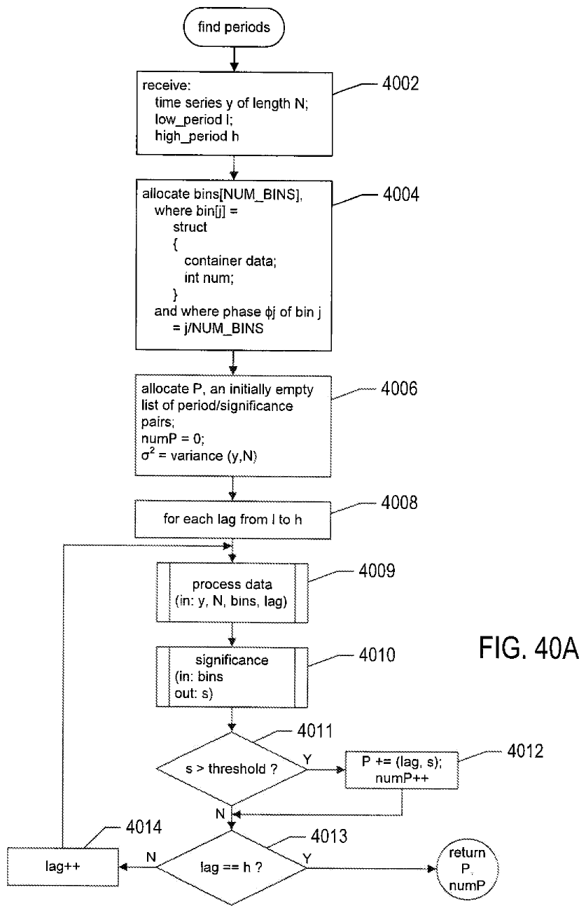

FIGS. 39A-I provide an example of detecting periodicity within a time series using the method of FIGS. 39A-C. FIG. 39A shows 65 datapoints for a timeseries. A plot of the initial 50 points of the time series are shown in FIG. 39B. FIGS. 39 C-H show the 20 bin-based-accumulator-bin variances for a series of applied lags from an initial lag of 22 a final leg of 39. The computed average theta value for all but two of the lags is close to 1.0. However, for lag=23 (3902 in FIG. 39 C) and for lag=32 (3904 in FIG. 39), the computed average theta values are substantially less than 1.0. FIG. 39G shows the initial 65 datapoints for a primary time-series component 3906 and for a first periodic time-series component 3908 of the time series shown in FIG. 39B. FIG. 39H shows initial 65 datapoints 3910 for a second periodic time-series component of the time series shown in FIG. 39B. FIG. 39I is a plot of the three time-series components for which data is provided in FIGS. 39G-H. The solid-line curve 3920 is a representation of the primary time-series component, the curve with short dashes 3922 is a representation of the first periodic time-series component, and the curve with long dashes 3924 is a representation of the second periodic time-series component. The period for the second periodic time-series component 3926 is 32, and corresponds to the low average theta 3904 for lag=32 in FIG. 39E. The period for the first periodic time-series component 3928 is 11.5. This corresponds to the low average theta 3902 for lag=23 in FIG. 39C. Lag 23 is twice 11.5, and is thus also a period for the first periodic timeseries.

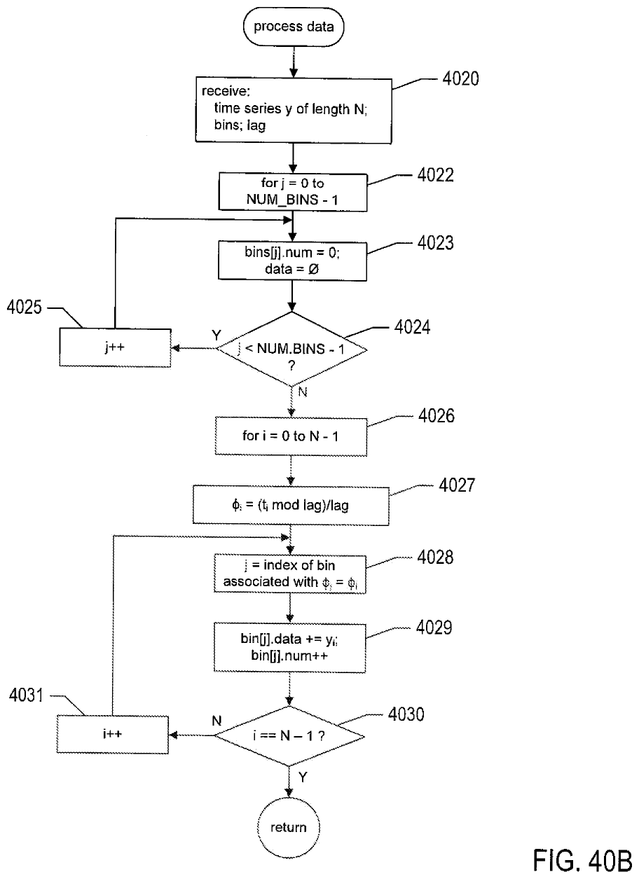

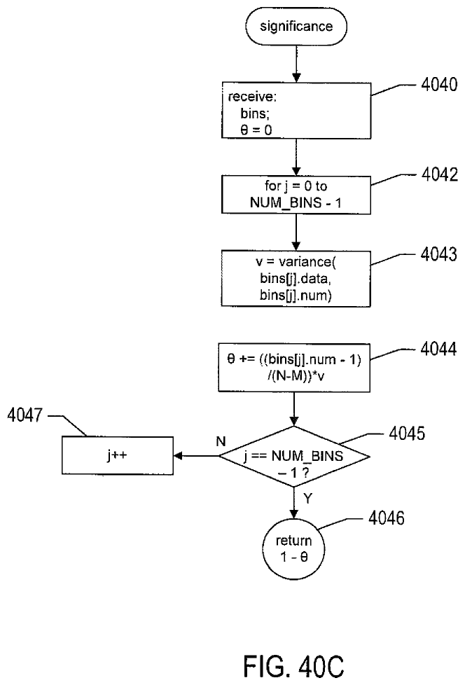

FIGS. 40A-C provide control-flow diagrams for a routine that illustrates implementation of the method for identifying periodicities in timeseries discussed above with reference to FIGS. 38A-39I. FIG. 40A provides a control-flow diagram for a routine “find periods,” which implements the method of 38A-39I. In step 4002, the routine “find periods” receives a timeseries y of length N and indications of the shortest and longest periods, l and h, that bound a series of lags to be evaluated. In step 4004, the routine “find periods” allocates and/or initializes an array bins of NUM_BINS, bins corresponding to the above-discussed bin-based accumulator (3814 in FIG. 3880). Each bin is a structure that includes a data container data and an integer num. As discussed above, each bin j is associated with a phase φⱼ. In step 4006, a list P is allocated and/or initialized. The list P will hold entries, each of which consists of a period/significance pair. Also, in step 4006, a local variable numP is initialized to 0 and the variance σ² of the time series y is computed. In the for-loop of steps 4008-4014, each lag in the integer range [l, h] is considered. In step 4009, a routine “process data” is called to apply the comb-like data-point-selector corresponding to the currently considered lag to the time series y in order to fill the bin-based accumulator. In step 4010, a routine “significance” is called to compute the significance for the currently considered lag, as discussed above. When the significant returned for the currently considered lag is greater than a threshold value, as determined in step 4011, a new entry that includes the lag and the computed significance is added to the list P, in step 4012, and the local variable numP is incremented. When the currently considered lag is equal to h, as determined in step 4013, the routine “find periods” returns the list P and the local variable numP. Otherwise, the lag is incremented, in step 4014, and control flows back to step 4009 for a next iteration of the for-loop of steps 4008-4014.

FIG. 40B provides a control-flow diagram for the routine “process data,” called in step 4009 of FIG. 40A. In step 4020, the routine “process data” receives a time series y of length N, a reference to the bin-based accumulator bins, and the currently considered lag. In the for-loop of steps 4022-4025, the data member num of each bin is set to 0 and the container data of the bin is emptied. In the for-loop of steps 4026-4031, each datapoint i in the series y is considered. In step 4027, the phase φᵢ associated with the currently considered datapoint is computed. In this implementation, the times associated with datapoints have integer values, as do the lags. In step 4028, the index j of the bin associated with a phase φⱼ equal to the phase φᵢ associated with the currently considered datapoint is identified. In step 4029, the data value of the currently considered datapoint is added to the container for bin[j] and the data member num for bin[j] is incremented. When the currently considered datapoint i is the final datapoint in the time series, as determined in step 4030, the routine “process data” returns. Otherwise, i is incremented, in step 4031, and control returns to step 4028 for another iteration of the for-loop of steps 4026-4031.

FIG. 40C provides a control-flow diagram for the routine “significance,” called in step 4010 of FIG. 40A. In step 4040, the routine “significance” receives a reference to the bin-based accumulator bins and sets a local variable θ to 0. In the for-loop of steps 4042-4047, each bin in the bin-based accumulator bins is considered. In step 4043, a local variable v is set to the variance computed for the data values of the datapoints stored in the bin and, in step 4044, the weighted significance term for the bin is added to local variable θ. When all of the bin-based-accumulator bins of been considered, as determined in step 4045, the significance for the lag is computed and returned, in step 4046. Otherwise, in step 4047, the index j is incremented to consider a next bin in a next iteration of the for-loop of steps 4042-4047.

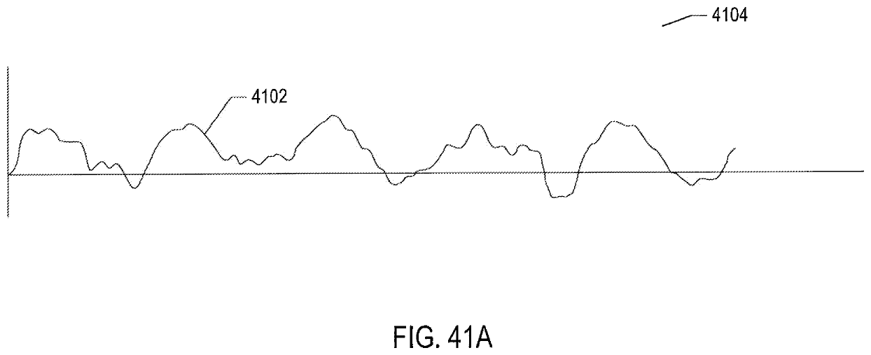

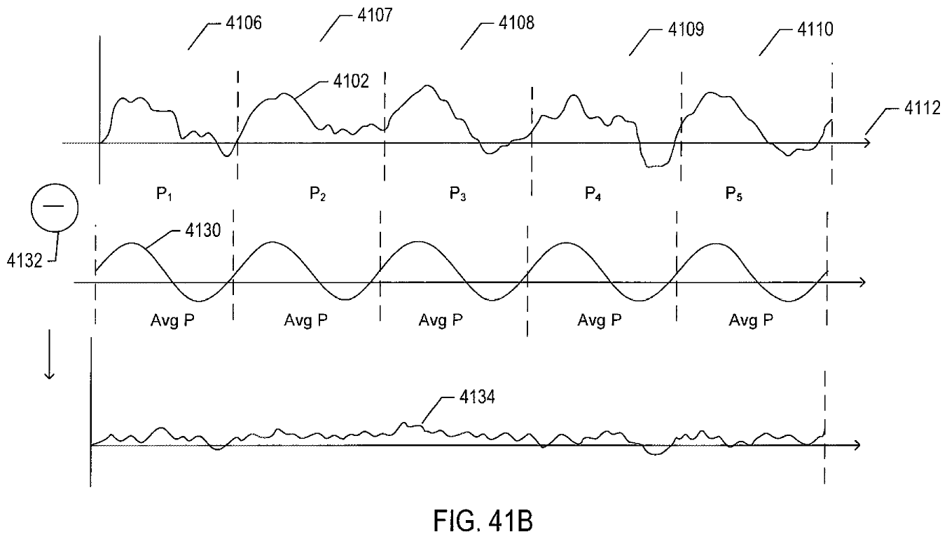

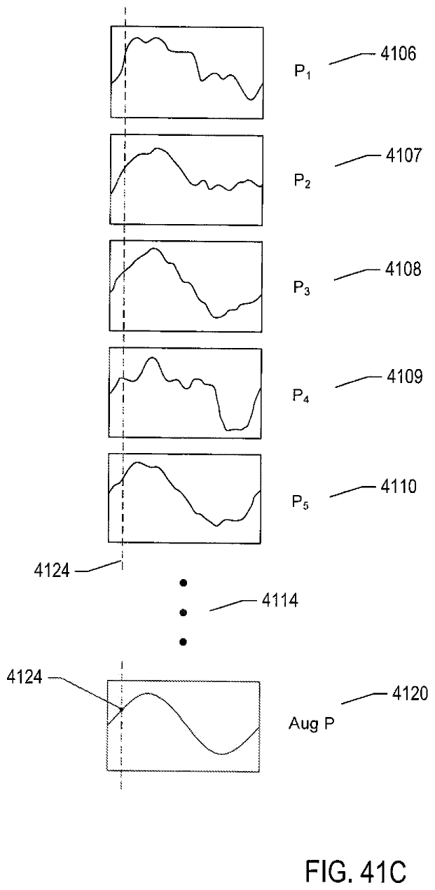

There are many methods for removing known periodic time-series components from a time series. FIGS. 41A-C illustrate one such method. FIG. 41A shows a portion of a time series that includes a periodic time-series component, representative as curve 4102 in plot 4104. In a first step, shown at the top of FIG. 41B, the time series is partitioned into a series of successive periods 4106-4110. The arrow 4112 at the end of the horizontal axis of the time series indicates that the time series may be longer and more periods may be identified within the longer time series. The periods, of course, each have a length equal to the period of a known periodic time-series component, perhaps identified by the method embodied in the routine “find periods,” described above. Then, as shown in FIG. 41C, an average period 4120 is computed from the periods 4106-4110 into which the time series has been partitioned. Ellipsis 4114 indicates that there may be additional periods, as discussed above. The data value of each point in the curve of the average period 4120, such as the value of datapoint 4122, is computed as the average value of all of the datapoint values in all of the periods with the same phase within the period as the phase of datapoint 4122 in the average period, as indicated by vertical dashed line 4124. Then, returning to FIG. 41B, a computed time series 4130 is constructed by replicating the average period, in time. Finally, as indicated by the subtraction symbol 4132, the constructed time series is subtracted from the original timeseries 4102 to produce the residual timeseries component 4134. Additional periodic time-series components may be removed from the residual time series by repeating this procedure. When multiple periodic time-series components need to be removed, they are removed in decreasing significance order.

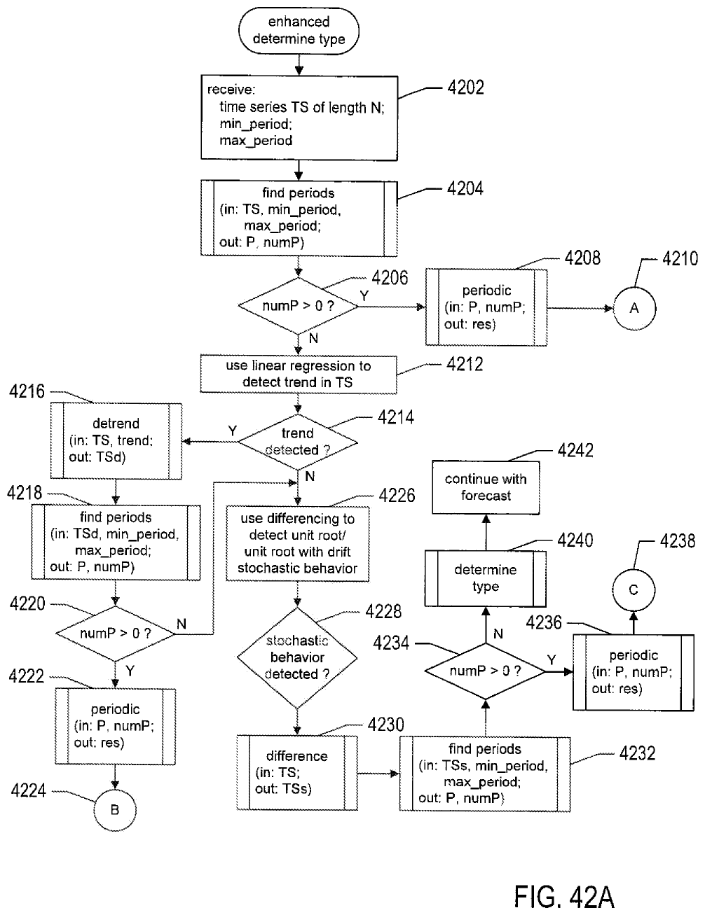

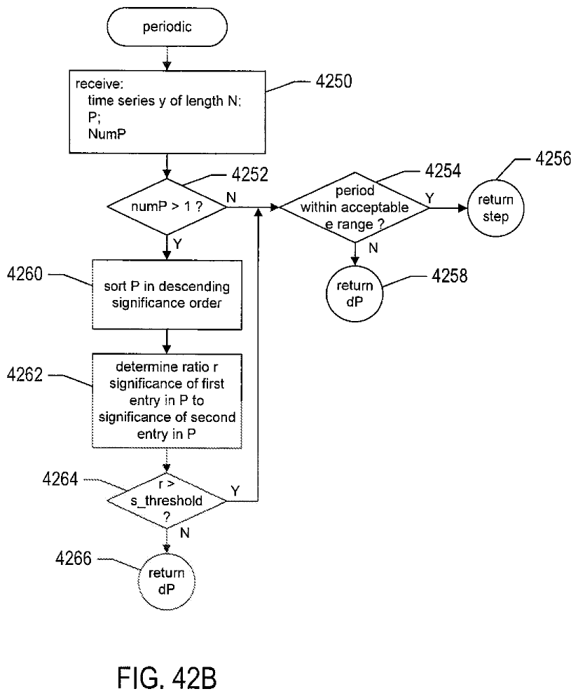

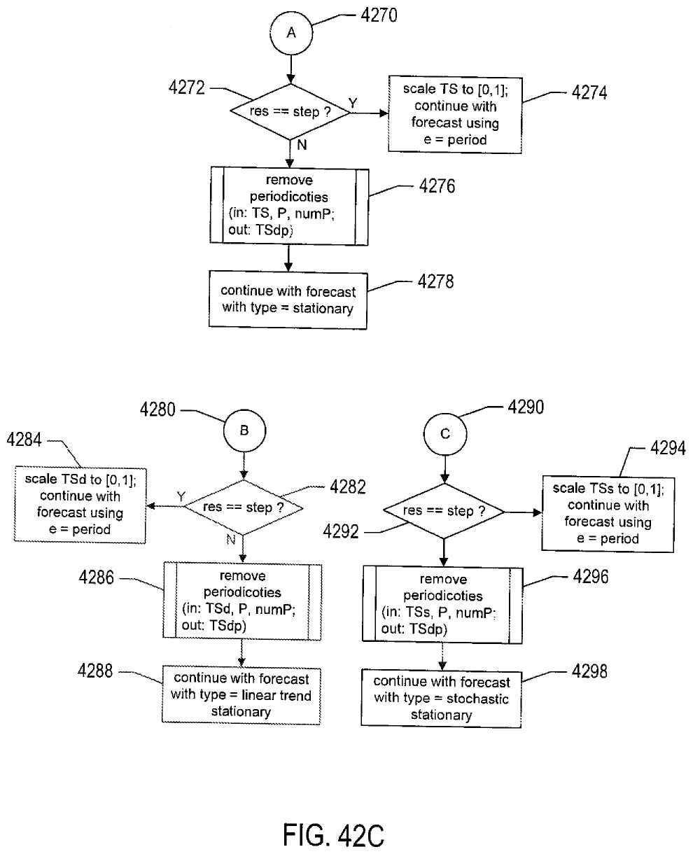

FIGS. 42A-C provide control-flow diagrams that illustrate how the forecasting method disclosed in the preceding subsection and shown in FIG. 36A is modified to enable forecasting of periodic time-series in the above-described periodic-time-series classes SPTS, TPTS, and SCPTS. FIG. 42A provides a control-flow diagram for a routine “enhanced determine type,” which is called in an enhanced version of the routine “forecast,” shown in FIG. 36 A, in place of the call to the routine “determine type” in step 3604. In step 4202, the routine “enhanced determine type” receives a time series TS of length N and indications of the minimum and maximum lag to use for periodicity detection. In step 4204, the routine “find periods,” discussed above, is called to determine whether there are periodicities in the received time series TS. When the return value numP is greater than 0, as determined in step 4206, at least one periodicity was found and a routine “periodic” is called, in step 4208, to characterize the periodicity or periodicities detected by the routine “find periods.” Then, control flows through the circular step labeled “A” 4210 to the same circular step labeled “A” 4270 in FIG. 42C. When the return value numP has a value 0, as determined in step 4206, then, in step 4212, a linear regression is applied to the time series TS to determine whether there is a trend in time series TS. When a trend is detected, as determined in step 4214, the results of the linear regression are used to detrend TS, in step 4216, producing a detrended time series TSd. The routine “find periods” is applied to the detrended time series TSd, in step 4218. When the return value numP has a value greater than 0, as determined in step 4220, at least one periodicity was found, and the routine “periodic” is called, in step 4222, to characterize the periodicity or periodicities found in the detrended time series TSd by the routine “find periods.” Then, control flows through the circular step labeled “B” 4224 to the same circular step labeled “B” 4280 in FIG. 42C. When the return value numP has a value 0, as determined in step 4222, then, in step 4226, differencing is used to detect stochastic behavior, such as that exhibited by a URTS or URDTS. When stochastic behavior is detected, as determined in step 4228, differencing is applied to timeseries TS to produce timeseries TSs with stochastic behavior removed, in step 4230. The routine “find periods” is applied to the time series TSs, in step 4232. When the return value numP has a value greater than 0, as determined in step 4234, at least one periodicity was found and the routine “periodic” is called, in step 4236, to characterize the periodicity or periodicities found in the time series TSs by the routine “find periods.” Then, control flows through the circular step labeled “C” 4238 to the same circular step labeled “C” 4290 in FIG. 42C. When the return value numP has a value 0, as determined in step 4234, no periodicity was found in the received time series TS. Therefore, the original routine “determine type” is called, in step 4240 after which the remaining steps in the forecast routine shown in FIG. 36A following the call to the routine “determine type” are executed, as represented by step 4242.

FIG. 42B provides a control-flow diagram for the routine “periodic,” called in steps 4208, 4022, and 4236 of FIG. 42A. In step 4250, the routine “periodic” receives a time series y of length N, a list P of periods, significance pairs, and an integer numP. When numP has the value 1, as determined in step 4252, and when the period is within an acceptable range of expansion factors, discussed above with reference to FIGS. 31A-B, as determined in step 4254, the result step is returned, in step 4256. This value indicates that the time series y can be directly submitted to a neural network for forecasting using an expansion factor equal to the period of the detected periodicity in the timeseries since, as discussed above with reference to FIGS. 38A-B as well as with reference to FIGS. 41A-C, selecting datapoints by the comb-like bin selector having a length equal to a periodic-time-series-component period, which is equivalent to datapoint selection using an expansion factor equal to the period of a detected periodicity, has the effect of eliminating the periodicity and retaining the non-repeating information timeseries, when the selected datapoints in each bin are scaled to the range [0, 1]. In essence, using an expansion factor equal to the period of a detected periodic time-series component for selecting datapoints for input to the neural network and then resealing the datapoints selected for each set of input datapoints to the range [0, 1] automatically removes the periodic time-series component from the time series. When the period is not within an acceptable expansion-factor range, as determined in step 4254, a value dP is returned, in step 4258, to indicate that the periodicity must be removed from the time series prior to forecasting. When numP has a value greater than 1, as determined in step 4252, the list P is sorted in descending significant order, in step 4260. Then, in step 4262, a ratio r of the significance of the first entry in P to the significance of the second entry in P is computed. When this ratio has greater than a threshold value, as determined in step 4264, control flows to step 4254, since the remaining periodicities following the first periodicity in list P can be ignored. Otherwise, the value dP is returned, in step 4266.

FIG. 42C provides the continuations of the control-flow diagram of FIG. 42A indicated by circular labeled steps 4210, 4024, and 4238 in FIG. 42A. Circular labeled step 4270 is the continuation of step 4210 in FIG. 42A. When the result returned by the call to the function “periodic” in step 4208 is step, as determined in step 4272, the received time series TS is resealed and then directly submitted to neural-network forecasting using an expansion factor equal to the period of the detected periodicity, in step 4274. Otherwise, in step 4276, a technique, such as the technique discussed above with reference to FIGS. 41A-C, is applied to the time series to remove significant periodicities and then the original portion of the forecast routine following the call to the function “determine type” is executed, assuming the type “stationary” for the received time series, as indicated by step 4278. Circular labeled step 4280 is the continuation of step 4224 in FIG. 42A. When the result returned by the call to the function “periodic” in step 4222 is step, as determined in step 4282, the detrended time series TSd is resealed and then directly submitted to neural-network forecasting using an expansion factor equal to the period of the detected periodicity, in step 4284. Otherwise, in step 4286, a technique, such as the technique discussed above with reference to FIGS. 41A-C, is applied to the time series to remove significant periodicities and then the original portion of the forecast routine following the call to the function “determine type” is executed assuming the type “linear trend stationary” for the received time series TS, as indicated by step 4288. Circular labeled step 4290 is the continuation of step 4238 in FIG. 42A. When the result returned by the call to the function “periodic” in step 4236 is step, as determined in step 4292, the time series TSs is resealed and then directly submitted to neural-network forecasting using an expansion factor equal to the period of the detected periodicity, in step 4294. Otherwise, in step 4296, a technique, such as the technique discussed above with reference to FIGS. 41A-C, is applied to the time series TSs to remove significant periodicities and then the original portion of the forecast routine following the call to the function “determine type” is executed assuming the type “stochastic stationary” for the received time series, as indicated by step 4298.

The modifications to the above-discuss forecasting method illustrated in FIGS. 42A-C are but one of many different possible sets of modifications that can be made to allow the forecasting method disclosed in the preceding subsection to be applied to periodic time series. For example, other types of logic and considerations may be carried out with respect to detected periodicities in the various types of periodic time series. Directly submitting time series that periodic time-series components to neural-network-based forecasting, using an expansion factor equal to the period of the periodic time-series component, may be undesirable for other reasons, as a result of which alternative approaches may be taken, including removal of periodic time-series components. In all cases, the forecast needs to be transformed back to the original type of series, as discussed above with reference to FIG. 29. The reverse transformations need to include reincorporating any periodic time-series components removed prior to submitting a time series to the neural-network-based forecasting procedure. In certain cases, when there are multiple periodic time-series components in a time series from which a forecast is desired to be generated, and when the periods are related by a small-integer factor, a suitable expansion factor, or step, may be computed to select datapoints at a period common to both periodic time-series components, as a result of which the multiple periodic time-series components are automatically removed using the computed expansion factor and scaling, just as in the case of a single periodic time-series component.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems for generating forecasts from time-series data can be obtained by varying any of many different design and implementation parameters, including modular organization, programming language, underlying operating system, control structures, data structures, and other such design and implementation parameters. As discussed above, any of many different hypotheses tests can be used to assign a type or class to an input TS. Any of many different types of neural networks having different numbers and types of nodes, different numbers of levels of nodes, and different numbers of input and output nodes may be employed. In alternative implementations, multiple forecasting neural networks can be used for large subsets of the total number of TS types or classes from which forecasts are to be generated, in order to provide greater accuracy.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated time-series-data forecasting subsystem within a cloud-computer system comprising:
one or more processors;
one or more memories; and
computer instructions, stored in one or more of the one or more memories that, when executed by one or more of the one or more processors, control the automated time-series-data forecasting subsystem to
receive a time series of a type, the type either a type that includes time series with periodic time-series components or a type that includes non-periodic time series,
determine
the type of the received times series, and
a transform and an inverse transform corresponding to the received time series,
apply the transform to the received time series to generate a corresponding stationary time series,
input the stationary time series to a forecaster,
receive, from the forecaster, an initial forecast time series,
apply the inverse transform to the initial forecast time series to generate a final forecast time series, and
output the final forecast time series to a final-forecast-time-series recipient.

2. The automated time-series-data forecasting subsystem of claim 1 wherein a time series and a forecast time series are both data sets comprising time-associated data values, each data value an integer, floating-point number, or other value representation.

3. The automated time-series-data forecasting subsystem of claim 1 wherein a forecast time series represents data values associated with times subsequent to the most recent time associated with a data value in a time series from which the forecast time series is generated.

4. The automated time-series-data forecasting subsystem of claim 1 wherein the automated time-series-data forecasting subsystem is employed by an automated forecasting service which receives time series from service-requesting automated-forecasting-service clients and returns, to the service-requesting automated-forecasting-service clients, a final forecast time series generated by the automated time-series-data forecasting subsystem.

5. The automated time-series-data forecasting subsystem of claim 1 wherein the type of a received time series is selected from among:
a stationary time series;
a linear-trend stationary time series;
a unit-root time series;
a unit-root-with-drift time series;
a time series that includes a stationary-time-series component and a periodic time-series component;
a time series that includes a linear-trend stationary time series and a periodic time-series component; and
a time series that includes a stochastic time-series component, such as a unit-root time series or a unit-root-with-drift time series, and a periodic time-series component.

6. The automated time-series-data forecasting subsystem of claim 5 wherein the forecaster is a machine-learning-based subsystem that has been trained to generate an output forecast time series corresponding to a received stationary time series.

7. The automated time-series-data forecasting subsystem of claim 6 wherein the forecaster is a neural network with m input nodes and a output nodes.

8. The automated time-series-data forecasting subsystem of claim 7
wherein a number d of time-associated data values are extracted from the received time series and input to the neural network, which produces a number ƒ of forecast-time-series time-associated data values:
wherein, when the number d is equal to m, the number d of time-associated data values are input to the m neural-network input nodes to produce n output-forecast time-associated data values, where n is equal to ƒ; and
wherein, when the number d is greater than m, the number d of time-associated data values are input to neural-network in e passes, wherein e is an expansion factor determined by integer division of d by m, to produce n output-forecast time-associated forecast data values in each pass which are combined together to produce ƒ output-forecast time-associated forecast data values, wherein, is equal to n multiplied by e.

9. The automated time-series-data forecasting subsystem of claim 8
wherein a time series that includes a stationary-time-series component and a periodic time-series component has a period and a period length; and
wherein a time series that includes a stationary-time-series component and a periodic time-series component is input to the neural network with an expansion factor equal to the period length, with resealing prior to input of each pass, in order to remove the periodic time-series component.

10. The automated time-series-data forecasting subsystem of claim 5 wherein the automated time-series-data forecasting subsystem determines the type of the received times series by
applying a first periodicity detection to the time series; and
when a periodic time-series component is detected in the time series by the first periodicity detection,
generating a forecast by one of
inputting the time series to the neural network with an expansion factor equal to the period length of the periodic time-series component, and
removing the periodic time-series component from the times series to generate a stationary time series and inputting the stationary time series to the neural network.

11. The automated time-series-data forecasting subsystem of claim 10
wherein, when a periodic time-series component is not detected in the time series by the first periodicity detection,
applying linear regression to the time series;
when a trend is detected by application of linear regression,
detruding the time series to produce a detrended time series, and
applying a second periodicity detection to the detrended time series; and
when a periodic time-series component is detected in the detrended time series by the second periodicity detection,
generating a forecast by one of
inputting the detrended time series to the neural network with an expansion factor equal to the period length of the periodic time-series component, and
removing the periodic time-series component from the detrended time series to generate a stationary time series and inputting the stationary time series to the neural network.

12. The automated time-series-data forecasting subsystem of claim 11
wherein, when a periodic time-series component is not detected in the detrended time series by the second periodicity detection,
applying differencing to the time series;
when stochastic behavior is detected by application of differencing,
applying differencing to the time series to produce a non-stochastic time series, and
applying a third periodicity detection to the non-stochastic time series; and
when a periodic time-series component is detected in the non-stochastic time series by the third periodicity detection,
generating a forecast by one of
inputting the non-stochastic time series to the neural network with an expansion factor equal to the period length of the periodic time-series component, and
removing the periodic time-series component from the non-stochastic times series to generate a stationary time series and inputting the stationary time series to the neural network.

13. The automated time-series-data forecasting subsystem of claim 11
wherein, when a periodic time-series component is not detected in the non-stochastic time series by the third periodicity detection,
determining that the time series is non-periodic; and
generating a forecast from the non-periodic time series.

14. A method, carried out by an automated system, that generates a forecast time series from an input time series, the method comprising:
receiving a time series of a type, the type either a type that includes time series with periodic time-series components or a type that includes non-periodic time series,
determining
the type of the received times series, and
a transform and an inverse transform corresponding to the received time series,
applying the transform to the received time series to generate a corresponding stationary time series,
inputting the stationary time series to a forecaster,
receiving, from the forecaster, an initial forecast time series,
applying the inverse transform to the initial forecast time series to generate a final forecast time series, and
outputting the final forecast time series to a final-forecast-time-series recipient.

15. The method of claim 14
wherein a time series and a forecast time series are both data sets comprising time-associated data values, each data value an integer, floating-point number, or other value representation; and
wherein a forecast time series represents data values associated with times subsequent to the most recent time associated with a data value in a time series from which the forecast time series is generated.

15. The method of claim 14 wherein the type of a received time series is selected from among:
a stationary time series;
a linear-trend stationary time series;
a unit-root time series;
a unit-root-with-drift time series;
a time series that includes a stationary-time-series component and a periodic time-series component;
a time series that includes a linear-trend stationary time series and a periodic time-series component; and
a time series that includes a stochastic time-series component, such as a unit-root time series or a unit-root-with-drift time series, and a periodic time-series component.

16. The method of claim 15
wherein the forecaster is a neural network with m input nodes and n output nodes;
wherein a number d of time-associated data values are extracted from the received time series and input to the neural network, which produces a number ƒ of forecast-time-series time-associated data values;
wherein, when the number d is equal to m, the number d of time-associated data values are input to the m neural-network input nodes to produce n output-forecast time-associated data values, where n is equal to ƒ; and
wherein, when the number d is greater than m, the number d of time-associated data values are input to neural-network in e passes, wherein e is an expansion factor determined by integer division of d by m, to produce n output-forecast time-associated forecast data values in each pass which are combined together to produce ƒ output-forecast time-associated forecast data values, wherein ƒ is equal to n multiplied by e.

17. The method of claim 16
wherein a time series that includes a stationary-time-series component and a periodic time-series component has a period and a period length; wherein, and
wherein a time series that includes a stationary-time-series component and a periodic time-series component is input to the neural network with an expansion factor equal to the period length, with resealing prior to input of each pass, in order to remove the periodic time-series component.

18. The method of claim 17 wherein determining the type of the received times series further comprises:
applying a first periodicity detection to the time series; and
when a periodic time-series component is detected in the time series by the first periodicity detection,
generating a forecast by one of
inputting the time series to the neural network with an expansion factor equal to the period length of the periodic time-series component, and
removing the periodic time-series component from the times series to generate a stationary time series and inputting the stationary time series to the neural network.

19. The method of claim 18
wherein, when a periodic time-series component is not detected in the time series by the first periodicity detection,
applying linear regression to the time series;
when a trend is detected by application of linear regression,
detrending the time series to produce a detrended time series, and
applying a second periodicity detection to the detrended time series; and
when a periodic time-series component is detected in the detrended time series by the second periodicity detection,
generating a forecast by one of
inputting the detrended time series to the neural network with an expansion factor equal to the period length of the periodic time-series component, and
removing the periodic time-series component from the detrended time series to generate a stationary time series and inputting the stationary time series to the neural network.

20. The method of claim 19
wherein, when a periodic time-series component is not detected in the detrended time series by the second periodicity detection,
applying differencing to the time series;
when stochastic behavior is detected by application of differencing,
applying differencing to the time series to produce a non-stochastic time series, and
applying a third periodicity detection to the non-stochastic time series; and
when a periodic time-series component is detected in the non-stochastic time series by the third periodicity detection,
generating a forecast by one of
inputting the non-stochastic time series to the neural network with an expansion factor equal to the period length of the periodic time-series component, and
removing the periodic time-series component from the non-stochastic times series to generate a stationary time series and inputting the stationary time series to the neural network.

21. The method of claim 19
wherein, when a periodic time-series component is not detected in the non-stochastic time series by the third periodicity detection,
determining that the time series is non-periodic; and
generating a forecast from the non-periodic time series.

22. A physical data-storage device that contains computer instructions that, when executed by one or more processors of a computer system containing memory and mass-storage, control the computer system to generate a forecast time series from an input time series by
receiving a time series of type, the type either a type that includes time series with periodic time-series components or a type that includes non-periodic time series;
determining
the type of the received times series, and
a transform and an inverse transform corresponding to the received time series:
applying the transform to the received time series to generate a corresponding stationary time series;
inputting the stationary time series to a neural-network forecaster;
receiving, from the neural-network forecaster, an initial forecast time series;
applying the inverse transform to the initial forecast time series to generate a final forecast time series; and
outputting the final forecast time series to a final-forecast-time-series recipient for use in determining a response to execute based on a state or condition represented by the input time series.
